(19) United States
(12) Patent Application Publication
(10) Pub. No.: US 2026/0279021 A1
(43) Pub. Date: Sep. 17, 2026

(54) SYSTEMS AND METHODS FOR IMAGE PROCESSING

(71) Applicant: CSR BIOTECH (GUANGZHOU) CO., LTD., Guangzhou (CN)

(72) Inventors: Liangyi CHEN, Guangzhou (CN); Haoyu LI, Guangzhou (CN); Weisong ZHAO, Guangzhou (CN); Liying QU, Guangzhou (CN)

(73) Assignee: CSR BIOTECH (GUANGZHOU) CO., LTD., Guangzhou (CN)

(21) Appl. No.: 19/679,605

(22) Filed: May 15, 2026

Related U.S. Application Data
(63) Continuation of application No. PCT/CN2024/077072, filed on Feb. 8, 2024.

(30) Foreign Application Priority Data
Dec. 29, 2023 (CN) 202311866712.7

(51) Int. Cl. G06V 10/774; G06V 10/26; G06V 10/32; G06V 20/69

(52) U.S. Cl. CPC G06V 10/774; G06V 10/26; G06V 10/32; G06V 20/695

(57) ABSTRACT

A method for image processing is provided. The method may include: obtaining an initial image; and generating a target image by processing the initial image using a trained image processing model. The trained image processing model may be generated by training an image processing model using one or more training samples. Each training sample of the one or more training samples may include an image pair generated based on a sample image.

### CROSS-REFERENCE TO RELATED APPLICATIONS

This application is a Continuation of International Application No. PCT/CN2024/077072, filed on Feb. 8, 2024, which claims priority to Chinese Patent Application No. 202311866712.7, filed on Dec. 29, 2023, the entire contents of each of which are incorporated herein by reference.

### TECHNICAL FIELD

The present disclosure generally relates to the field of image processing, and more particularly to systems and methods for image denoising.

### BACKGROUND

Fluorescence microscopy of live cells requires gentle imaging conditions and adequate spatiotemporal resolution to record authentic biological information. By encoding super-resolution (SR) information via specific optics and fluorescent on-off indicators, SR techniques have further strengthened the spatial resolution and enabled previously unappreciated, intricate structures to be observed. However, for a finite number of fluorophores within the cell volume, the increase in spatial resolution leads to increase in illumination intensity or exposure time by order of magnitudes to maintain the same signal-to-noise ratio (SNR). Furthermore, any increase in spatial resolution may need to be matched with an increase in temporal resolution to prevent motion artifacts, which may be particularly problematic for live-cell SR imaging to accumulate sufficient photons. Therefore, it is desirable to provide systems and methods for efficient image denoising with relatively high SNR.

### SUMMARY

In one aspect of the present disclosure, a method for image processing is provided. The method may be implemented on a machine including at least a processor and a storage device. The method may include: obtaining an initial image; and generating a target image by processing the initial image using a trained image processing model. In some embodiments, the trained image processing model may be generated by training an image processing model using one or more training samples.

In some embodiments, each training sample of the one or more training samples may include an image pair generated based on a sample image.

In another aspect of the present disclosure, a method for training an image processing model is provided. The method may be implemented on a machine including at least a processor and a storage device. The method may include: obtaining a plurality of sample images; generating a plurality of image pairs based on the plurality of sample images; and obtaining a trained image processing model by training the image processing model using the plurality of image pairs. Noises of each image pair of the plurality of image pairs may be uncorrelated.

In another aspect of the present disclosure, a system for image processing is provided. The system may include at least one storage device storing a set of instructions; and at least one processor in communication with the storage device, wherein when executing the set of instructions, the at least one processor is configured to cause the system to perform operations including: obtaining an initial image; and generating a target image by processing the initial image using a trained image processing model. In some embodiments, the trained image processing model may be generated by training an image processing model using one or more training samples. In some embodiments, each training sample of the one or more training samples may include an image pair generated based on a sample image.

In another aspect of the present disclosure, a system for training an image processing model is provided. The system may include at least one storage device storing a set of instructions; and at least one processor in communication with the storage device, wherein when executing the set of instructions, the at least one processor is configured to cause the system to perform operations including: obtaining a plurality of sample images; generating a plurality of image pairs based on the plurality of sample images; and obtaining a trained image processing model by training the image processing model using the plurality of image pairs. Noises of each image pair of the plurality of image pairs may be uncorrelated.

In another aspect of the present disclosure, a system for image processing is provided. The system may include: an obtaining module configured to obtain an initial image; and a processing module configured to generate a target image by processing the initial image using a trained image processing model. In some embodiments, the trained image processing model may be generated by training an image processing model using one or more training samples. In some embodiments, each training sample of the one or more training samples may include an image pair generated based on a sample image.

In another aspect of the present disclosure, a system for training an image processing model is provided. The system may include a training module configured to: obtain a plurality of sample images; generate a plurality of image pairs based on the plurality of sample images; and obtain a trained image processing model by training the image processing model using the plurality of image pairs. Noises of each image pair of the plurality of image pairs may be uncorrelated.

In another aspect of the present disclosure, a non-transitory computer readable medium is provided. The non-transitory computer readable medium may include at least one set of instructions for image processing. When executed by one or more processors of a computing device, the at least one set of instructions may cause the computing device to perform a method, including: obtaining an initial image; and generating a target image by processing the initial image using a trained image processing model. In some embodiments, the trained image processing model may be generated by training an image processing model using one or more training samples. In some embodiments, each training sample of the one or more training samples may include an image pair generated based on a sample image.

In another aspect of the present disclosure, a non-transitory computer readable medium is provided. The non-transitory computer readable medium may include at least one set of instructions for training an image processing model. When executed by one or more processors of a computing device, the at least one set of instructions may cause the computing device to perform a method, including: obtaining a plurality of sample images; generating a plurality of image pairs based on the plurality of sample images; and obtaining a trained image processing model by training the image processing model using the plurality of image pairs. Noises of each image pair of the plurality of image pairs may be uncorrelated.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1A-1F show an exemplary workflow and simulation validation of SN2N according to some embodiments of the present disclosure;

FIGS. 2A-2K show exemplary systematical evaluations in SD-SIM tests using known structures according to some embodiments of the present disclosure;

FIGS. 3A-3I show exemplary multi-color live-cell SR imaging enabled by RL-SN2N on SD-SIM according to some embodiments of the present disclosure;

FIGS. 4A-4I show 3D RL-SN2N on SD-SIM unlocks fast long-term imaging across 5D according to some embodiments of the present disclosure;

FIGS. 5A-5O show SN2N and RL-SN2N permit long-term live-cell STED imaging according to some embodiments of the present disclosure;

FIGS. 6A-6J show integration of SN2N and SOFI massively improves the SR reconstruction efficiency according to some embodiments of the present disclosure;

FIGS. 7A-7B show exemplary workflow of SN2N and network architectures according to some embodiments of the present disclosure;

FIGS. 8A-8F show exemplary testing results of different pixel sizes, interpolation methods, and constraint weights according to some embodiments of the present disclosure;

FIGS. 9A-9F show exemplary testing results of different noise levels and data amounts according to some embodiments of the present disclosure;

FIGS. 10A-10G show exemplary comparisons of SN2N versus RL-SN2N using SD-SIM and applying SN2N on SD-confocal microscopy according to some embodiments of the present disclosure;

FIGS. 11A-11K show exemplary SN2N-empowered automated subcellular segmentation and tracking according to some embodiments of the present disclosure;

FIGS. 12A-12F show that RL-SN2N can suppress noise in undersampled data from EMCCD SD-SIM according to some embodiments of the present disclosure;

FIGS. 13A-13K show exemplary full data of SOFI-SN2N results and SN2N-assisted expansion microscopy (ExM-SN2N) according to some embodiments of the present disclosure;

FIGS. 14A-14T show that SN2N removes random, non-continuous artifacts in low-SNR SIM with two strategies according to some embodiments of the present disclosure;

FIGS. 15A-15C show that SN2N maintains the linear response of Ca²⁺ transients obtained by the SD-SIM according to some embodiments of the present disclosure;

FIGS. 16A-16K show exemplary generalization of unsupervised learning methods across different SNR conditions and pixel sizes (structural scales) according to some embodiments of the present disclosure;

FIG. 17 shows exemplary simulation workflow of microtubule filaments, ground-truth (GT) image, and SR images under different noise levels according to some embodiments of the present disclosure;

FIG. 18 shows exemplary full data uncertainty results of simulation data under different noise levels according to some embodiments of the present disclosure;

FIGS. 19A-19B show exemplary Full data uncertainty and model uncertainty results of simulation data with different training data amounts according to some embodiments of the present disclosure;

FIGS. 20A-20H show exemplary benchmarking of SN2N against N2V and DeepCAD using live-cell imaging data and their segmentation results according to some embodiments of the present disclosure;

FIGS. 21A-21B show that RL-SN2N reveals the 3D distribution of mitochondria after long-term recording according to some embodiments of the present disclosure;

FIGS. 22A-22B show exemplary representative lateral slices at the first time point of 5D data according to some embodiments of the present disclosure;

FIG. 23 shows exemplary STED (top), STED-SN2N (middle), and STED-ISM (bottom) results of microtubules in a fixed cell under different depletion laser powers according to some embodiments of the present disclosure;

FIGS. 24A-24B show exemplary resampling strategies according to some embodiments of the present disclosure;

FIG. 25 is a schematic diagram illustrating an exemplary application scenario of an image processing system according to some embodiments of the present disclosure;

FIG. 26 is a schematic diagram illustrating an exemplary computing device according to some embodiments of the present disclosure;

FIG. 27 is a block diagram illustrating an exemplary mobile device on which the terminal(s) may be implemented according to some embodiments of the present disclosure;

FIG. 28 is a block diagram illustrating an exemplary processing device according to some embodiments of the present disclosure;

FIG. 29 is a flowchart illustrating an exemplary process for training an image processing model according to some embodiments of the present disclosure;

FIG. 30 is a flowchart illustrating an exemplary process for generating a plurality of image pairs based on a plurality of sample images according to some embodiments of the present disclosure;

FIG. 31 is a flowchart illustrating an exemplary process for generating resampled twin images from a sample image based on a resampling strategy according to some embodiments of the present disclosure;

FIG. 32 is a flowchart illustrating an exemplary process for training an image processing model according to some embodiments of the present disclosure; and

FIG. 33 is a flowchart illustrating an exemplary process for processing an image according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by another expression if they achieve the same purpose.

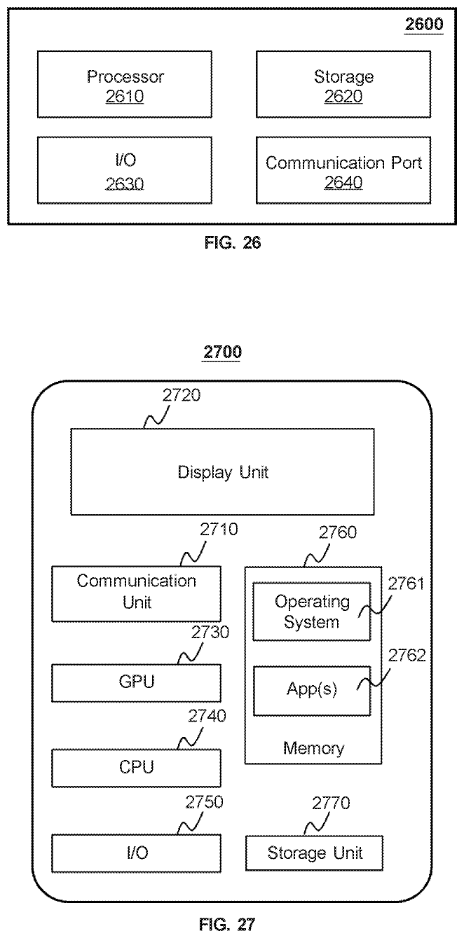

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processor 2610 as illustrated in FIG. 26) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood the operations of the flowcharts may be implemented not in order. Conversely, the operations may be implemented in inverted order, or simultaneously. Moreover, one or more other operations may be added to the flowcharts. One or more operations may be removed from the flowcharts.

Computational boosting of the SNR of SR images may be essential to maximize the utilization of sensor-collected photons. By modeling of image-formation process, traditional denoising algorithms based on numerical filtering and mathematical optimization can remove noise from fluorescence images to a certain extent. However, the corresponding carried assumptions are not dependent on the specific content of the imaging data and may not fulfill the optimal performance. Therefore, to capture the full statistical complexity of data, a sudden surge of data-driven methods may be used to produce unprecedented restoration results of images. After training using a dataset with ground truth (GT) labels, deep neural networks (DNNs) can learn the mapping between noisy images and their clean counterparts. Intuitively, for supervised learning, the collection of abundant content-matched clean images is crucial and is a great challenge to live-cell applications, especially under the super-resolution scale.

To denoise noisy images without clean ones, image processing methods (e.g., a Noise2Noise (N2N) method) are provided in the present disclosure. In the N2N process, a mapping between pairs of independently degraded versions of the same image may be learned, and its performance in denoising can approach to that of supervised learning methods. Similarly, this need for the twin noisy pairs is still against the live-cell SR applications. By leveraging the pixel-wise independency of noise, several approximate forms of N2N are developed for denoising without any paired data. To realize the full form of N2N configuration, a temporally interleaved self-supervised data generation process may be used to create the needed noisy data pairs, based on the assumption that the two adjacent frames in a video of continuous imaging can be considered with the same underlying content.

On the other hand, SR images are usually with more than sufficient sampling rate, at least over the Nyquist sampling theorem to protect the enriched spatial information. A self-supervised data generation strategy is provided based on this spatial redundancy, rather than the temporal redundancy. After a resampling operation (e.g., a diagonal resampling operation), the noisy pair with a 2-fold smaller image size is produced, and for maintaining the structural scale, the resulting image pair is subsequently upscaled (e.g., with a Fourier interpolation) by considering the low-pass-filter property of fluorescence microscopes. Compared to the previous temporal resampling, this spatially interleaved data generation is more stable and robust and produces almost no bias. Beyond this spatially self-supervised N2N realization, a self-constrained learning process may be developed to further enhance the denoising-performance and data-efficiency. The two network predictions of the generated noisy pair may be constrained to one identical expectation, and this process may shrink the learning and predictive uncertainty, thereby inherently increasing the efficiency and effectiveness of the unsupervised learning to denoise. Together with the self-supervised data generation and self-constrained learning, the self-inspired N2N (SN2N) processing can reach or even outperform the supervised learning to denoise methods with less training data in which one single frame of image is sufficient for training.

The capability of SN2N is demonstrated on various images. For example, the capability of SN2N is demonstrated directly on images generated by two commercial spinning-disk confocal-based structured illumination microscopes (SD-SIM) and two commercial stimulated emission depletion (STED) microscopes, as well as expansion microscopy (ExM) and high-resolution (HR) confocal microscopy. The use of SN2N enables high-quality long-term multi-color 3D live-cell SR imaging (5D in xyz-c-t). As another example, beyond the direct application, the SN2N framework can be integrated into one or more existing SR reconstruction procedures, including for example, the iterative deconvolution on SD-SIM and STED, SR optical fluctuation imaging (SOFI) reconstruction, and structured illumination microscope (SIM) imaging, to effectively mitigate the artifacts embedded in the SR images and enhance the photon efficiency. These organic integrations may deliver the fact that the SN2N processing can serve as a practical and powerful framework for further strengthening the performance of SR microscopy (e.g., live-cell SR microscopy).

It should be noted that live-cell microscopy is described in the present disclosure for the purpose of illustration and description only and is not intended to limit the scope of the present disclosure. The image processing methods are applicable for images generated using other imaging technologies and images of other objects (e.g., non-biological objects). For example, the SN2N process may be applicable to other fields for noise removal (e.g., random noise removal).

Exemplary principle of SN2N may be described below.

Exemplary self-supervised data generation by considering the inherent characters of SR microscopy may be described below.

SR microscopy imaging may have one or more physical properties. A first property (also referred to as p1) may refer that the sample rate of SR images may need to be finer than twice its highest frequency to fulfill the Nyquist sampling theorem. A second property (also referred to as p2) may refer that the point spread function (PSF) of the SR microscopy imaging represents the highest frequency of the SR microscopy imaging system and is usually with spatial symmetry inside 2×2 pixels.

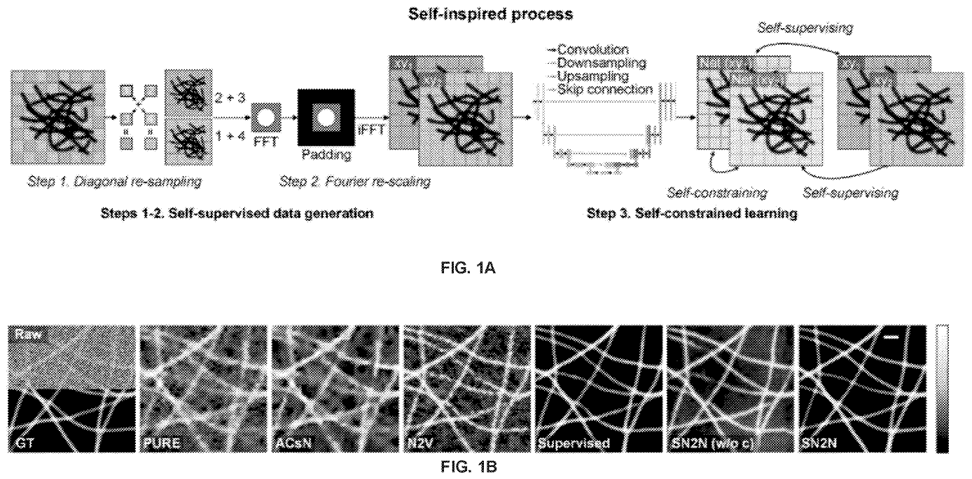

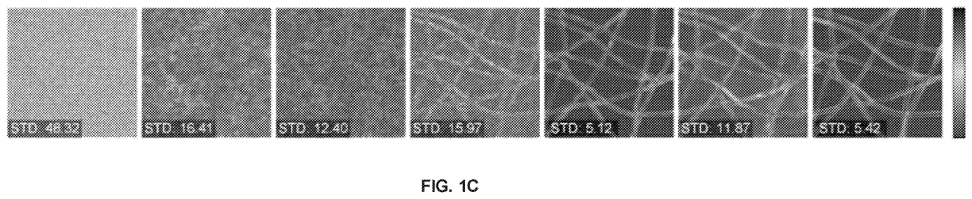

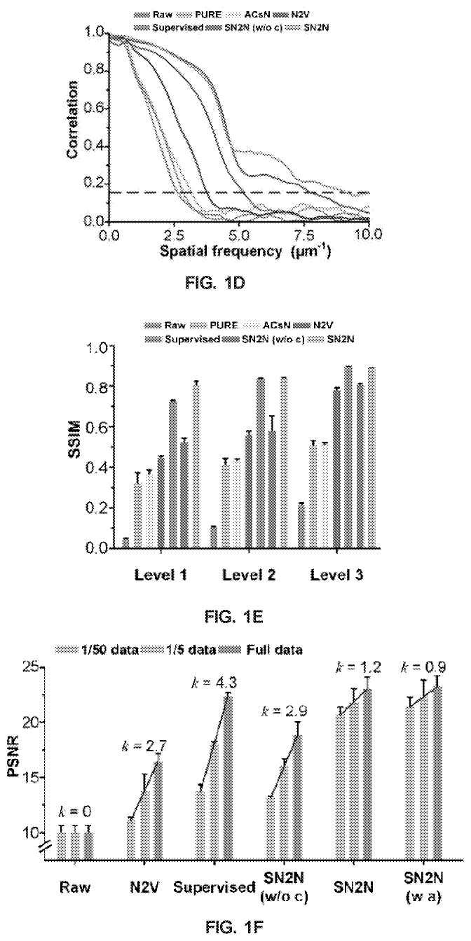

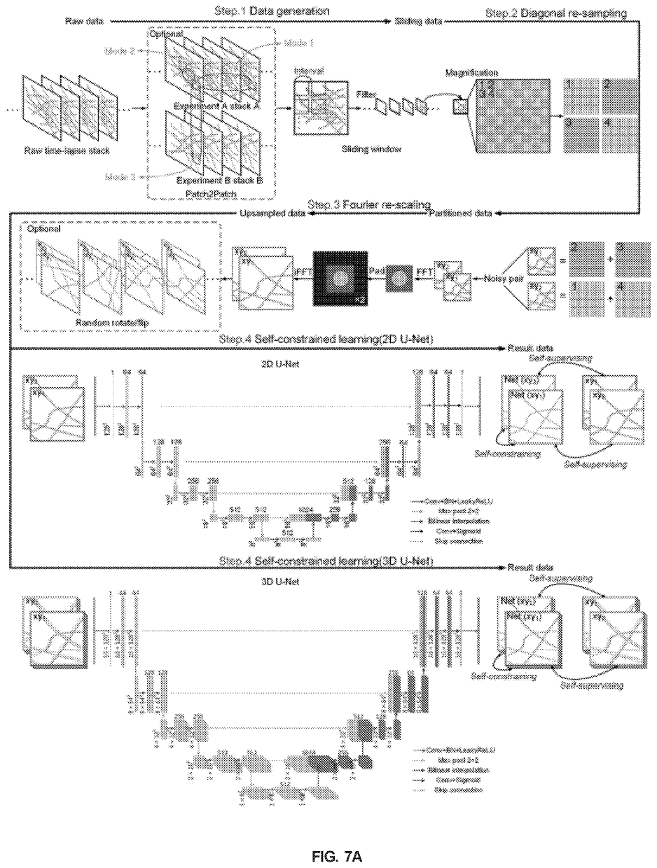

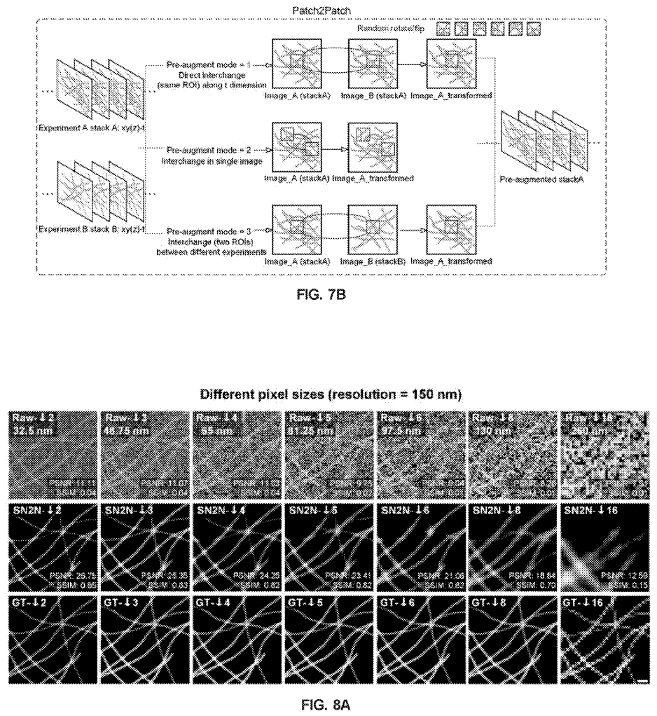

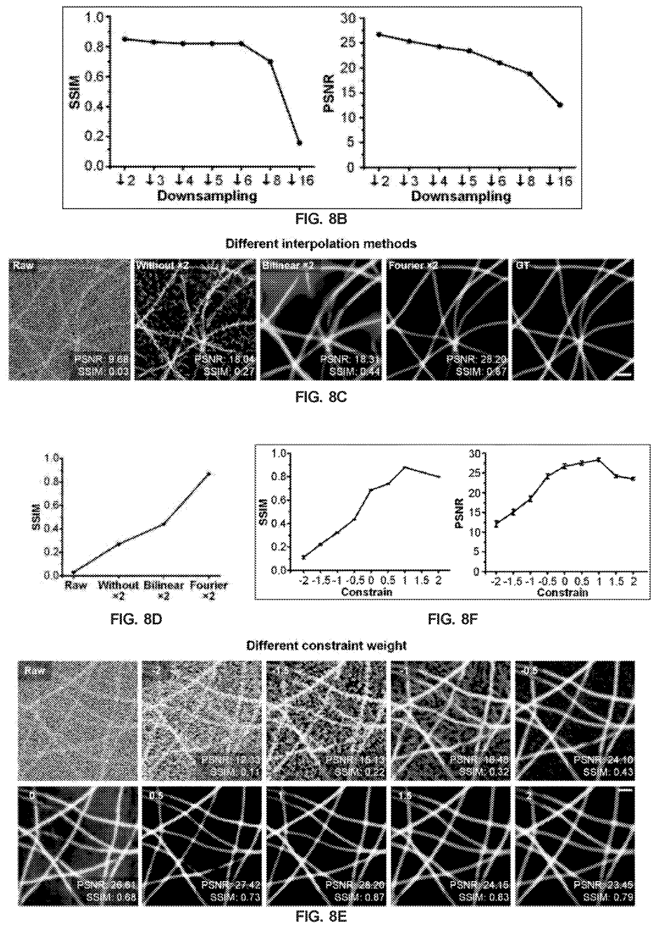

A third property (also referred to as p3) may refer that each pixel of the camera is commonly sampled independently. A fourth property (also referred to as p4) may refer that the SR microscopy imaging system can be regarded as a low-pass filter. In some embodiments, an SR image may be produced by a plurality of PSFs multiplied with the corresponding fluorophore brightness at different spatial positions, and each PSF may contribute for at least larger than an area of 2×2 pixels. Considering this spatial redundancy (e.g., p1 and p2), the SR image as two subimages may be resampled through various forms of binning (e.g., a diagonal re-sampling shown in FIG. 1A). Merely by way of example, every four adjacent pixels (2×2) may be regarded as one unit, and every two diagonal pixels (e.g., top left and bottom right in FIG. 1A; top right and bottom left in FIG. 1A, FIG. 7A) may be averaged as one new pixel. Because of the independency of each pixel and the spatial symmetry on the two diagonal directions (e.g., p2 and p3), statistically independent image pairs that share identical details but different noise realizations may be generated for the N2N configuration. Through suggesting the contents inside one smallest unit are identical, the N2N method may be more general than temporal resampling approach(es), which assume the entire contents of two frames are identical. Compared to other spatial generation algorithms, the resampling In diagonal axes may be more stable for requiring no additional registration or calibration to create matched image content. Notably, although originated from the spatial redundancy of SR images, the N2N process is not sensitive to the pixel size changes and can produce stable denoising results for even undersampled images (e.g., an image with 260 nm pixel size with 150 nm resolution, as shown in an image downsampled by eight times denoted by “81” in FIGS. 8A-8B).

Because these produced two subimages are twice smaller, an interpolation operation may be performed to rescale them to the original structural scale of the image. In some embodiments, a Fourier interpolation may be applied to the two subimages, which is based on the fact that the optical transfer function (OTF) of an SR microscope has only finite support (e.g., p4). In some embodiments, the Fourier-transformed image out of its OTF support may be padded with zeros, which does not alter its information content, and after back-transforming, this padded image will have doubled pixel number in both xy axes, identical to the original SR image (FIG. 1A, FIG. 7A). In some embodiments, without this operation, the network may produce structural artifacts for the scale difference between the training and test datasets (FIG. 8C). On the other hand, spatial methods (such as bilinear interpolation) may create more pixels according to the noise-corrupted pixels and it may be problematic when meeting the background areas without fluorescence signals. Because these smoothly created pixels do not conform to the randomness of noise, which may influence the learning process, potentially producing background artifacts (Extended Data FIG. 8C).

Exemplary SN2N framework may be described below.

Exemplary SN2N core may be described below.

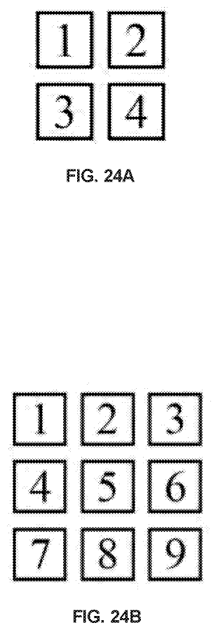

In principle, N2N may not require clean target to train a denoising model approaching supervised learning performance. However, this is achieved by assuming that the noise is zero-mean and the training set contains infinite noisy data pairs sharing identical contents with independent noise components. In some embodiments, to remove the need for data pairs, a diagonal resampling strategy may be designed to generate such twin images from one single frame using the inherent spatial redundancy of SR images. In some embodiments, every four pixels (e.g., four pixels shown in FIG. 24A) in an SR image may be assembled as one unit. In some embodiments, a diagonal binning operation may be performed on these four pixels to create two new pixels for N2N data pair. In some embodiments, the two diagonal pixels (e.g., pixel 1 and pixel 4) may be averaged as one new pixel; and the other two diagonal pixels (e.g., pixel 2 and pixel 3) may be averaged as the other new pixel. Throughout the input image, two 2× subsampled images may be created. In some embodiments, to rescale back to their original image size, a Fourier interpolation may be performed to upsample the resulting image pair by two times. Thus, the two subsampled images may be transformed into the Fourier domain and zero-padding may be applied to extend the borders in the Fourier space by e.g., half of the original sizes in each direction. Then, the inverse Fourier transformed image may be twice the size of the input image, identical to the original SR image. Additionally, in some embodiments, to prevent boundary artifacts, the image (in spatial domain) may be extended with mirror-symmetric half-copies before the Fourier padding, and the resulting image may be Fourier upsampled and then cropped back to the original size.

In some embodiments, originally in N2N, the infinite training set may execute average of noise to its true zero-mean result. However, in case of limited data for training, there would be inevitable differences between these means across the different realizations of noise. Thus, the insufficient training set may introduce large predictive uncertainty, inherently resulting in limited denoising performance. To minimize this uncertainty, a self-constrained learning process with considering the identical underlying content from the noisy data pair may be designed. Merely by way of example, the noisy data pair may be successively and individually fed into the network, and the two resulting predictions may be calculated by a loss function to execute the training stage. An exemplary loss function may be illustrated as:

$$ℓ = \frac{1}{2 + λ} {‖ {\hat{x}}_{1} - {x}_{2} ‖}_{1} + \frac{1}{2 + λ} {‖ {\hat{x}}_{2} - {x}_{1} ‖}_{1} + \frac{1}{2 + λ} {‖ {\hat{x}}_{1} - {\hat{x}}_{2} ‖}_{1} , \qquad ( 1 )$$

where \tilde{x} represents the network outcome of the input x, and ∥ ∥₁ refers to the l₁ norm. The first term and the second term may be the conventional N2N loss. Because the corresponding two denoised results should have no differences, the third term may be included as a self-constrained loss with constraint weight λ to enforce the consistency of the predictions.

Exemplary data augmentation for low-level tasks may be described below.

In some embodiments, random patch transformations in multiple dimensions (Patch2Patch) may be developed to further improve the data efficiency (FIG. 7B) for network training. In some embodiments, one or more random selected regions of interest (ROIs) of an image may be rotated, and/or flipped, or remained still, and subsequently interchanged with one or more other ROIs from the same image (or frame) or a different image (or frame) from different time or different measurements. The Patch2Patch operation can equivalently create more imaging results without changing the inherent noise properties and hence it can effectively reduce the required data bulk in network training.

Exemplary Patch2Patch data augmentation may be described below.

In some embodiments, the Patch2Patch operation may employ multidimensional random patch transformations to increase the data amount for network training, which is adaptable to both two-dimensional (2D) (xy) and three-dimensional (3D) (xyz) datasets (FIG. 7B). Within the Patch2Patch framework, a plurality of modes for augmentation may be developed. Merely by way of example, three modes (i.e., Mode 1, Mode 2, Mode 3) for augmentation along the temporal axis, in a single image, and between different measurements may be used. The Patch2Patch operation can effectively increase variations of noise realizations and structural features without altering the intrinsic characteristics of data. According to Mode 1, for image/volume dataset with additional temporal dimension (xy-t/xyz-t), Patch2Patch can create augmentation along the temporal dimension. One or more patches (e.g., randomly chosen patches) at time point A (e.g., Stack A, Image A) may be exchanged with one or more patches from another time point (e.g., randomly selected time point B (Stack A, Image B)) at the same location. According to Mode 2, for the augmentation of a single image/volume, two distinct patches at different positions may be swapped (e.g., randomly). According to Mode 3, for augmentation between different measurements, one or more patches (e.g., randomly chosen patches) at measurement A (e.g., Image A) may be exchanged with one or more patches from (e.g., randomly selected) experiment B (e.g., Image B) at one or more locations (e.g., randomly picked locations). In some embodiments, to further increase the data amounts, one or more geometric transformations may be performed on one or more pairs of patches (e.g., no transformation, horizontal flip, vertical flip, 90° rotation to the left, 90° rotation to the right, 180° rotation, or the like, or any combination thereof).

Exemplary network architecture may be described below.

The SN2N process can be applied on any DNNs. Merely by way of example, a U-Net architecture may be applied to showcase the strengths of SN2N (FIG. 7A). Exemplary U-Net architectures may include a 2D U-Net architecture or a 3D U-Net architecture. An exemplary 2D U-Net architecture may include a 2D encoder module (contracting path), a 2D decoder module (expanding path), and/or one or more (e.g., four) skip connections bridging the encoder and decoder. The 2D encoder module and/or decoder module may be structured into one or more (e.g., four) distinct blocks. In some embodiments, each encoder block may be equipped with one or more (e.g., two) convolutional layers (e.g., 3×3 convolutional layers), followed by a leaky rectified linear unit (LeakyReLU) and a pooling operation (e.g., a 2×2 max pooling operation with a stride of two in both dimensions). Accordingly, each decoder block may include one or more (e.g., two) convolutional layers (e.g., 3×3 convolutional layers), followed by a LeakyReLU and a 2D bilinear interpolation. In some embodiments, batch normalization (BN) may be integrated after each convolutional layer. In some embodiments, the skip connection(s) may serve to concatenate low-level feature map(s) and high-level feature map(s) of the image(s), enhancing the preservation of spatial information of the image(s).

For denoising process involving 3D datasets (xyz), the U-Net may be shifted from the 2D version to its 3D extension to better leverage the axial spatial information. In some embodiments, the internal operations in the 2D U-Net architecture may be tailored to a 3D framework, so that the 2D U-Net is transformed into the 3D U-Net. For example, the convolution operations may be changed from 3×3 to 3×3×3. As another example, the max pooling may be changed from 2×2 to 2×2×2. As a further example, the interpolation operations may be changed from 2D bilinear to 3D trilinear interpolation.

Exemplary self-constrained learning process may be described below.

In some embodiments, a self-constrained learning process may be performed to constrain the training process and denoising variance (FIG. 1A). In some embodiments, the denoising predictions of the same underlying signal may be identical. In some embodiments, the generated data pair may have matched content but different noise components, thus ideally, the corresponding two denoised results may have no differences. In some embodiments, the two generated images may be successively and individually fed into the network, and a loss function may be calculated based on the two resulting predictions to execute the training process. An exemplary loss function may be expressed as:

$$ℓ = ‖ {\hat{x}}_{1} - {x}_{2} ‖ + ‖ {\hat{x}}_{2} - {x}_{1} ‖ + λ {‖ {\hat{x}}_{1} - {\hat{x}}_{2} ‖}_{1} , \qquad ( 2 )$$

where \tilde{x} represents the network outcome of input x, and ∥ ∥ refers to distance calculation. In some embodiments, the l₁ norm may be used as distance calculation (e.g., Equation (1)). The first term and the second term may be conventional N2N losses, and the third term may be a self-constrained loss with a constraint weight λ. By enforcing this constraint, the low-frequency components may manifest a greater propensity of being stable than the high-frequency ones (FIGS. 8E-8F). Thus, in some embodiments, to avoid over-smoothed results, the constraint weight may be set as 1. It should be noted that, the SN2N process may be model-independent, thus a commonly used U-Net may be used to highlight its ability (FIG. 1A, FIG. 7A).

Exemplary learning and inference processes may be described below.

Regarding the training data generation, in some embodiments, the percentile image normalization may be first applied before training to remove the baseline background and/or moderate the large intensity gap between the bright and dim fluorescence signals, which may be defined for an image x as:

$$N ( x ; {I}_{low} , {I}_{high} ) = \frac{x - perc ( x , {I}_{low} )}{perc ( x , {I}_{high} ) - perc ( x , {I}_{low} )} , \qquad ( 3 )$$

where perc(x, l) is the l-th percentile of all pixel values of x, and l_{low} and l_{high} represent the lowest and highest values, respectively. Notably, for some data under ultra-low SNR conditions, a wavelet-based background subtraction may be executed before this percentile normalization.

For small dataset, in some embodiments, the Patch2Patch pre-augmentation pipeline may be performed on the raw dataset to enlarge the training set (Step. 1, FIG. 7A). Then, a sliding window approach may be employed to generate small patches (e.g., 128×128 or 128×128×16 tiles) suitable as network input for training (Step. 1, FIG. 7A). The interval of the sliding window may be customizable to adjust different image processing requirements (e.g., 64 pixels). In some embodiments, during this step, a background patch rejection may be performed on the fly, in which the patches with averaged intensity twice lower than that of the entire image/volume may be filtered. For these small patches, a resampling strategy (e.g., a spatial diagonal resampling strategy) may be applied to produce pairs of twice smaller sub-images, each sharing identical content but different noise realizations (Step. 2, FIG. 7A). After that, an upsampling (e.g., the Fourier upsampling) may be used to create paired SN2N data to match the original structural scale. Additionally, the conventional data augmentation strategies such as rotation and flipping may be included to further increase the network generalization (Step. 3, FIG. 7A). Finally, the self-constrained learning process may utilize the basic U-Net network and selected either the 2D U-Net or 3D U-Net based on the input data dimensions (Step. 4, FIG. 7A).

In some embodiments, the constraint weight λ may be set as 1. In some embodiments, the models may be optimized utilizing the Adam optimizer with a learning rate of 2×10⁻⁴, and the first-moment and second-moment estimates may be regulated with exponential decay rates of 0.5 and 0.999, respectively. In some embodiments, for every training iteration, the batch size may be set to the maximum number reaching the GPU (graphics processing unit) memory limit (e.g., the training stage may be conducted using NVIDIA GeForce RTX 4090 GPUs). Finally, in the inference process, the raw data after the percentile normalization may be directly fed into the trained SN2N network for predictive analytics. In some embodiments, for input data sizes that exceed the memory limit (most of the volumetric data), the inputs may be automatically cropped into dozens of subvolumes and fed into the SN2N network, and the predictions may be stitched back together to generate the final denoised results.

Exemplary integrations of the SN2N framework with SR reconstructions may be illustrated below.

Exemplary SN2N-enhanced RL deconvolution may be described below.

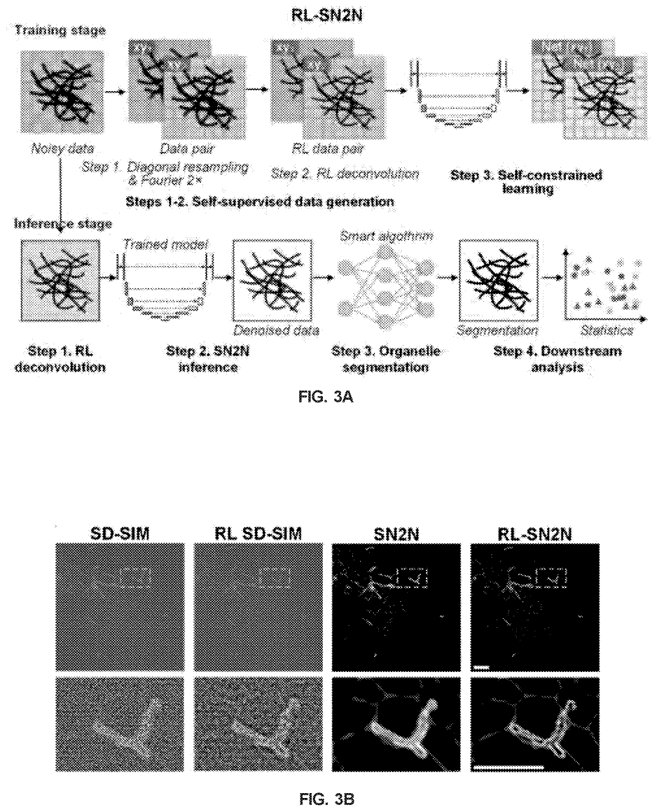

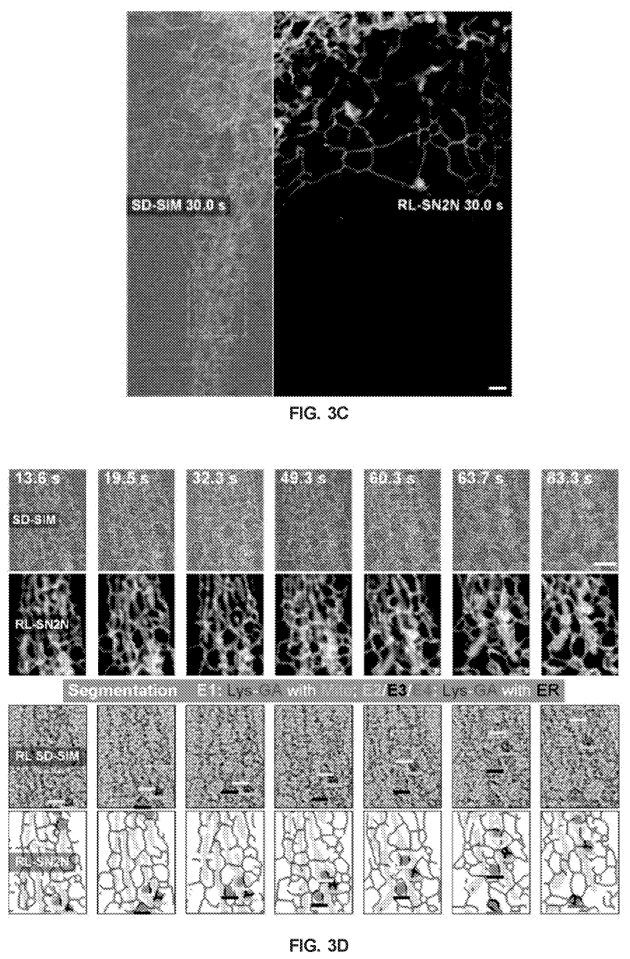

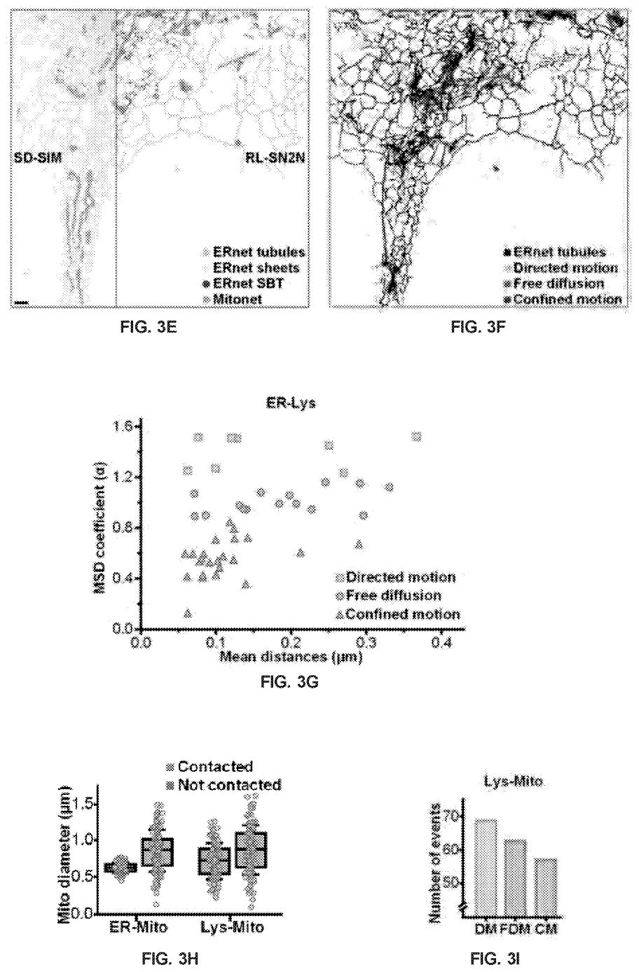

In some embodiments, RL deconvolution may be integrated with the SN2N framework, namely RL-SN2N (FIG. 3A). This approach can leverage the contrast and resolution enhancement capabilities of RL deconvolution while mitigating the artifacts that arise from deconvolution under low SNR conditions. In some embodiments, to preserve the stochastic independence of noise at the pixel level, RL deconvolution may be performed after the initial self-supervised data generation. In some embodiments, an exemplary accelerated RL deconvolution illustrated below may be used:

$${d}^{j + 1} = {d}^{j} \cdot ( {h}^{T} \cdot \frac{g}{h \cdot {d}^{j}} ) , \qquad ( 4 )$$

$${v}^{j} = {d}^{j + 1} - {y}^{j} , \qquad ( 5 )$$

$${α}^{j + 1} = \frac{\sum {v}^{j} \cdot {v}^{j - 1}}{\sum {v}^{j - 1} \cdot {v}^{j - 1}} , \qquad ( 6 )$$

$${y}^{j + 1} = {d}^{j + 1} + {α}^{j + 1} \cdot ( {d}^{j + 1} - {d}^{j} ) , \qquad ( 7 )$$

where yⁿ⁺¹ is the image after n+1 iterations; g is the input image; and h is the PSF. The adaptive acceleration factor α represents the length of an iteration step. The RL deconvolution may be executed by the corresponding theoretically calculated 2D/3D PSFs by the Gaussian kernel approximation. In some embodiments, the iterations may be usually selected by 10-15 times. In the inference phase, the trained RL-SN2N model may be fed with the directly deconvolved image/volume.

Exemplary SN2N-enhanced SOFI may be described below.

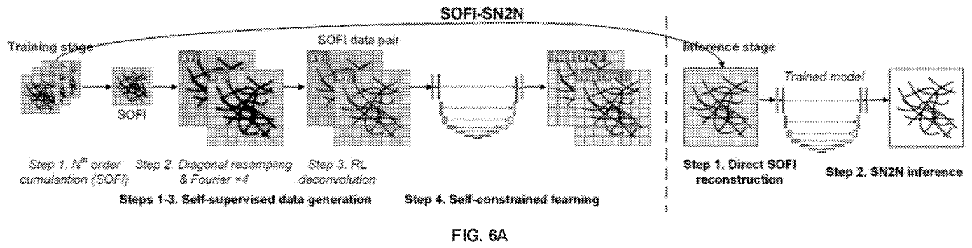

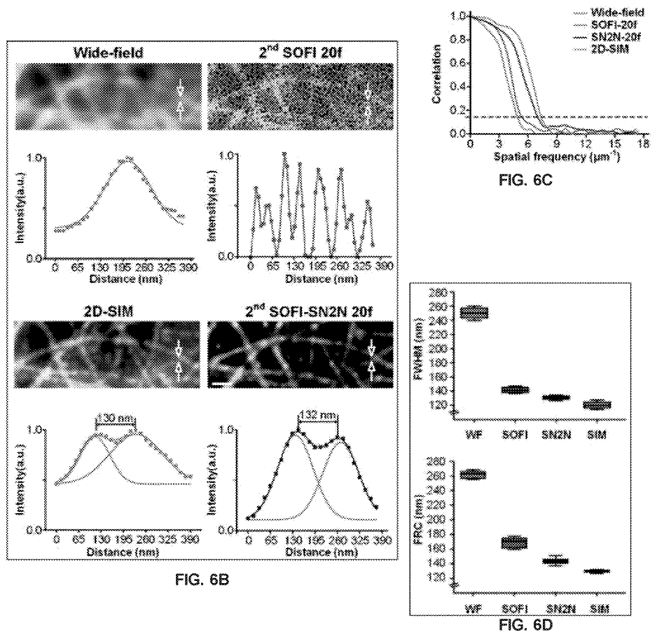

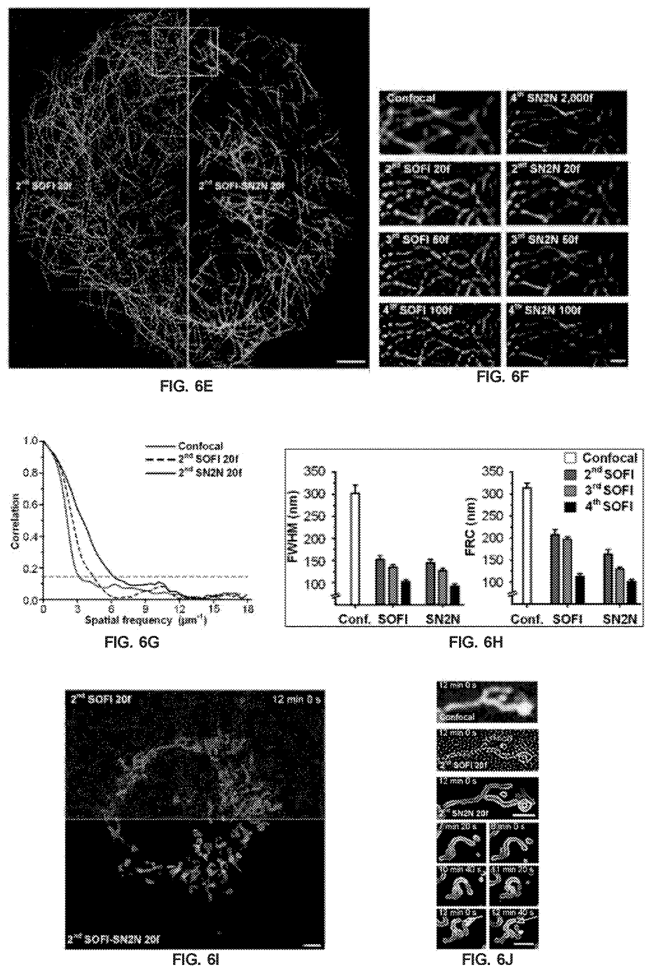

In some embodiments, the SN2N may be integrated into a SOFI reconstruction pipeline (SOFI-SN2N, FIG. 6A) to increase its imaging efficiency. Merely by way of example, after the acquisition of the image sequence, the n^{th} order of auto-correlation cumulant may be calculated, i.e., the 2^{nd}, 3^{rd} and 4^{th} order SOFI, on each pixel along time. Then, the self-supervised data generation and RL deconvolution may be performed successively. In some embodiments, to match the improved spatial resolution, in SOFI-SN2N, 4× Fourier upsampling may be applied on the resampled data pair (e.g., diagonal resampled data pair) rather than a routinely used 2× Fourier upsampling. Finally, after RL deconvolution, an intensity linearization step may be used by taking the n-th root directly to minimize the nonlinear effects of SOFI. In the inference stage, the trained SOFI-SN2N model may be fed with the SR image reconstructed by the n^{th} order SOFI followed by 2× Fourier interpolation before RL deconvolution and intensity linearization.

Exemplary SN2N-enhanced SIM may be described below.

In some embodiments, one or more strategies may be used for artifacts removal of SR-SIM images. Mostly, the self-supervised data generation may be performed on every modulated raw frame (e.g., 9 frames) for creating the twin SIM sequences. After that, the paired SR-SIM images may be individually reconstructed with the HiFi-SIM pipeline. Finally, these two resulting SIM images may be considered as the training set of the SIM-SN2N network. In the test stage, the ordinary SIM reconstruction may be directly inputted into the SIM-SN2N network.

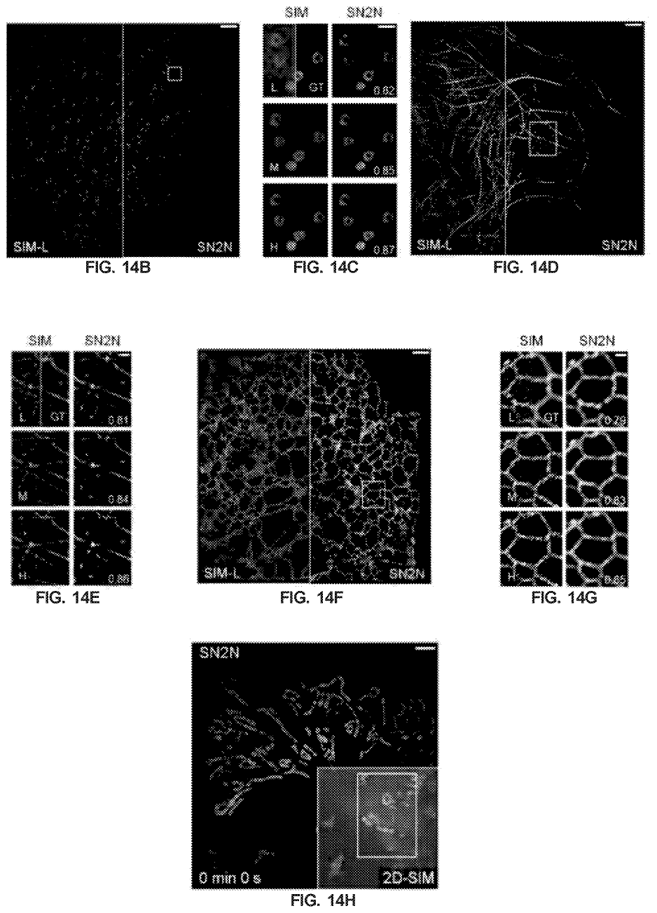

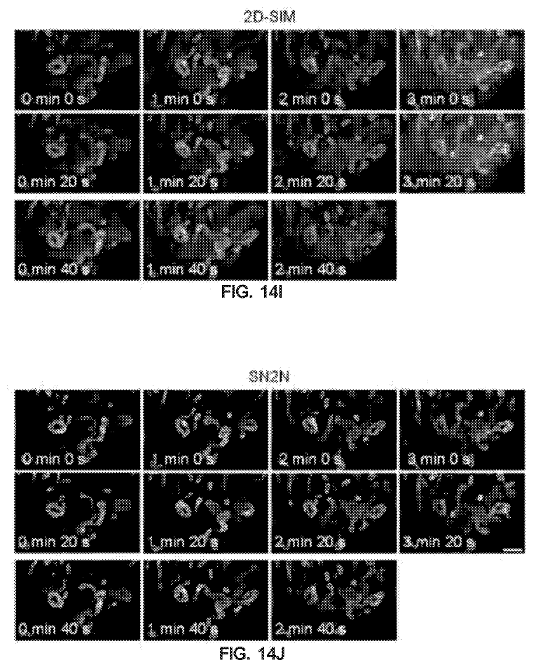

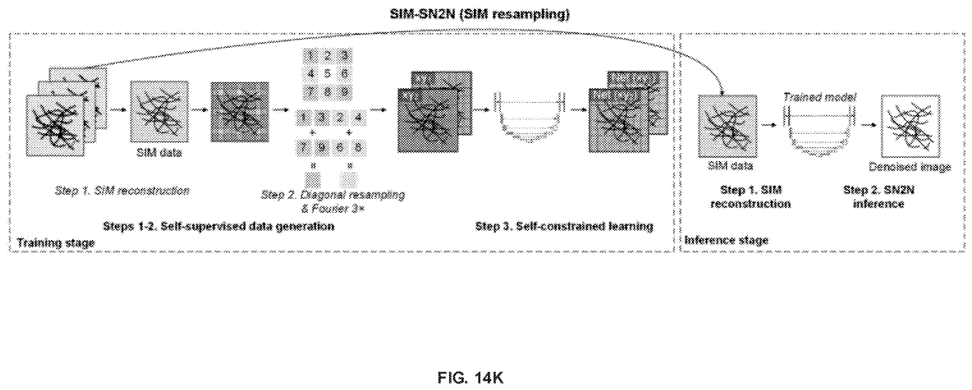

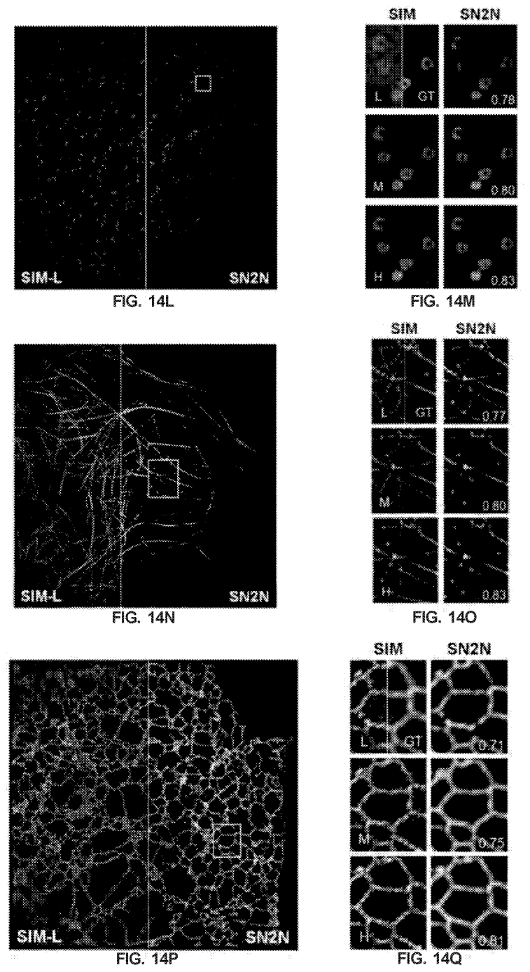

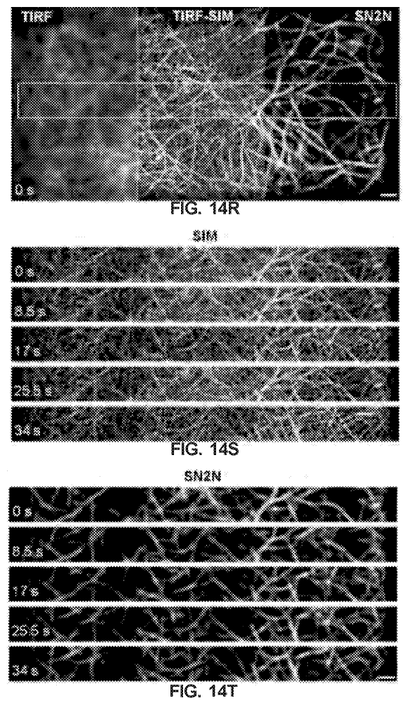

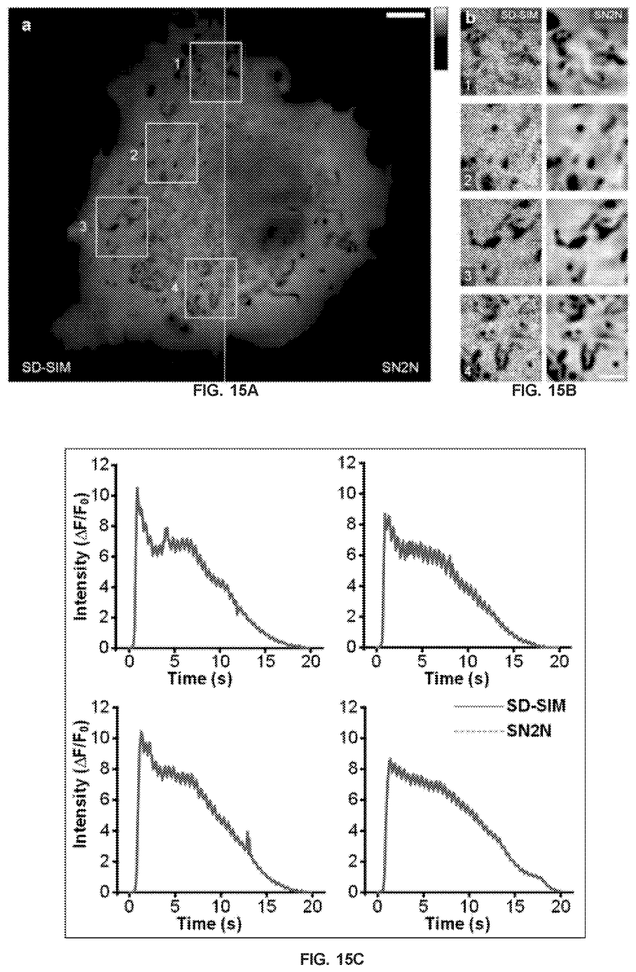

In some embodiments, the self-supervised data generation may influence the parameter estimation, especially under ultra-low SNR conditions for ultra-fast imaging, leading to failed reconstruction. On the other hand, the SIM reconstruction may bring the inherent artificial upsampling (2-fold), and hence the adjacent pixels may be highly correlated. To create independent data pairs from SIM reconstruction, the resampling step may be performed within 3×3 pixels (FIG. 14A, FIG. 14K). In some embodiments, every 9 pixels may be assembled as one unit, as shown in FIG. 24B. Then a special binning operation may be applied on these 9 pixels to create two new pixels for the N2N data pair. Merely by way of example, the four corner pixels, “1”, “3”, “7” and “9” may be averaged to obtain a new pixel; and the other four intermediate pixels, “2”, “4”, “6” and “8” may be averaged to obtain the other new pixel. Throughout the input image, two 3× subsampled images may be created. Followed by a 3× Fourier upsampling, the required data pair may be obtained directly from an SR-SIM image.

Exemplary SN2N-empowered automated subcellular segmentation and tracking may be illustrated below.

Exemplary subcellular segmentation may be described below.

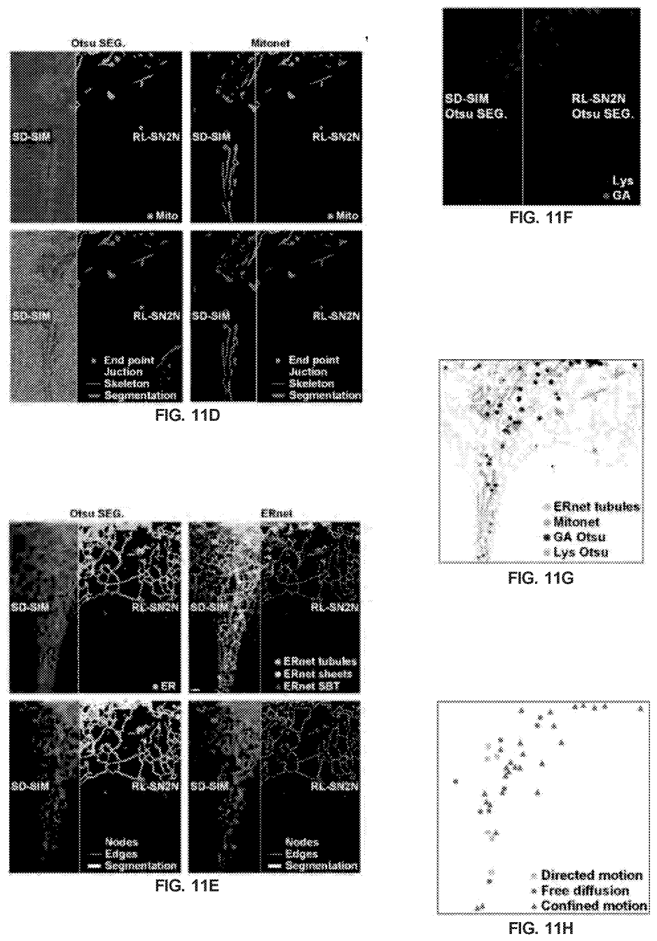

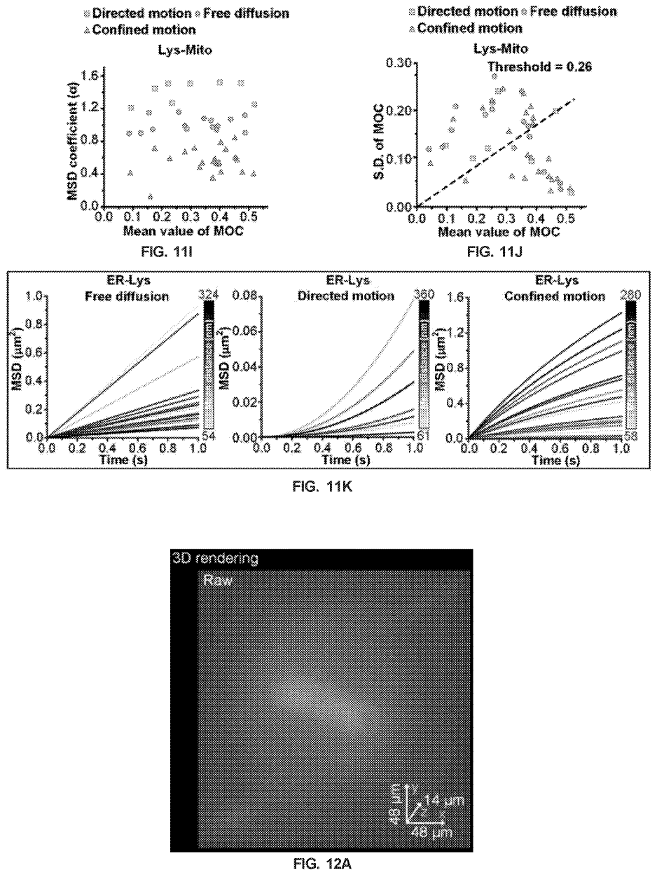

In some embodiments, the Otsu method may be employed to automatically determine the hard thresholds for identifying the corresponding organelle features in images. Additionally, to achieve more precise segmentation, pre-trained models may be utilized from several learning-based approaches, e.g., Ernet for ER structures and Mitonet for Mito shapes. Following the segmentation of ER, isolated pixels in the binarized masks may be eliminated and then the skeleton structures may be extracted for the network topology construction, in which the nodes may represent intersections in the skeleton graph, and edges may represent connections between these nodes. After Mito segmentation, the connected domains within the binary masks may be computed and the skeletons and key points may be identified. These key points may be subsequently categorized into junctions or end points based on their respective topological positions (FIG. 11D).

Exemplary tracking of Lys may be described below.

Tracking of Lys may be performed using TrackMate 7.11.1. To characterize their dynamic behaviors, the mean square displacement (MSD) may be computed for the trajectories across all timepoints. The calculated MSD curves may be approximated with a power-law function. An exemplary power-law function may be illustrated below:

$$MSD ( t ) = Γ \times {t}^{α} , \qquad ( 8 )$$

where t represents the time interval, Γ is the proportionality factor that relates to both particle motion dynamics and the physical properties of the system, and α characterizes the different modes of particle movements. Then, a logarithmic transformation may be applied to the MSD formula, followed by a linear regression to estimate α:

$$log ( MSD ) = α \times log ( t ) + log ( Γ ) . \qquad ( 9 )$$

In some embodiments, the Lys movements may be classified into confined motion (α<0.85), free diffusion (0.85≤α≤1.2), and directed movement (α>1.2).

Exemplary Mito diameter estimation may be described below.

To estimate the Mito diameter at a selected point, the tangent line of the nearest Mito contour may be drawn. Using the perpendicular line of this tangent line, the other intersected point may be obtained to the opposite Mito contour. Finally, the diameter may be approximated by measuring the distance between the initially selected point and this intersection point.

Exemplary ER-Lys distance estimation may be described below.

The edges of ER tubules may be identified from the Ernet-generated masks, and the distances may be calculated based on the centroid coordinates of Lys and the most adjacent ER edges. Then, the final ER-Lys distances may be quantified by averaging the distances across the entire trajectory.

Exemplary ER-Mito distance estimation may be described below.

The ER-Mito contact level may be quantified by the minimum distance from each Mito to the edges of ER tubules, in which the distances as 0 may be distributed as contacted and larger than 0 as not-contacted. The Mito diameter may be estimated at the point with the closest ER-Mito distance.

Exemplary Lys-Mito interactions may be described below.

The Mander's overlap coefficient (MOC) may be calculated to examine the Lys-Mito interactions. The masks of Mito and Lys may be convolved with the PSF of the SD-SIM system, and the MOC values may be calculated from the resulting masks at each timepoint. Subsequently, the ratio of the mean value and standard deviation of the MOC curve may be calculated and an empirical threshold of 0.26 may be obtained, in which the associated MOC values larger than this threshold may be identified as functional sites in specific instances of Lys-Mito contact (FIG. 11J). With MOC values below the threshold, intersection points on the Mito edge may be identified from the connecting line of Lys and Mito centroids. It may be used as the selected point for the Mito diameter estimation. For events of MOC values higher than the threshold, the perpendicular line of the connecting line from the two intersection points between the edges of Lys and Mito may be drawn, and the intersection of this perpendicular line and the Mito edge may be picked as the selected point for the Mito diameter estimation.

Exemplary simulations of microtubule filaments may be described below.

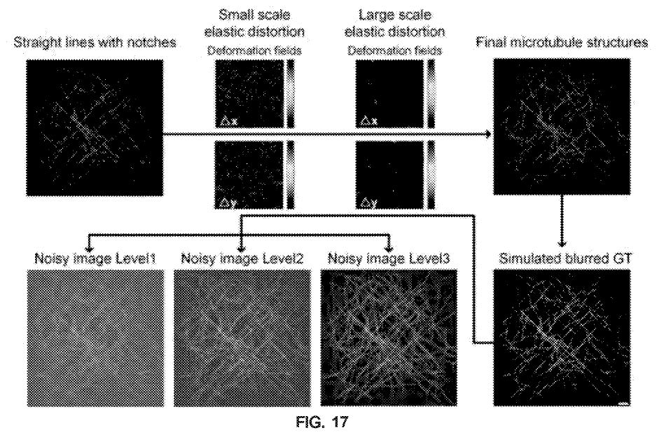

To perform benchmarks with simulated ground-truth, the microtubule-like structures may be created. In some embodiments, the insertShape (MATLAB function) may be utilized to sketch multiple lines with random orientations on a blank canvas of 4096×4096 pixels (FIG. 17). To simulate the effect of incomplete labeling observed in practical tests, a small Gaussian mask (σ as 2 pixels) may be applied, introducing random notches along the lines (indicated by red circles in FIG. 17). Then, to mimic the curviness of cytoskeleton, an elastic deformation may be applied to bend the straight lines to curved lines in both x and y dimensions, in which the resulting image may be considered its pixel size as 16.25 nm. The synthetic structures may be convolved with a 150 nm size PSF and downsampled by 2-fold, for 2048×2048 pixels with a 32.5 nm pixel size (simulated blurred ground-truth). Finally, the images may be contaminated by three different Poisson-Gaussian noise levels (10%, 20%, and 40%).

Exemplary pixel-wise metrics may be described below.

In some embodiments, the SSIM, PSNR, and RMSE may be used as metrics to evaluate the pixel-level consistency between reconstructed images and ground-truth images. For the fixed samples, the exposure time may be directly enlarged to acquire the high SNR data. To remove potential small baseline background and noise, the ground-truth images may be created from these high SNR images by subtracting a constant background value and subsequently filtering a small Gaussian kernel. To qualify data and model uncertainties, the standard deviation (STD) may be adopted using the ten predictions from ten repetitively collected inputs or ten repetitively trained models:

$$STD = {\sum }_{x , y} \sqrt{\frac{{\sum }_{i = 1}^{n} {( {I}_{i} - {〈 I 〉}_{1 ∼ n} )}^{2}}{n - 1}} , \qquad ( 10 )$$

where n is the sequence length (default as 10); Iᵢ(x, y) represents the intensity of the i^{th} image in the sequence, and (I(x,y))_{1~n} is the averaged intensity of the sequence.

Exemplary FRC resolution estimation may be described below.

The calculation of FRC resolution may require two independent frames of identical contents under the same imaging conditions. In case of confocal, SD-SIM, and STED, the same content may be repetitively acquired twice. For SOFI, these two frames may be generated by splitting the raw image sequence into two image subsets, e.g., the first 20 frames and the last 20 frames, and they may be reconstructed independently.

Exemplary line restoration ratio (LQR) estimation may be described below.

To quantitatively evaluate the reconstruction quality of parallel lines, the line quality ratio (LQR) metric may be employed:

$$L R Q = \frac{2 \times Avg ( {Region}_{0} )}{Avg ( {Region}_{1} ) + Avg ( {Region}_{2} )} . \qquad ( 11 )$$

where the Region₁, Region₂, and Region₀ represent the parallel lines and the region in between, and Avg calculates the mean intensity of pixels within the corresponding area. To avoid overconfident determination, a threshold of 0.2 may be used to ascertain the successful separation of parallel lines.

Exemplary prediction uncertainty estimation may be described below.

An optimized denoising algorithm can be characterized by minimal data and model uncertainties. Data uncertainty may indicate the algorithm's ability to efficiently reduce noise (minimize errors), whereas model uncertainty may reflect the model's efficiency in utilizing data (sustain performance under limited or varying data conditions). To estimate data uncertainty, ten independent frames of identical contents may be collected under the same imaging conditions and they may be fed to the trained SN2N network. The STD of the ten resulting predictions may be calculated as the data uncertainty. Regarding the model uncertainty, the DNNs may be repetitively trained with ten times and the same data may be inputted into these ten models. The STD of the resulting predictions may serve as a measure of model uncertainty.

Exemplary FWHM measurements may be described below.

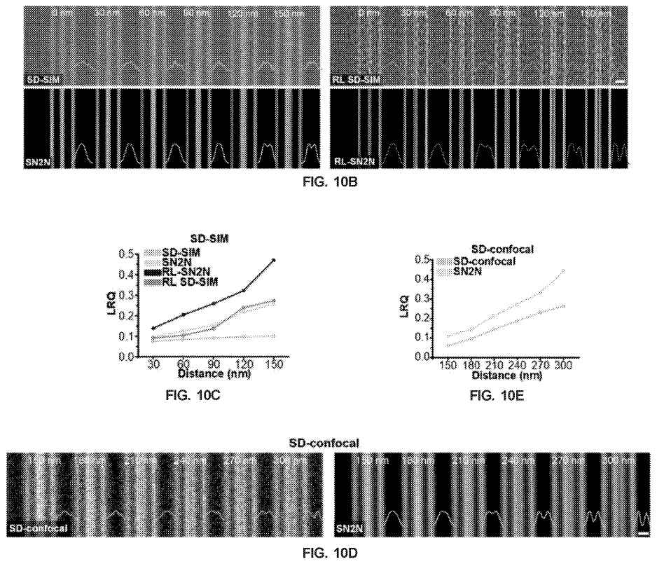

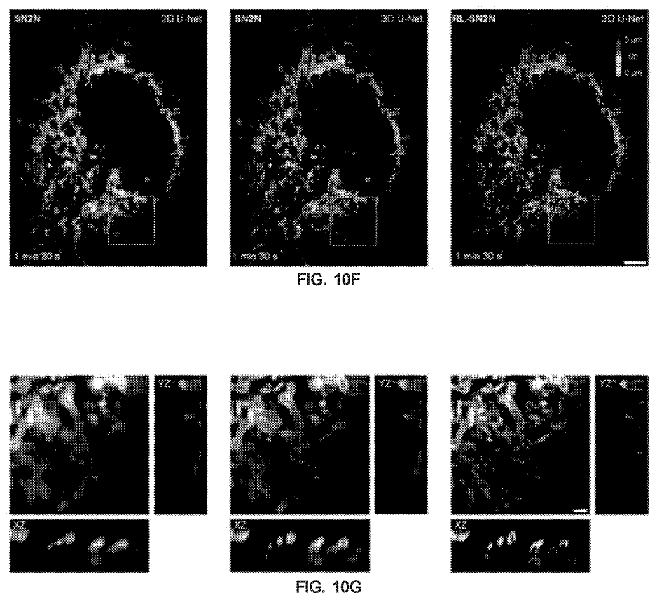

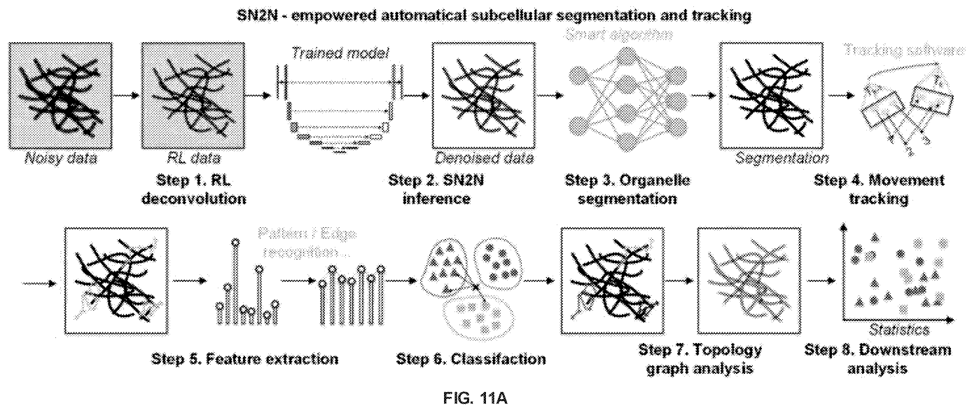

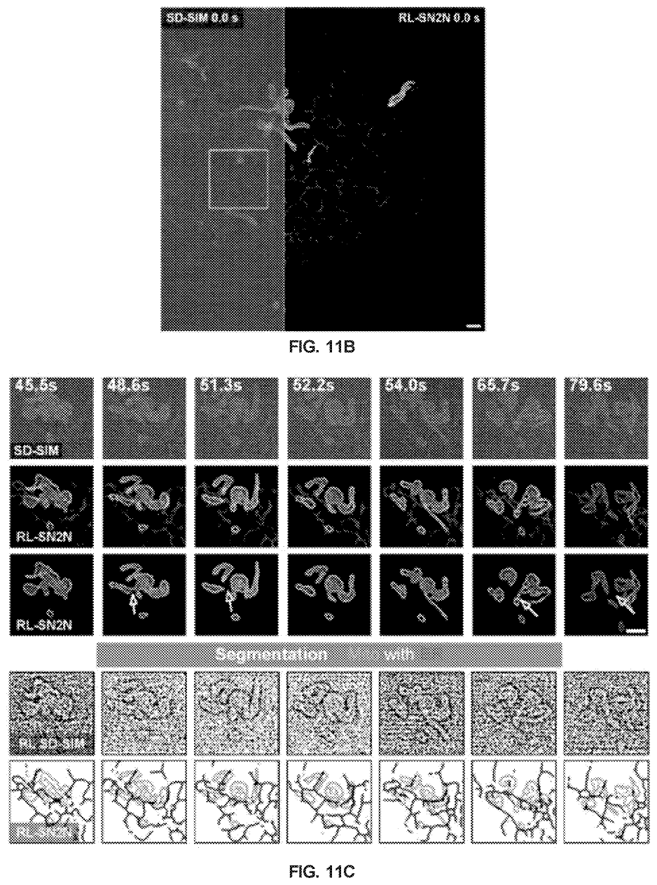

The FWHM values may be estimated from the Gaussian fittings of the manually picked intensity profiles. Particularly, the profiles and values plotted in FIG. 10A may be automatically created by using the LuckyProfiler ImageJ plugin, which can autonomously identify and quantify the optimal FWHM locations within images. The necessary regions may be selected for FWHM calculations and Gaussian fitting algorithms may be applied.

Exemplary SD-SIM setup may be described below.

Two commercial SD-SIM systems may be used to capture SR confocal images. The denoising performance may be validated using a commercial fluorescent sample (the Argo-SIM slide, Argolight, France) with ground-truth patterns consisting of fluorescing double line pairs (spacing from 0 nm to 390 nm, λₑₓ=300-550 nm) under the SpinSR10 system and conducted live-cell imaging tests using the Live-SR system.

Exemplary SpinSR10 system may be described below.

The SpinSR10 system may be a commercial SD-SIM (SpinSR10, Olympus, Japan) equipped with a wide-field objective (×100/1.49 oil, APON, Olympus) and an sCMOS camera (ORCA Fusion, Hamamatsu, Japan). Four laser beams of 405 nm, 488 nm, 561 nm, and 640 nm may be combined with the SD-SIM. The detection optical path may adopt a further 3.2× magnification, and the total magnification may be 320 times. SD-SIM images may be captured in its SoRa (super-resolution) mode and collected confocal images may be captured by switching to its conventional SD-confocal mode.

Exemplary Live-SR system may be described below.

The Live-SR SD-SIM may be set based on an inverted fluorescence microscope (IX81, Olympus) equipped with a wide-field objective (100×/1.3 oil, Olympus), a scanning confocal system (CSU-X1, Yokogawa), and a Live-SR module (GATACA systems, France). Four laser beams of 405 nm, 488 nm, 561 nm, and 647 nm may be combined with the SD-SIM. The images may be captured either by an sCMOS camera (C14440-20UP, Hamamatsu) or an EMCCD camera (iXon3 897, Andor, United Kingdom).

Exemplary STED setup may be described below. STED images may be acquired from two commercial STED systems.

Exemplary Abberior STED may be described below.

Long-term activities of mitochondrial cristae (PKMO labeled) may be recorded by a commercial STED microscope (STEDYCON, Abberior Instruments, Germany) equipped with a wide-field objective (100×/1.45, CFI Plan Apochromat Lambda D, Nikon, Japan). PKMO may be excited at 561 nm wavelength, and STED may be performed using a pulsed depletion laser at 775 nm wavelength with gating of 1 to 7 ns and dwell times of 10 μs. A pixel size of 25 nm may be used for STED recording and each line may be scanned 1 or 10 times (line accumulations). The pinhole may be set to 0.7 to 1.0 AU.

Exemplary Leica STED may be described below.

Other live-cell STED images may be obtained using a gated STED (gSTED) microscope (TCS SP8 STED 3X, Leica, Germany) equipped with a wide-field objective (100×/1.40 oil, HCX PL APO, Leica). The excitation and depletion wavelengths may be 488 nm and 592 nm for the Sec61β-GFP and LifeAct-GFP, 594 nm and 775 nm for the Alexa Fluor 594, 635 nm and 775 nm for the Alexa Fluor 647, 651 nm and 775 nm for SiR-tubulin. The detection wavelength range may be set to 495-571 nm for GFP, 605-660 nm for Alexa Fluor 594, 657-750 nm for SiR, and 649-701 nm for Alexa Fluor 647. For comparison, confocal images may be acquired in the same field before the STED imaging. All images may be obtained using the LAS AF software (Leica).

Exemplary SOFI setup may be described below.

Exemplary wide-field microscopy may be described below.

The three phases of structured illumination under the same orientation can be averaged to a uniform wide-field illumination. Taking advantage of that, the SIM setup described in the above section may be use to generate the wide-field images by integrating three frames (corresponding to three phases of structured illumination) on the camera plane, which may enable more flexible cross-validation of SIM and SOFI-SN2N results. In other words, the identical commercial inverted fluorescence microscope (IX83, Olympus) equipped with an objective (100×/1.7 HI oil, APON, Olympus) and a sCMOS (Flash 4.0 V3, Hamamatsu, Japan) camera may be employed to capture the wide-field images for SOFI-SN2N reconstruction.

Exemplary SD-confocal microscopy may be described below.

A commercial SD-confocal microscope system (Dragonfly SD system, Andor) based on an inverted fluorescence microscope (Dmi8, Leica) with a wide-field objective (100×/1.3 oil, Plan Apo, Leica), may be used. Four laser beams of 405 nm, 488 nm, 561 nm, and 647 nm may be combined with the SD-confocal microscope. The images may be captured by a sCMOS camera (Zyla 4.2 Plus, Andor).

Exemplary SIM setup may be described below.

The SIM system may be set based on a commercial inverted fluorescence microscope (IX83, Olympus) equipped with an objective (×100/1.49 oil, UAPON, Olympus, for 2D-SIM; 100×/1.7 HI oil, APON, Olympus, for TIRF-SIM) and a multiband dichroic mirror (DM, ZT405/488/561/640-phase R; Chroma) as described previously. In short, laser light with wavelengths of 488 nm (Sapphire 488LP-200) and 561 nm (Sapphire 561LP-200, Coherent) and acoustic optical tunable filters (AOTF, AA Opto-Electronic, France) may be used to combine, switch, and adjust the illumination power of the lasers. A collimating lens (focal length: 10 mm, Lightpath) may be used to couple the lasers to a polarization-maintaining single-mode fiber (QPMJ-3AF3S, Oz Optics). The output lasers may be then collimated by an objective lens (CFI Plan Apochromat Lambda 2×NA 0.10, Nikon) and diffracted by the pure phase grating that consisted of a polarizing beam splitter, a half-wave plate, and the SLM (3DM-SXGA, ForthDD). The diffraction beams may be then focused by another achromatic lens (AC508-250, Thorlabs) onto the intermediate pupil plane, where a carefully designed stop mask may be placed to block the zero-order beam and other stray light and to permit passage of ±1 ordered beam pairs only. To maximally modulate the illumination pattern while eliminating the switching time between different excitation polarizations, a home-made polarization rotator may be placed after the stop mask. Next, the light may pass through another lens (AC254-125, Thorlabs) and a tube lens (ITL200, Thorlabs) to focus on the back focal plane of the objective lens, which may interfere with the image plane after passing through the objective lens. Emitted fluorescence collected by the same objective may pass through a dichroic mirror, an emission filter, and another tube lens. Finally, the emitted fluorescence may be split by an image splitter (W-VIEW GEMINI, Hamamatsu, Japan) before being captured by a sCMOS (Flash 4.0 V3, Hamamatsu) camera.

Exemplary expansion microscopy setup may be described below.

The commercial inverted fluorescence microscope (IX83, Olympus) equipped with a wide-field objective (100×/1.49 oil, UAPON, Olympus) and a sCMOS (Flash 4.0 V3, Hamamatsu) camera may be used to capture the wide-field images of the expanded samples.

Exemplary imaging sample preparation may be described below.

Exemplary cell maintenance and preparation may be described below.

COS-7 cells (ATCC, CRL-1651) and HeLa cells (ATCC, CCL-2) may be cultured in high-glucose DMEM (Gibco, 21063029) supplemented with 10% fetal bovine serum (FBS) (Gibco) and 1% 100 mM sodium pyruvate solution (Sigma-Aldrich, S8636) in an incubator at 37° C. with 5% CO₂ until ~75% confluency may be reached. MCF7 cells may be cultured in MEM (thermo fisher, 11095072) supplemented with 10% fetal bovine serum (FBS), 0.01 mg/ml human recombinant insulin (Sigma, 19278), and 1% 100 mM sodium pyruvate solution. For the SD-SIM/SD-confocal/STED imaging, 35-mm glass-bottomed dishes (Cellvis, D35-14-1-N) may be used. For the wide-field and 2D-SIM imaging, cells may be seeded onto coverslips (H-LAF 10 L glass, reflection index: 1.788, diameter: 26 mm, thickness: 0.15 mm, customized) coated with 0.01% Poly-L-lysine solution (Sigma, P4707) for 10 minutes and washed twice with Sterile Water before seeding transfected cells.

Exemplary live-cell samples for SD-SIM and SIM may be described below.

To label late endosomes or lysosomes (Lys), COS-7 cells may be incubated in 50 nM LysoTracker Deep Red (Thermo Fisher Scientific, L12492) for 45 min and may be washed 3 times in PBS before imaging. To label mitochondria, COS-7 cells may be incubated with 250 nM MitoTracker™ Green FM (Thermo Fisher Scientific, M7514) and 250 nM MitoTracker® Deep Red FM (Thermo Fisher Scientific, M22426) in HBSS containing Ca²⁺ and Mg²⁺ or no phenol red medium (Thermo Fisher Scientific, 14025076) at 37° C. for 15 min before being washed three times before imaging. To perform nuclear staining on COS-7 cells, SPY650-DNA (Cytoskeleton, CY-SC501) may be diluted to 1:1000 in PBS for ~1 h and washed 3 times in PBS.

To label cells with genetic indicators, COS-7 cells may be transfected with LifeAct-EGFP/LAMP1-EGFP/LAMP1-mChery/Tom20-mCherry/Sec61β-EGFP/Golgi-BFP/mGold-Mito-N-7/DsRed-ER. The transfections may be executed using Lipofectamine™ 2000 (Thermo Fisher Scientific, 11668019) according to the manufacturer's instructions. After transfection, cells may be plated in pre-coated coverslips. Live cells may be imaged in a complete cell culture medium containing no phenol red in a 37° C. live cell imaging system. For the calcium lantern imaging in SD-SIM, the calcium signal may be stimulated with a micropipette containing 10 μmol/L 5′-ATP-Na₂ solutions (Sigma-Aldrich, A1852).

Exemplary samples for STED imaging may be described below.

To label the ER tubules/actin/microtubule in live cells, COS-7 cells may be either transfected with Sec61β-EGFP/Lifeact-EGFP, or incubated with SiR-Tubulin (Cytoskeleton, CY-SC002) for ~20 mins without wash before imaging. For immunofluorescence experiments, HeLa cells may be quickly rinsed with PBS and immediately fixed with prewarmed 4% PFA (Santa Cruz Biotechnology, sc-281692). After rinsing three times with PBS, cells may be permeabilized with 0.1% Triton® X-100 (Sigma-Aldrich, X-100) in PBS for 15 mins. Cells may be blocked in 5% BSA/PBS for 1 h in room temperature. Primary antibodies (monoclonal mouse anti-Nup107, Mab414, 1:1000 dilution, Abcam, ab24609; mouse anti-Tom20, 1:1000 dilution, 29/Tom20, BD Biosciences, 612278; monoclonal rat anti-Tubulin, YL1/2, 1:1000 dilution, Abcam, ab6160) may be incubated in 2.5% BSA/PBS blocking solution in 4° C. cold room overnight, followed by the final washing in PBS. Secondary antibodies (goat anti-mouse conjugated to Alexa Fluor 594, Abcam, ab150120; goat anti-rat conjugated to Alexa Fluor 647, Abcam, ab150167) may be used at concentrations of 1:500 and incubated in 2.5% BSA/PBS blocking solution at room temperature, followed by washing.

Exemplary immunofluorescence for SOFI may be described below.

The COS-7 cells may be grown in 35-mm glass-bottomed dishes overnight and rinsed with PBS, then immediately fixed with prewarmed 4% PFA (Santa Cruz Biotechnology, sc-281692) for 10 mins. After three washes with PBS, cells may be permeabilized with 0.1% Triton® X-100 (Sigma-Aldrich, X-100) in PBS for 10 mins. Cells may be blocked in 5% BSA/PBS for 1 h in room temperature. Mouse anti-Tubulin DM1a (Sigma, T6199) may be diluted to 1:100 and stained cells in 2.5% BSA/PBS blocking solution for 2 h at room temperature. The cells may be then washed with PBS five times for 10 mins per wash and stained with biotin-XX goat anti-mouse IgG antibody (Invitrogen, B2763). The cells may be then washed with PBS five times for 10 mins per wash and stained with Qdot™ 525 Streptavidin Conjugate (Invitrogen, Q10143MP) for 60 mins. Finally, cells may be washed five times with PBS and imaged.

Exemplary live-cell samples for SOFI may be described below.

To label the mitochondria in live cells, COS-7 cells may be transfected with Skylan-S-TOM20. The transfections may be executed using Lipofectamine™ 2000 (Thermo Fisher Scientific, 11668019) according to the manufacturer's instructions. After transfection, cells may be plated in glass-bottomed dishes. The Skylan-S may be under sequential illumination with a 405 nm laser (low power) when imaging. In addition, live cells may be imaged in complete cell culture medium containing no phenol red in a 37° C. live cell imaging system.

Exemplary sample preparation for expansion microscopy may be described below.

Exemplary sample expansion may be described below.

The sample expansion may be performed. The labeled cells may be incubated with 0.1 mg mL⁻¹ of Acryloyl-X (AcX, Thermo, A20770) diluted in PBS overnight at r.t. and washed three times with PBS. To prepare the gelation solution, freshly prepared 10% (w/w) N,N,N′,N′-tetramethylethylenediamine (TEMED, Sigma, T7024) and 10% (w/w) ammonium persulfate (APS, Sigma, A3678) may be added to the monomer solution (1×PBS, 2 M NaCl, 2.5% (w/v) acrylamide (Sigma, A9099), 0.15% (w/v) N,N′-methylenebisacrylamide (Sigma, M7279) and 8.625% (w/v) sodium acrylate (Sigma, 408220)) to a final concentration of 0.2% (w/w) each. Next, the cells may be embedded with the gelation solution first for 5 min at 4° C., and then for 1 h at 37° C. in a humidified incubator. The gels may be immersed into the digestion buffer (50 mM Tris, 1 mM EDTA, 0.1% (v/v) Triton X-100, and 0.8 M guanidine HCl, pH 8.0) containing 8 units mL⁻¹ proteinase K (NEB, P8107S) at 37° C. for 4 h, and then placed into ddH₂O to expand. Water may be changed 4-5 times until the expansion process reached a plateau. By determining the gel sizes of before and after the expansion, the expansion factor may be quantified to be 4.5 times. The gels may be immobilized on poly-D-lysine-coated glass No. 1.5 cover-glass for further imaging.

Exemplary α-tubulin immunostaining may be described below.

COS-7 cells may be seeded in a Lab-Tek II chamber slide (Nunc, 154534). Cells may be firstly extracted in the cytoskeleton extraction buffer (0.2% (v/v) Triton X-100, 0.1 M PIPES, 1 mM EGTA, and 1 mM MgCl₂, pH 7.0) for 1 min at room temperature (r.t.). Next, the extracted cells may be fixed with 3% (w/v) formaldehyde and 0.1% (v/v) glutaraldehyde for 15 min, reduced with 0.1% (w/v) NaBH₄ in PBS for 7 min, and washed three times with 100 mM glycine. Then the cells may be permeabilized with 0.1% (v/v) Triton X-100 for 15 min, and blocked with 5% (w/v) BSA in 0.1% (v/v) Tween 20 for 30 min. for antibody staining, the cells may be incubated with monoclonal rabbit anti-α-tubulin antibody (EP1332Y, 1:250 dilution, Abcam, ab52866) in antibody dilution buffer (2.5% (w/v) BSA in 0.1% (v/v) Tween 20) overnight at 4° C., washed three times with 0.1% (v/v) Tween 20, incubated with Alexa Fluor 488-conjugated F(ab′)2-goat anti-rabbit secondary antibody (1:1,000 dilution, Thermo, A11070) in antibody dilution buffer for 2 h at r.t. and washed three times with 0.1% (v/v) Tween 20.

Exemplary Sec61β-GFP transfection may be described below.

COS-7 cells may be seeded in a Lab-Tek II chamber slide (Nunc, 154534) and cultured to reach around 50% confluence. For transient transfection of Sec61β-GFP in a single well, 500 ng plasmid and 1 μL of X-tremeGENE HP (Roche) were diluted in 20 μL Opti-MEM sequentially. The mixture may be vortexed, incubated for 15 min at r.t., and applied to cells. 24 h after transfection, the cells may be washed three times with PBS and fixed as described in the α-tubulin immunostaining experiment.

Exemplary STED images with different excitation/depletion laser powers may be described below.

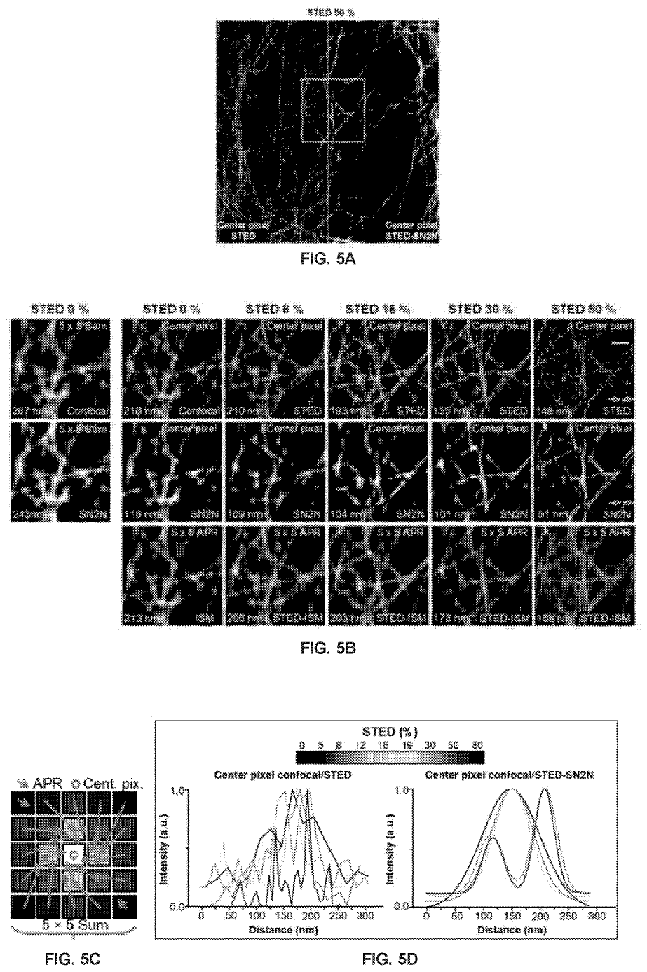

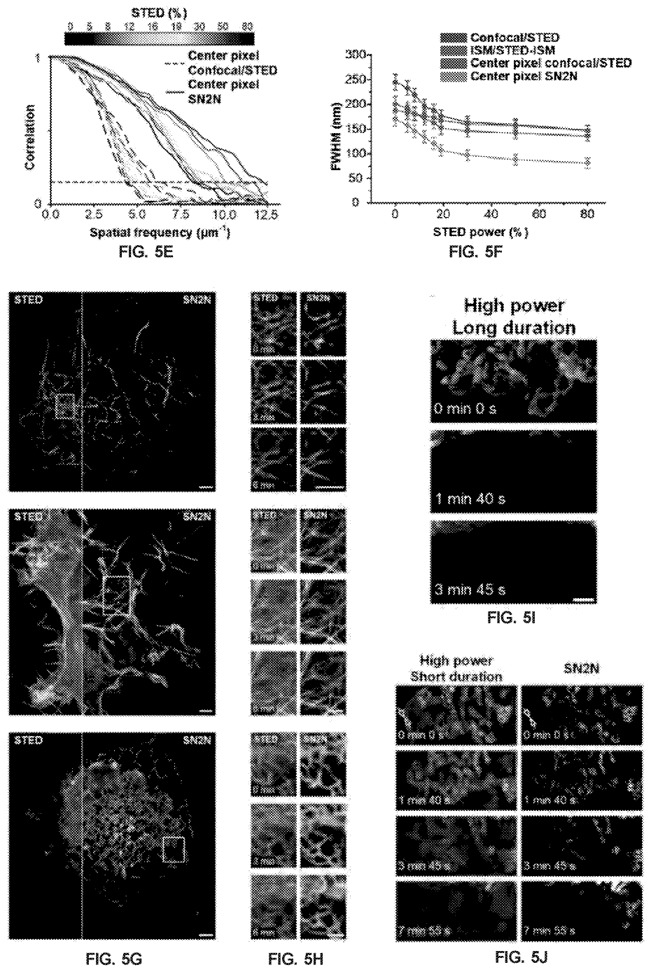

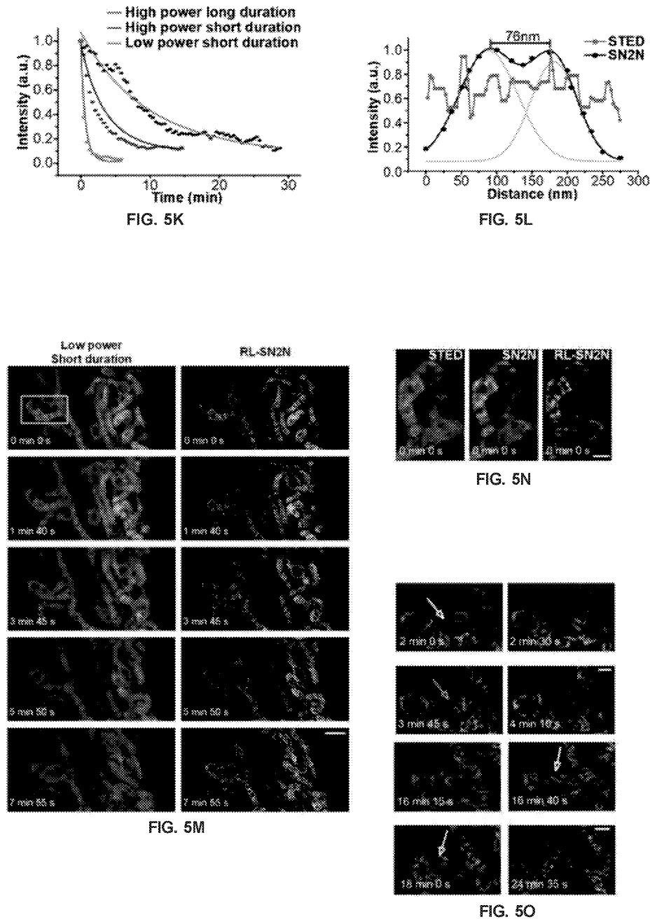

One or more datasets may be used for testing the SN2N's denoising performance on STED images. A custom STED system incorporating a SPAD array detector with 5×5 elements may be used for data collection. A series of images (FIG. 5A) may be collected from living HeLa cells labeled with SIR tubulin under gradually increased STED power (0%, 5%, 8%, 12%, 16%, 19%, 30%, 50%, and 80% depletion laser powers). Another series of images (FIG. 23) may be acquired from α-tubulin labeled fixed HeLa with gradually increased STED power (0%, 10%, 20%, 25%, 30%, 40%, and 90% depletion laser powers). With 0% depletion laser power, the system may be switched to a conventional point-scanning confocal mode. The direct sum and the reassigned sum of signals from 25 elements may be used as confocal/STED and ISM/STED-ISM images, respectively.

Exemplary Bio-SR SIM datasets may be described below.

One or more datasets (e.g., the BioSR dataset) may be used for evaluating the denoising performance on SIM images. The CCPs (clathrin-coated pits), microtubules, and ER data under different noise levels may be used as SIM images of high, medium, and low SNR conditions in some embodiments.

Exemplary image rendering and processing may be described below.

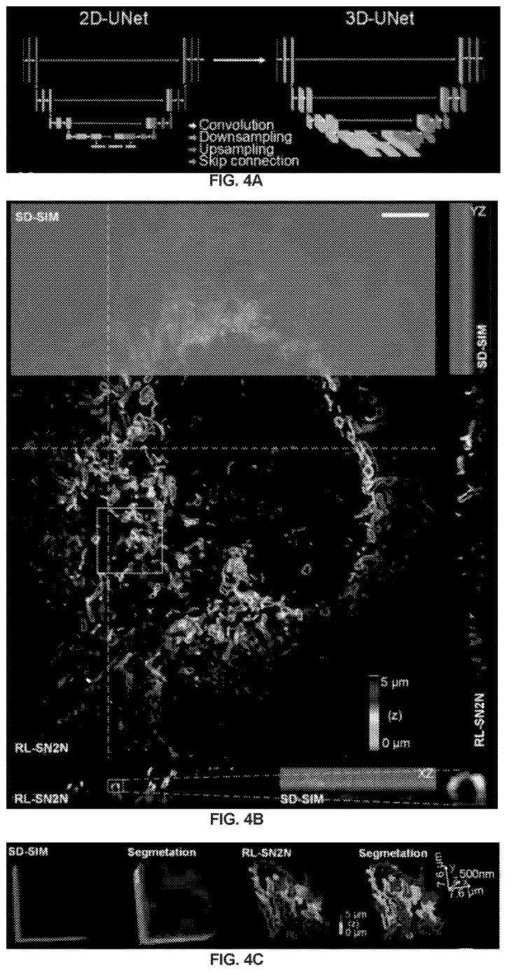

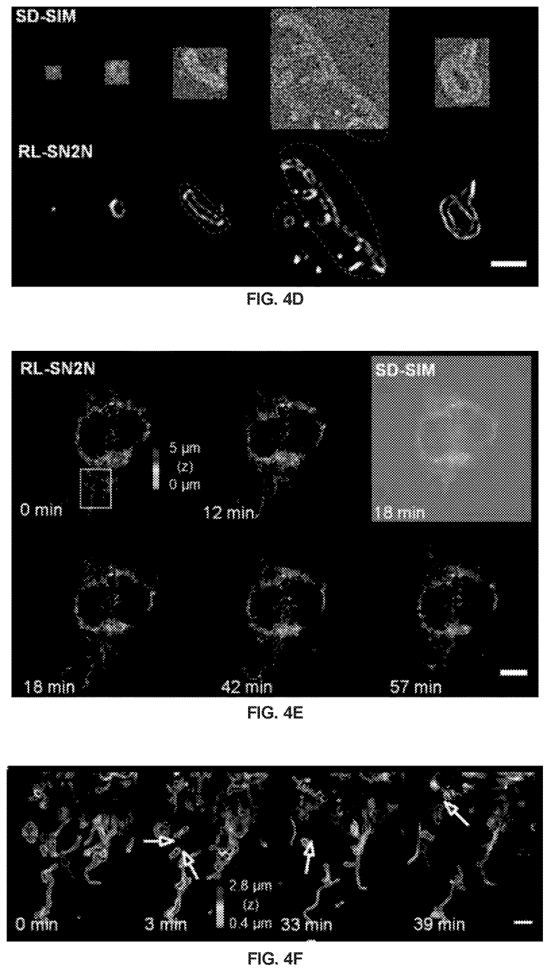

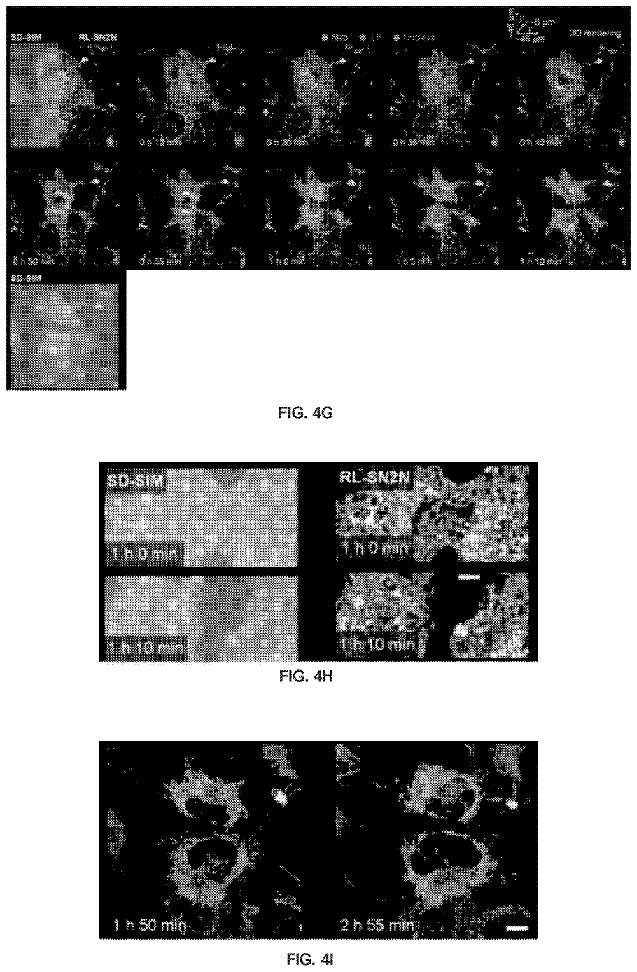

The ‘biop-12colors’ color map may be used to color code the 3D volumes in FIGS. 4B, 4E, 4F, FIGS. 15E, 15F, and FIGS. 16A-16F. The 3D volumes in FIGS. 4G-4I, and FIGS. 11A, 11C, 11E may be rendered using the Microscape software. In some embodiments, data processing may be achieved using MATLAB and ImageJ.

Exemplary results may be described below.

Exemplary simulation validation may be described below.

To quantitatively test the SN2N's performance, the SN2N is first validated on synthetic microtubule imaging data with 150 nm resolution and three different Poisson-Gaussian noise levels (FIG. 17). The SN2N process is superior to existing methods in two aspects.

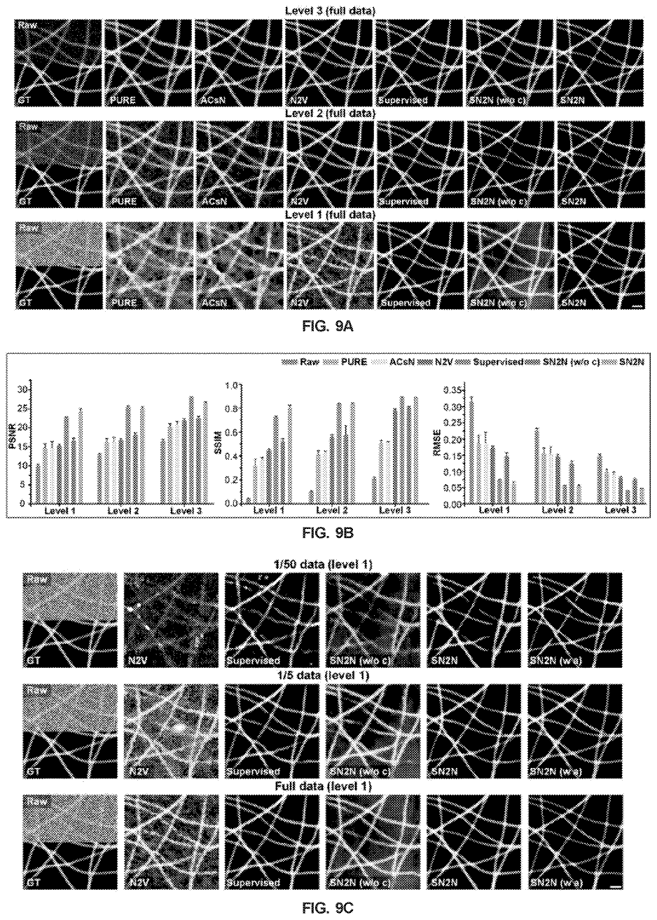

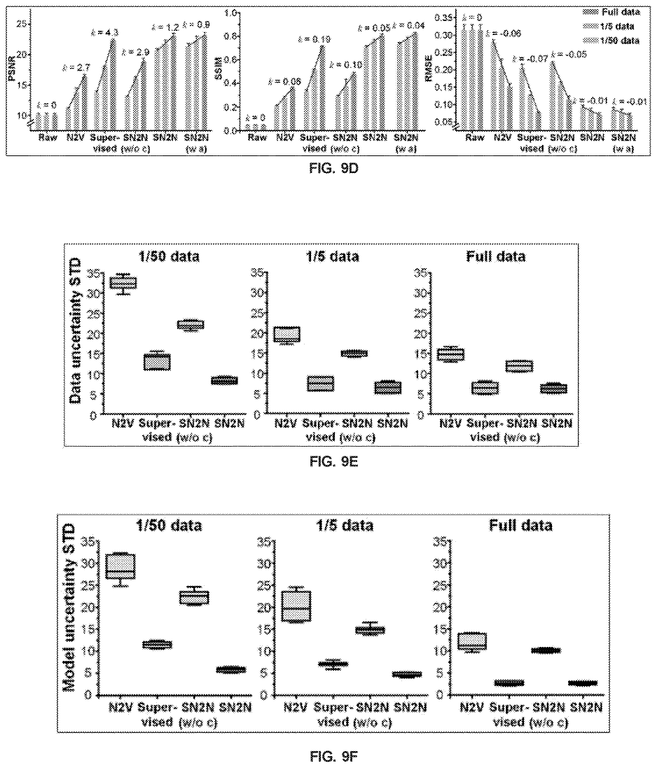

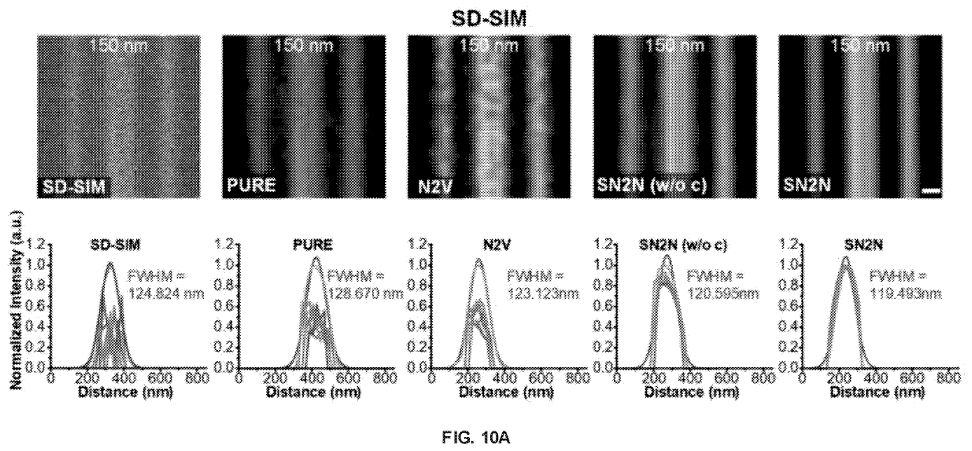

First, SN2N is denoising effective, especially for ultra-low SNR conditions. Under the lowest SNR condition (Level 1), classical denoising methods, e.g., PURE (Poisson unbiased risk estimate) and AcsN (automatic correction of sCMOS-related noise), failed to remove noise and left overly blurred underlying structures (FIG. 1B). The approximated form of N2N, Noise2Void (N2V), can remove the noise, but the predicted images from ten repetitive acquisitions are still with large standard deviation (STD as 15.97 in FIG. 1B), reflecting the limited performances. Removing the self-constrained learning process (SN2N w/o c), the improvement of SN2N against N2V may be relatively limited and may not be competitive with the supervised learning method using sufficient training data. The full SN2N truly approaches the performance of supervised learning with similar STD and even better FRC (Fourier ring correlation), SSIM (structural similarity), PSNR (peak SNR), and RMSE (root-mean-square error) metrics (FIGS. 1B-1E, FIG. 9B). On the other hand, when examining the higher SNR conditions (Level 2 and Level 3), all methods can achieve acceptable denoising results (FIG. 1E, FIG. 9A) and the improvements are less impressive, in which the results of N2V and SN2N without constraint (SN2N w/o c) reach closer to the full SN2N (Table 1).

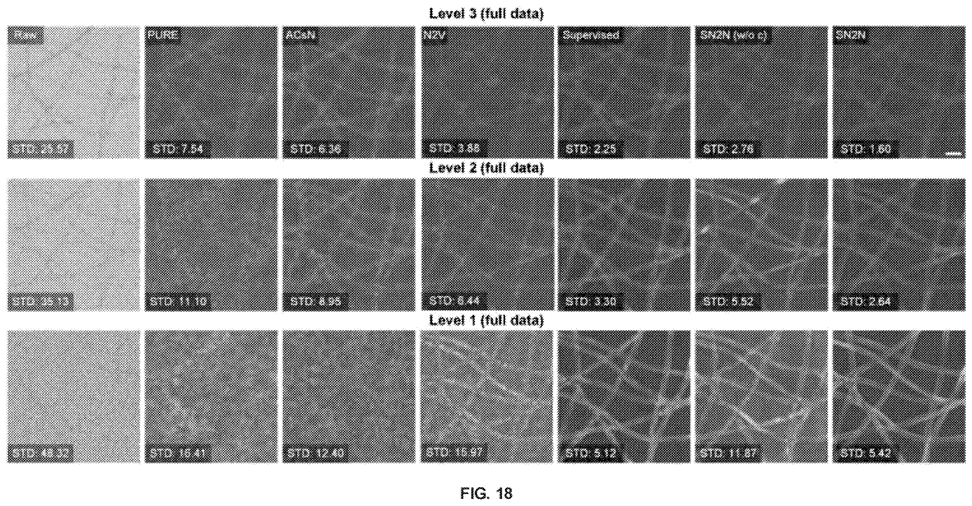

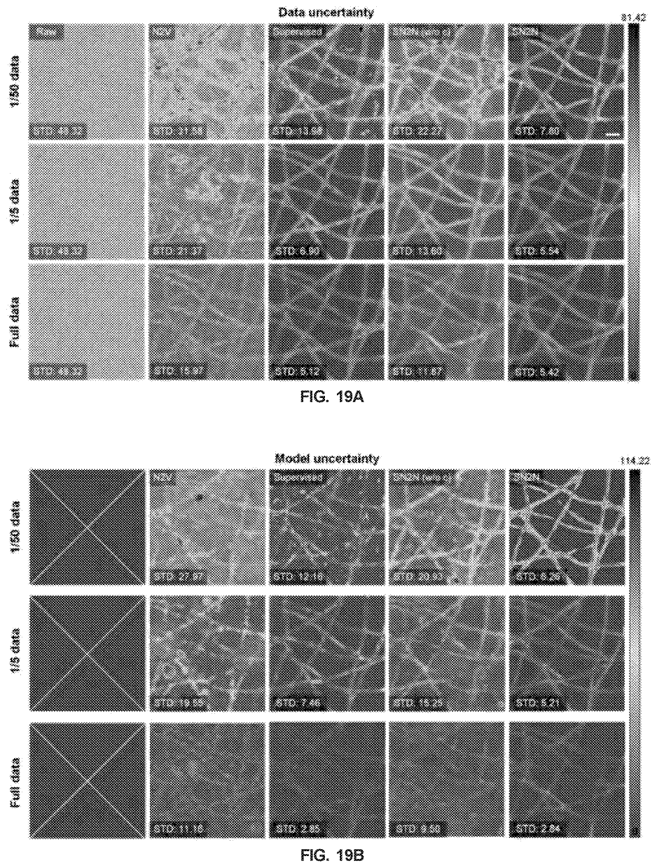

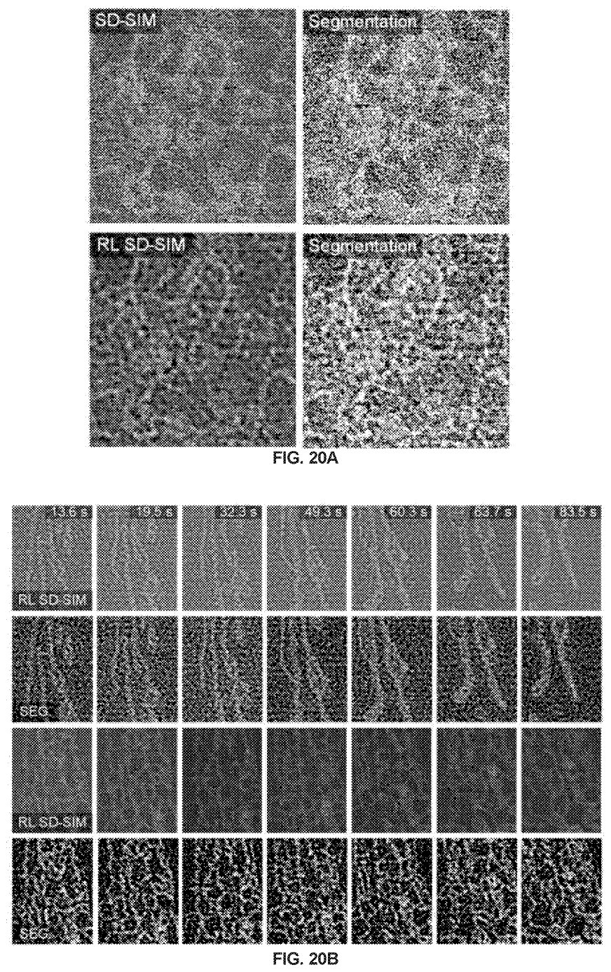

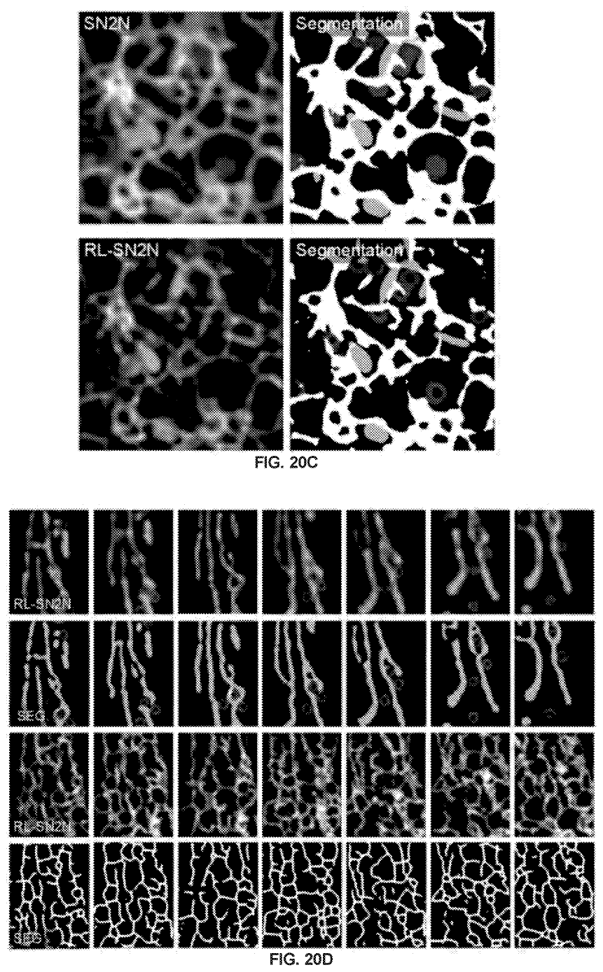

Second, the SN2N is data efficient and can be trained even on one single image. The requirement of large datasets for DNNs to capture the accurate data distribution of high noise-level is moderated by the self-constrained learning process. To test its data efficiency, the slopes of SSIM, PSNR, and RMSE metrics of different learning-based methods are measured by decreasing the training data size by a factor of 5 and 50 (1 frame only) (FIG. 1F, FIGS. 9C-9D, Table 2). As the data pool shrinking, the denoising quality of the supervised learning method dropped quickly, e.g., k=4.3 for PSNR (FIG. 1F), and this variation also dramatically effected the performances of N2V (k=2.7) and SN2N w/o c (k=2.9). In contrast, it is clearly observed that the full SN2N moderated the influence (k=1.2). The self-constrained loss helps the network to learn the denoising process more efficiently, which is further strengthened by the developed Patch2Patch (k=0.9, SN2N with augmentation, SN2N w a). Fundamentally, these two aspects are highly correlated to the data and model uncertainties of the DNNs, in which the denoising-effectiveness reflects the data uncertainty, and data-efficiency represents the model uncertainty. Using ten acquisitions' predictions and ten repetitively trained models' predictions, the data and model uncertainties are measured, respectively (FIG. 9E, see also FIGS. 18-19B). Consistently, it can be seen that the SN2N outperforms other methods in both data and model uncertainties.

TABLE 1
Exemplary SSIM, PSNR, and RMSE values for denoising simulated
microtubules under different noise levels (c.f., FIG. 9B)

| Full data | | PURE | ACsN | N2V | Supervised | SN2N (w/o c) | SN2N |
|---|---|---|---|---|---|---|---|
| SSIM | Level 1 | 0.3182 ± | 0.3654 ± | 0.4473 ± | 0.7278 ± | 0.5222 ± | 0.8032 ± |
| | | 0.0028 | 0.0004 | 0.0001 | 0.0001 | 0.0005 | 0.0004 |
| | Level 2 | 0.4129 ± | 0.4306 ± | 0.5603 ± | 0.8370 ± | 0.5790 ± | 0.8400 ± |
| | | 0.0009 | 0.0002 | 0.0003 | 0.0001 | 0.0030 | 0.0000 |
| | Level 3 | 0.5072 ± | 0.5101 ± | 0.7808 ± | 0.8926 ± | 0.8062 ± | 0.8882 ± |
| | | 0.0005 | 0.0001 | 0.0001 | 0.0000 | 0.0001 | 0.0000 |
| PSNR | Level 1 | 14.6763 ± | 14.7244 ± | 15.2940 ± | 22.6393 ± | 16.6833 ± | 24.2803 ± |
| | | 1.2347 | 2.4205 | 0.0867 | 0.0422 | 0.2847 | 0.3170 |
| | Level 2 | 16.1902 ± | 16.2847 ± | 16.7018 ± | 25.2417 ± | 18.1278 ± | 25.1182 ± |
| | | 0.8094 | 1.2442 | 0.1482 | 0.1346 | 0.2647 | 0.1410 |
| | Level 3 | 20.2255 ± | 20.9137 ± | 21.9142 ± | 27.9624 ± | 22.5314 ± | 26.6088 ± |
| | | 0.5811 | 0.5247 | 0.1992 | 0.0173 | 0.1575 | 0.0221 |
| RMSE | Level 1 | 0.1861 ± | 0.1865 ± | 0.1720 ± | 0.0738 ± | 0.1468 ± | 0.0613 ± |
| | | 0.0005 | 0.0011 | 0.0001 | 0.0000 | 0.0001 | 0.0000 |
| | Level 2 | 0.1559 ± | 0.1546 ± | 0.1463 ± | 0.0539 ± | 0.1243 ± | 0.0555 ± |
| | | 0.0003 | 0.0004 | 0.0000 | 0.0000 | 0.0000 | 0.0000 |
| | Level 3 | 0.0978 ± | 0.0903 ± | 0.0803 ± | 0.0401 ± | 0.0748 ± | 0.0467 ± |
| | | 0.0001 | 0.0001 | 0.0000 | 0.0000 | 0.0000 | 0.0000 |

TABLE 2
Exemplary SSIM, PSNR, and RMSE values for denoising simulated microtubules
under different training data amounts (c.f., FIG. 9D)

| Level 1 | | N2V | Supervised | SN2N (w/o c) | SN2N | SN2N (w a) |
|---|---|---|---|---|---|---|
| SSIM | 1/50 data | 0.2091 ± | 0.3322 ± | 0.2916 ± | 0.7062 ± | 0.7360 ± |
| | | 0.0002 | 0.0002 | 0.0001 | 0.0002 | 0.0001 |
| | 1/10 data | 0.2783 ± | 0.5173 ± | 0.3764 ± | 0.7586 ± | 0.7760 ± |
| | | 0.0001 | 0.0001 | 0.0023 | 0.0002 | 0.0002 |
| | Full data | 0.3591 ± | 0.7145 ± | 0.4826 ± | 0.8069 ± | 0.8232 ± |
| | | 0.0001 | 0.0000 | 0.0001 | 0.0002 | 0.0001 |
| PSNR | 1/50 data | 11.0758 ± | 13.7362 ± | 13.1180 ± | 20.6622 ± | 21.3920 ± |
| | | 0.0441 | 0.1555 | 0.0828 | 0.1965 | 0.2242 |
| | 1/10 data | 13.7447 ± | 18.0178 ± | 16.0825 ± | 21.7903 ± | 22.3012 ± |
| | | 0.5549 | 0.0176 | 0.1418 | 0.6402 | 0.6223 |
| | Full data | 16.4204 ± | 22.3782 ± | 18.8657 ± | 23.0682 ± | 23.2253 ± |
| | | 0.2085 | 0.0395 | 0.5431 | 0.4132 | 0.3057 |
| RMSE | 1/50 data | 0.2795 ± | 0.2059 ± | 0.2209 ± | 0.0928 ± | 0.0854 ± |
| | | 0.0001 | 0.0001 | 0.0001 | 0.0001 | 0.0001 |
| | 1/10 data | 0.2067 ± | 0.1257 ± | 0.1571 ± | 0.8182 ± | 0.0772 ± |
| | | 0.0005 | 0.0001 | 0.0001 | 0.0001 | 0.0001 |
| | Full data | 0.1512 ± | 0.0761 ± | 0.1144 ± | 0.0704 ± | 0.0691 ± |
| | | 0.0001 | 0.0000 | 0.0000 | 0.0000 | 0.0000 |

Exemplary experimental evaluation using standard sample under SD-SIM may be described below.

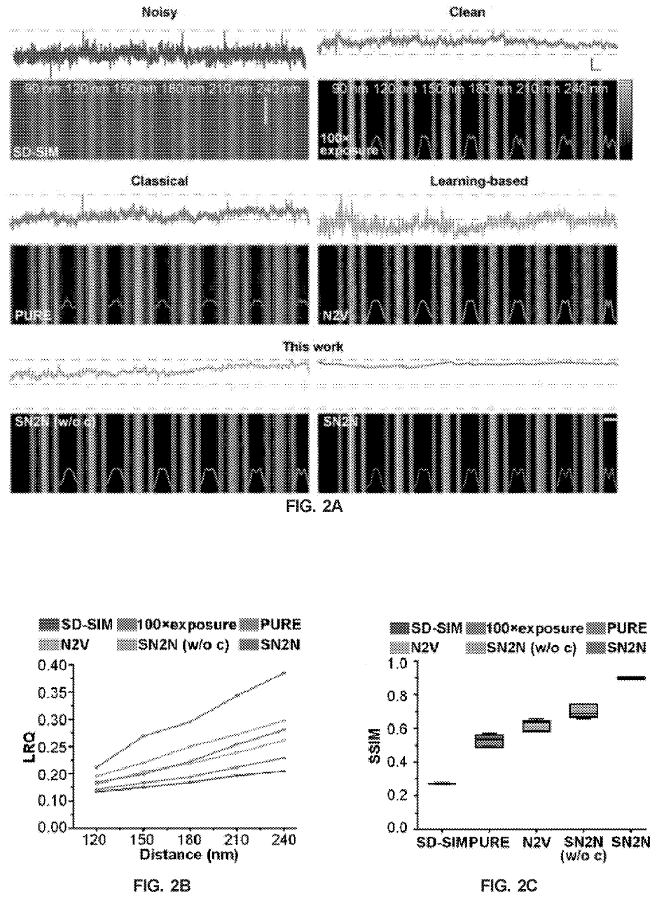

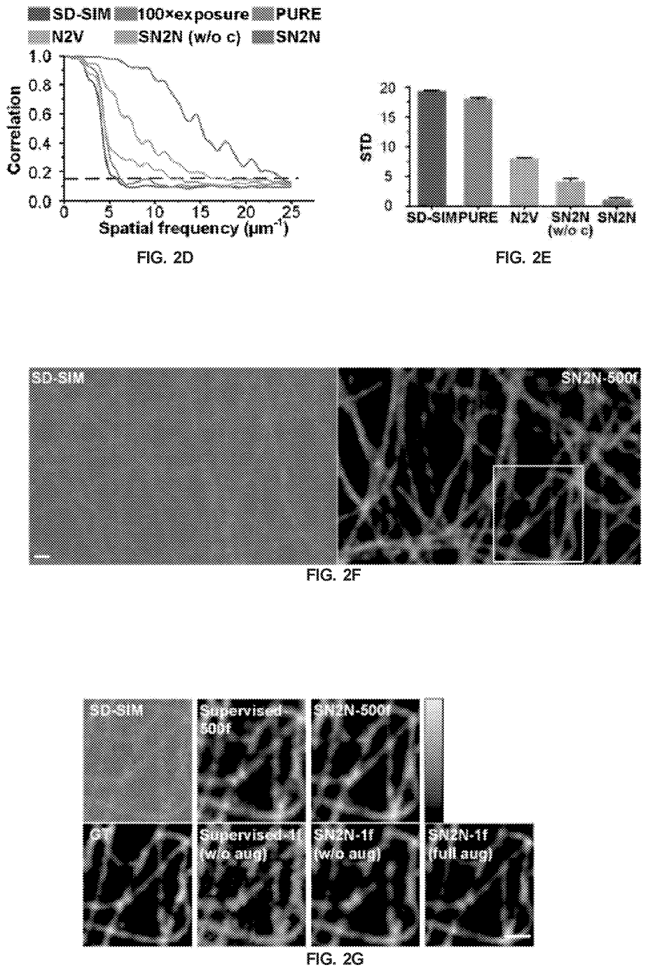

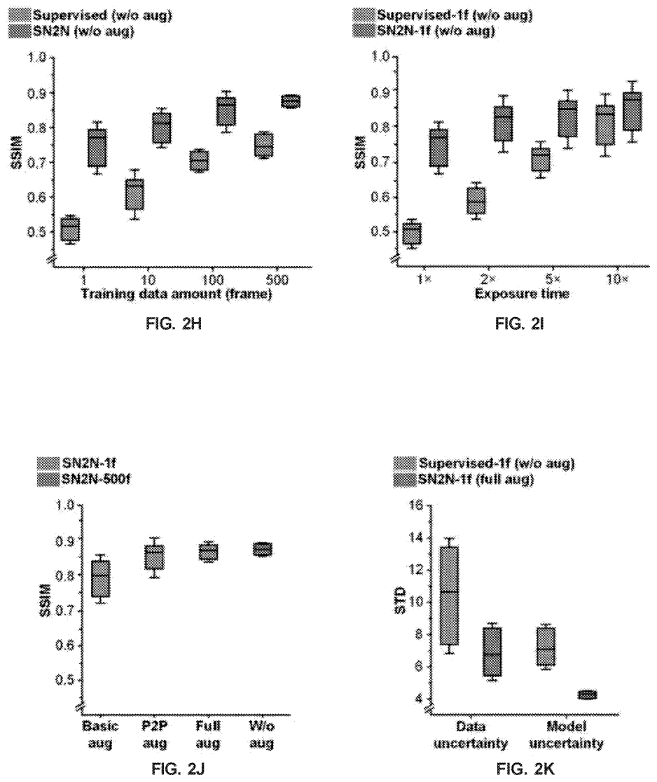

SR confocal microscopy can double the spatial resolution by narrowing its pinhole size, but correspondingly the number of photons reaching the detector is severely restricted. Although the photon reassignment concept has mitigated this inherent low SNR condition, the photon efficiency of SR confocal microscopy still needs to be improved for capturing fast long-term sub-organelle dynamics in multiple dimensions (5SD in xyz-color-time), especially for its paralleled version, i.e., the spinning-disk confocal-based structured illumination microscopy (SD-SIM). Next, SN2N is evaluated with ground-truth under a commercial SD-SIM system (Olympus SpinSR10 with an sCMOS camera). Compared to the diffraction-limited confocal mode, the integrated optical reassignment module and 3.2× second-stage magnification system of SpinSR10 bring heavily reduced SNR conditions (FIG. 100). Using a commercial Argo-SIM slide, the variance across the vertical straight line is measured, and only the SN2N can draw the expected brightness profile with minimum fluctuations, even smaller than that of image under 100× exposure (FIG. 2A). Furthermore, the double-line structures are highlighted by SN2N from noise with the highest contrast (FIG. 2A). Based on several metrics including LRQ (line restoration quality) according to the known line structures, SSIM against the 100× exposure generated ground-truth, FRC, and STD from repetitive acquisitions, as well as visual inspection, it is found that SN2N successfully restored real-world collected images with superior stability and quality (FIG. 2B-2E, FIG. 10A, Table 3).

TABLE 3
Exemplary LRQ, SSIM, and STD values for different denoising algorithms on the
commercial Argo-SIM slide under SpinSR10 SD-SIM system (c.f., FIGs. 2B-2E)

| | | SD-SIM | PURE | N2V | SN2N (w/o c) | SN2N |
|---|---|---|---|---|---|---|
| LRQ | 120 nm | 0.1673 | 0.1707 | 0.1808 | 0.1954 | 0.2119 |
| | 150 nm | 0.1747 | 0.1834 | 0.2035 | 0.2203 | 0.2690 |
| | 180 nm | 0.1843 | 0.1941 | 0.2188 | 0.2501 | 0.2951 |
| | 210 nm | 0.1969 | 0.2119 | 0.2388 | 0.2720 | 0.3431 |
| | 240 nm | 0.2047 | 0.2292 | 0.2613 | 0.2973 | 0.3846 |

| | | | | | |
|---|---|---|---|---|---|
| SSIM | 0.2715 ± 0.0001 | 0.5306 ± 0.0014 | 0.6200 ± 0.0012 | 0.7018 ± 0.0231 | 0.8974 ± 0.0001 |
| STD | 19.6506 ± 0.0038 | 18.3152 ± 0.0203 | 8.0821 ± 0.0231 | 4.2259 ± 0.0017 | 1.2241 ± 0.0501 |

Exemplary experimental evaluation using biological samples under SD-SIM may be described below.

To examine the broad applicability of SN2N, it is applied on microtubules in fixed COS-7 cells under another commercial SD-SIM system (GATACA Systems, Live-SR with an sCMOS camera) (FIG. 2F). The ultimate goal of unsupervised learning-to-denoise is to approach the similar performance of supervised learning without requiring the data pairs and large training set. In this case, the SN2N is compared against the supervised learning method in the denoising performance and data efficiency (FIG. 2F), in which the 500× exposure result is considered as the ground-truth. When only using one frame, the supervised learning method produces obscure structures (FIG. 2G), indicating an underfitting configuration, and the performance grows dramatically when increasing the data amount from 1 to 500 frames (FIGS. 2G-2H). In contrast, it is found that the expansion of the data pool has little effect on the denoising performance of SN2N (FIGS. 2G-2H), and the integration of the developed Patch2Patch (P2P) data augmentation helps the one-frame-trained model to approach the performance of the 500-frame-trained model (FIG. 2J, Table 4). Furthermore, by taking advantage of its intrinsic data efficiency and further reasonable data augmentation, SN2N exploits the full potential of available data producing superior model and data uncertainties (FIG. 2k, Table 5). Interestingly, it is found that the one-frame trained SN2N is less affected by the SNR degradations (FIG. 2I, Table 6), prompting to explore the trickier denoising task of multi-color live-cell SD-SIM data.

TABLE 4
Exemplary SSIM values for denoising microtubules in fixed COS-7
cells under different training data amounts (c.f., FIG. 2H)

| | | Supervised (w/o aug) | SN2N (w/o aug) |
|---|---|---|---|
| SSIM | 1 | 0.5127 ± 0.0008 | 0.7643 ± 0.0041 |
| | 10 | 0.6358 ± 0.0034 | 0.7965 ± 0.0017 |
| | 100 | 0.6947 ± 0.0007 | 0.8451 ± 0.0028 |
| | 500 | 0.7398 ± 0.0010 | 0.8652 ± 0.0002 |

TABLE 5
Exemplary SSIM values for denoising microtubules in fixed COS-7 cells
under different data augmentation strategies (c.f., FIG. 2J)

| | SSIM |
|---|---|
| SN2N-1f with basic augmentation | 0.7928 ± 0.0042 |
| SN2N-1f with Patch2Patch augmentation | 0.8488 ± 0.0035 |
| SN2N-1f with full augmentation | 0.8631 ± 0.0009 |
| SN2N-500f without augmentation | 0.8588 ± 0.0005 |

TABLE 6
Exemplary SSIM values for denoising microtubules in fixed
COS-7 cells under different exposure time (c.f., FIG. 2I)

| | | Supervised-1f (w/o aug) | SN2N-1f (w/o aug) |
|---|---|---|---|
| SSIM | 1× | 0.5062 ± 0.0014 | 0.7659 ± 0.0032 |
| | 2× | 0.5742 ± 0.0019 | 0.8135 ± 0.0036 |
| | 5× | 0.6931 ± 0.0018 | 0.8287 ± 0.0042 |
| | 10× | 0.8146 ± 0.0041 | 0.8677 ± 0.0040 |

In some embodiments, RL-SN2N on SD-SIM may unlock fast long-term imaging across 5D.

Exemplary multi-color live-cell SR imaging may be described below.

The Richardson-Lucy (RL) deconvolution has been routinely applied on SD-SIM to enhance the contrast and resolution, but it is prone to artifacts under live-cell imaging conditions (FIG. 3B). Thus, beyond denoising, the RL deconvolution is integrated with the SN2N (RL-SN2N) for simultaneously achieving the artifacts removal and resolution enhancement (FIGS. 3A-3B). To avoid breaking the pixel-wise noise independency, the deconvolution is executed after the self-supervised data generation step during the training stage, and at the inference phase, the trained SN2N model is fed with the directly deconvolved images. The performance of RL-SN2N is validated using the Argo-SIM slide, and its LRQ contrast substantially outperformed SN2N (FIGS. 10B-10C).

Also, it is expected that the resulting high-quality SR images can empower precise segmentation, facilitating automated analysis at a suborganelle-level precision from massive data (see the prototype in FIG. 3A and FIG. 11A). The first representative case is dual-color imaging of endoplasmic reticulum (ER) and outer mitochondrial membrane (OMM) labeled live COS-7 cells. It can be observed that the RL-SN2N effectively extracts the fluorescence signal from the noisy background with further enhanced contrast (FIGS. 5B-5C), hence many relative movements between OMM and ER can be dissected. Predictably, the direct hard threshold segmentation on the low-SNR live-cell data produced highly broken structures and strong false positives. The RL-SN2N minimized such noise-induced segmentation artifacts allowing inspection of fast mitochondrial fission events near the ER-Mito contact sites (arrows, FIG. 11C).

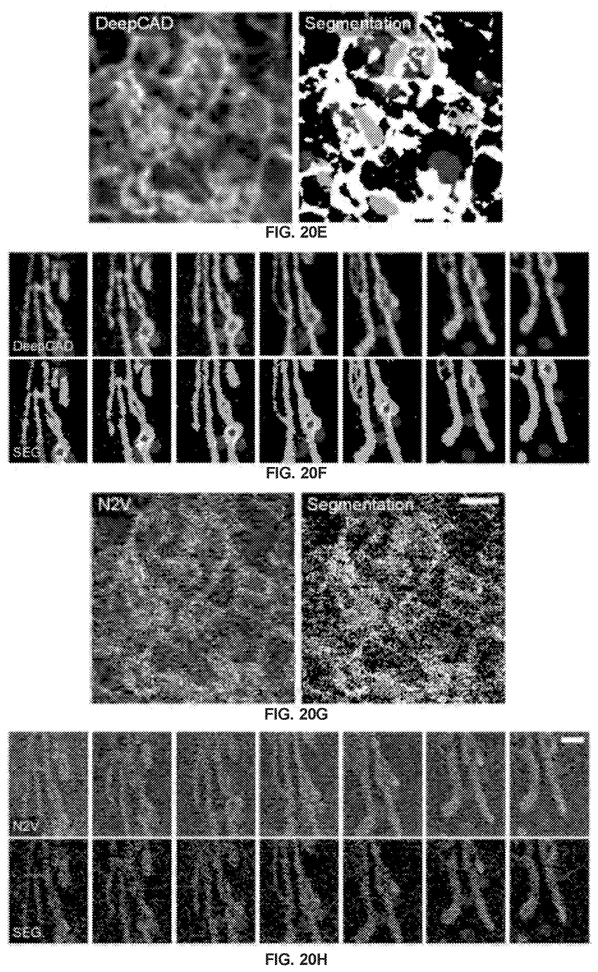

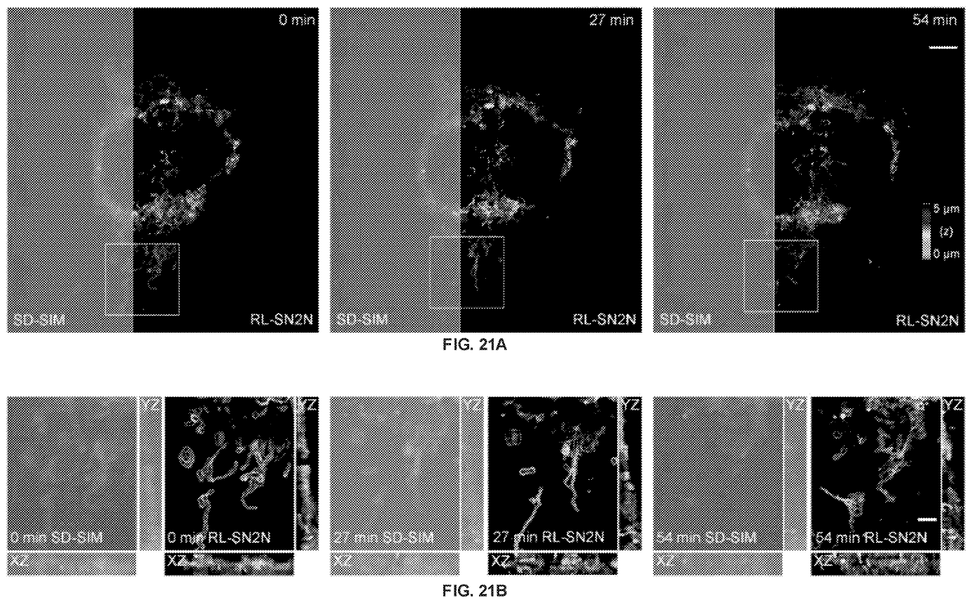

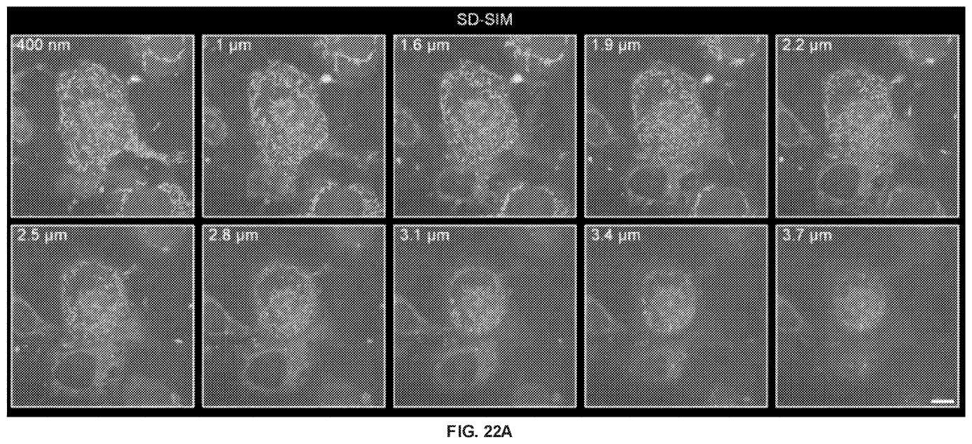

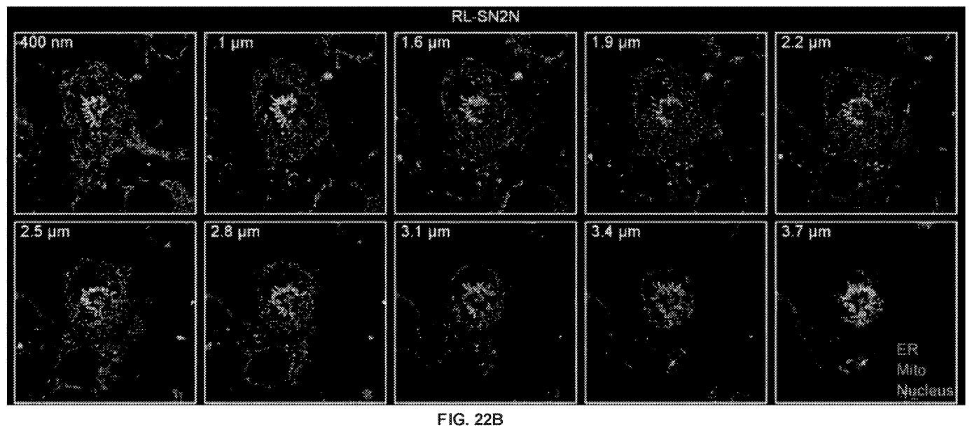

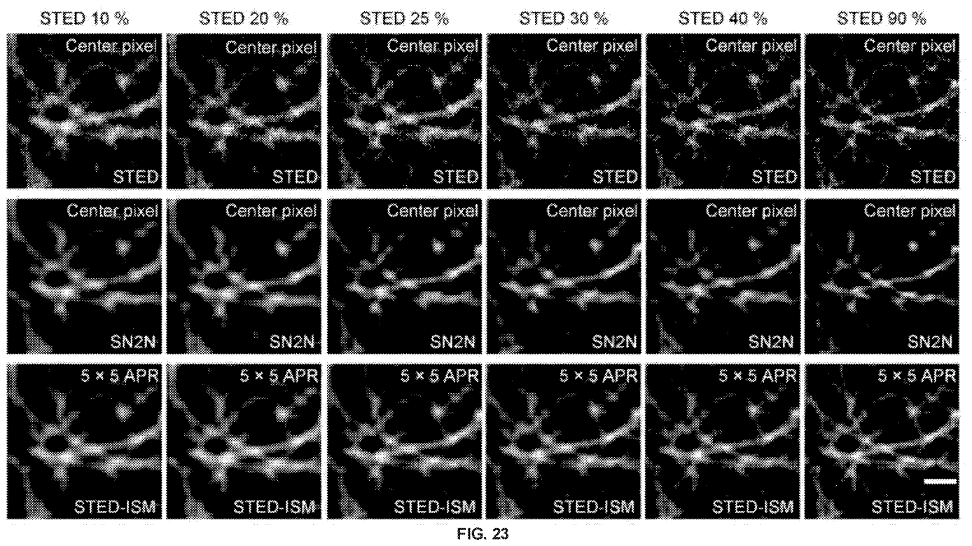

Next, application of RL-SN2N is extended to four-color live-cell imaging of lysosomes (Lys), Golgi apparatus (GA), mitochondrial matrix protein (Mito), and ER (FIG. 3C). Consistently, the RL-SN2N provided plausible reconstructions for monitoring multiple organelle interactions from obscure captures. The increases in SNR and contrast were stable during time-lapse SR imaging (FIG. 3D), which led to distinct observations of Lys-GA (GA being surrounded by Lys) with Mito (Event 1, E1, yellow lines) and Lys-GA with ER (E2-E4, cyan, black, and purple lines) interactions. In these events, it is found that Mito or ER settled in a circle could anchor onto a moving Lys-GA and be pulled out for spatial movements as it followed the trajectory of Lys-GA (segmentations in FIG. 3D). Furthermore, two learning-based segmentation methods, i.e., the Ernet and Mitonet, are applied on ER and Mito data. Although better than the hard threshold segmentations, it was found that these well-trained networks were still influenced by the noise conditions (left in FIG. 3E, FIGS. 11D-11G). On the other hand, empowered by the RL-SN2N, Ernet could precisely draw the ER topology of tubules, sheets, and sheet-based tubules (SBT) (right, FIG. 3E). The trajectories of Lys and spatial masks of ER tubules (FIG. 3F) enabled to examine the correlation between motions of lysosomes and the ER network. By calculating the MSD (mean square displacement) of Lys and their distances to ER, the Lys with confined motion behaviors were mostly located adjacent to ER (FIG. 3G, see also FIGS. 111, 11H, 11K). Mitonet-generated masks allowed to calculate the Mander's overlap coefficient (MOC) of Lys with the nearest Mito for identifying potential functional sites of Lys-Mito contact sites, i.e., MOC>0.26 as a potential event (FIG. 11J), in which the Lys with directed motion behaviors exhibited relatively larger number of events compared to the free diffusion and confined motions (FIG. 3I). The mitochondrial diameters at the ER-Mito or Lys-Mito contact sites (FIG. 3H) were quantified, reflecting the fact that the constricted loci in Mito preferentially associated with the ER-Mito contact. Together, in the absence of tedious manual processes, the RL-SN2N on SD-SIM system simplified the dissection of the synergy of different organelles at a suborganelle scale (FIG. 11A). Comparatively, N2V and DeepCAD cannot provide valid denoising as their insufficient temporal sampling rate and ultralow SNR (FIGS. 20A-20H).

Exemplary 3D-network and deconvolution extension for volumetric SR imaging across 5D may be described below.

With roots in the confocal microscopy, SD-SIM can perform 3D SR imaging with further enhanced axial contrast by the 3D deconvolution. To fully utilize the axial information, the RL deconvolution and U-Net is extended from 2D version to its 3D mode (FIG. 4A, FIGS. 10F-10G). By RL-SN2N, 3D mitochondrial networks were visualized, and as expected, it revealed with tori cross-section of OMM genuinely, which were ambiguous in the raw SD-SIM results (FIG. 4B). Various types of OMM structures, i.e., from tubular to a series of different structures including fragments, small vesicles and spheroids, can be resolved by the RL-SN2N (FIG. 4D). The segmentation also helps to highlight the hollow structures of OMM networks, which are hardly distinguishable in the raw images (FIG. 4C). Furthermore, benefiting from SNR and contrast reinforcements, the 4D OMM network dynamics can be captured across hours (FIG. 4E, FIGS. 21A-21B). In the RL-SN2N results, the kiss-and-run events happening in 3D are correctly identified (arrows, FIG. 4F), which might be misinterpreted as the fissions in 2D slice under low SNR and contrast conditions. Finally, the test is extended to the challenging 5D SR imaging, revealing the dynamics of ER, Mito, and nucleus during the entire cell mitosis process in all three dimensions over long duration of 3 hours (FIG. 4G, FIGS. 22A-22B). Empowered by SN2N, the segregation process (FIG. 4H) and interactions (FIG. 4I) of the dense ER-Mito networks can be clearly monitored.

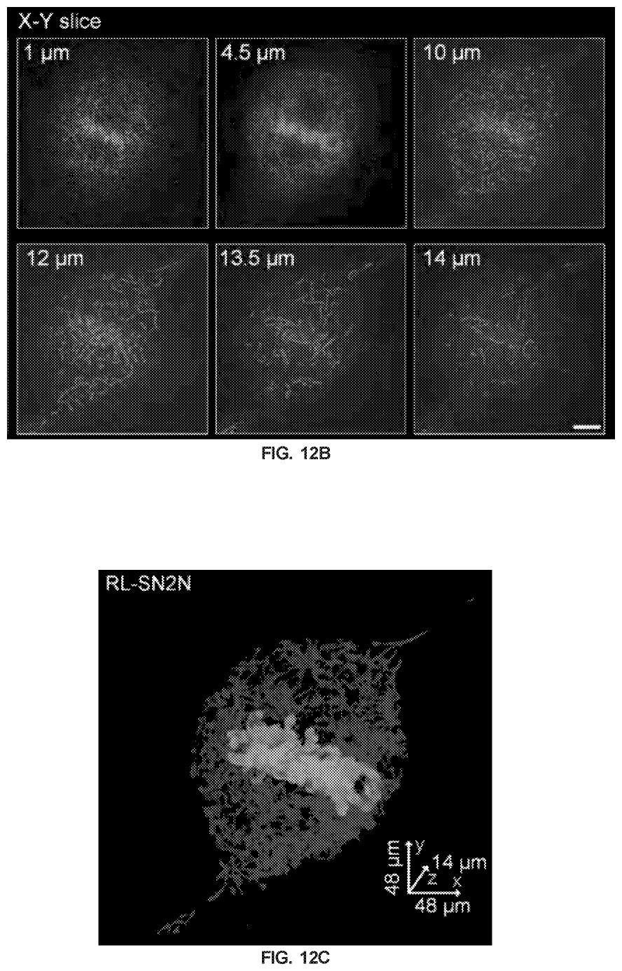

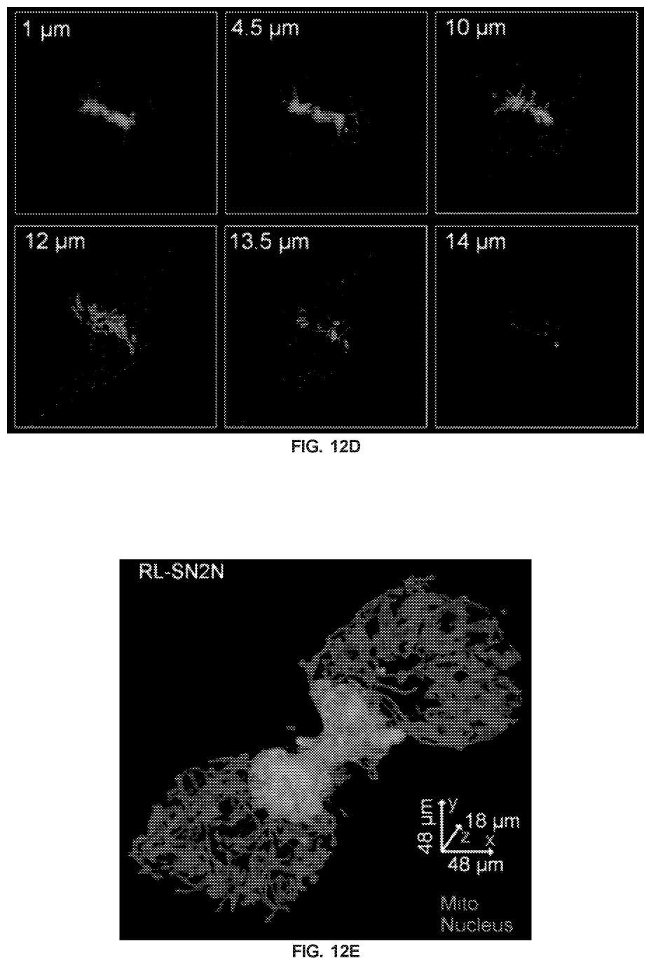

Additionally, according to the simulations, it is found that the approach is not sensitive to pixel size (FIG. 8A). Thus, the success in SD-SIM equipped with an sCMOS camera (~38 nm pixel) made it possible to apply the SN2N and RL-SN2N to diffraction-limited SD-confocal microscopy (~65 nm pixel) or SD-SIM with an EMCCD camera (~94 nm pixel). On the Argo-SIM slice, the SN2N removed the readout noise of SD-confocal images (FIGS. 10D-10E). Likewise, by applying RL-SN2N (with further 2× upsampling) on two-color whole-cell volumes from the EMCCD SD-SIM, two intermediate phases of cell mitosis were successfully recorded, in which the mitochondrion and nuclear protein distributions came into presence from background noise (FIGS. 12A-12F).

In some embodiments, the SN2N can empower long-term live-cell STED imaging.

Similar to confocal SR microscopy, the increase in spatial resolution of STED microscopy from depletion brings dramatically decreased SNR. Because the depletion is driven by de-excitation through stimulated emission, enlarging the depletion laser power will inherently decrease the emission brightness of fluorescence labels and cause adverse effects such as photobleaching and phototoxicity, preventing long-term monitoring of samples. Thus, the SN2N extraction of structures from few photons gives the possibility to tackle the contradiction for imaging live cells with both high spatial resolution and SNR. First, SN2N denoising performances were systematically evaluated under different depletion powers (FIGS. 5A-5B, see also FIG. 23), in which the data was collected from a custom STED setup incorporating a SPAD array detector with 5×5 elements for adaptive pixel-reassignment (APR). By assembly of SPAD center pixel collected signals, the spatial resolution of STED is further improved but most photons would be dropped. The 5×5 APR STED results, or equivalently the STED image scanning microscopy (STED-ISM) can fully exploit the collectible photons to preserve SNR (FIG. 5C). Differently, without these collected photons from circumjacent 24 pixels, the SN2N effectively recovered the live microtubule structures from only center pixel collected photons, especially under a high depletion power (FIG. 5B). The two-peak draws of microtubule intersections, FRC curves, and FWHM (full width at half maximum) measurements also highlight the increment process of spatial resolution without sacrificing SNR after SN2N denoising (FIGS. 5D-5F).

It is straightforward to apply the SN2N on a commercial STED system (Leica, TCS SP8 STED 3X) for time-lapse imaging of microtubules-, actin-, and ER-labeled COS-7 cells (FIGS. 5G-5H), routinely enabling high-quality live-cell SR imaging. Beyond that, the long-term dynamics of mitochondrial cristae (PK Mito Orange, PKMO⁴⁸ labeled) were also recorded under another commercial STED system (Abberior Instruments, STEDYCON) under various imaging conditions. To acquire high-quality STED images in situ, the high depletion power and long pixel duration time were applied and hereby instantly extinguished the fluorescence signal before 5 frames of recording (FIG. 5I). The high depletion power with short pixel duration time could delay the bleaching effects without loss of spatial resolution but create noisy captures, in which the SN2N effectively restored this SNR degradation (FIGS. 5I-5K). The measured crista-to-crista distance also reflects the achievable resolution of ~76 nm (FIG. 5L). Further turning down the depletion laser power will offer significantly less susceptible to photobleaching but short of spatial resolution maximization (FIGS. 5K, 5M). Fortunately, the RL-SN2N can lift the dropped resolution in the absence of amplified photobleaching (FIGS. 5M-5N). Short exposure and low illumination energy facilitate the record of the perplexing locomotion of cristae during mitochondrial fusion (FIG. 5O) and fission (FIG. 5P) over half an hour. In contrast, conventional STED produced uninterpretable SR images under the same conditions (FIG. 5M).

In some embodiments, the SN2N can improve reconstruction efficiency of SOFI.

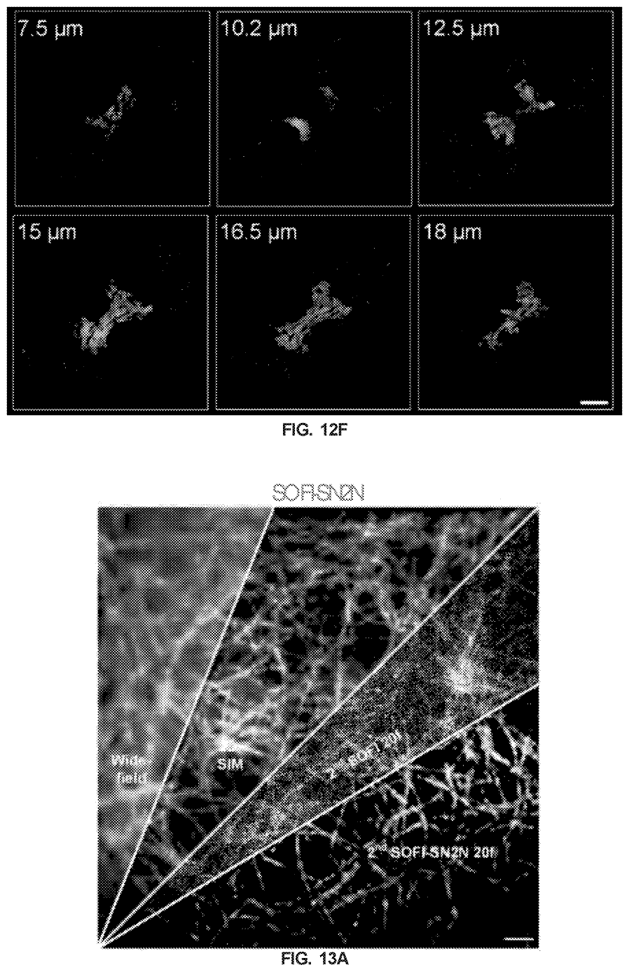

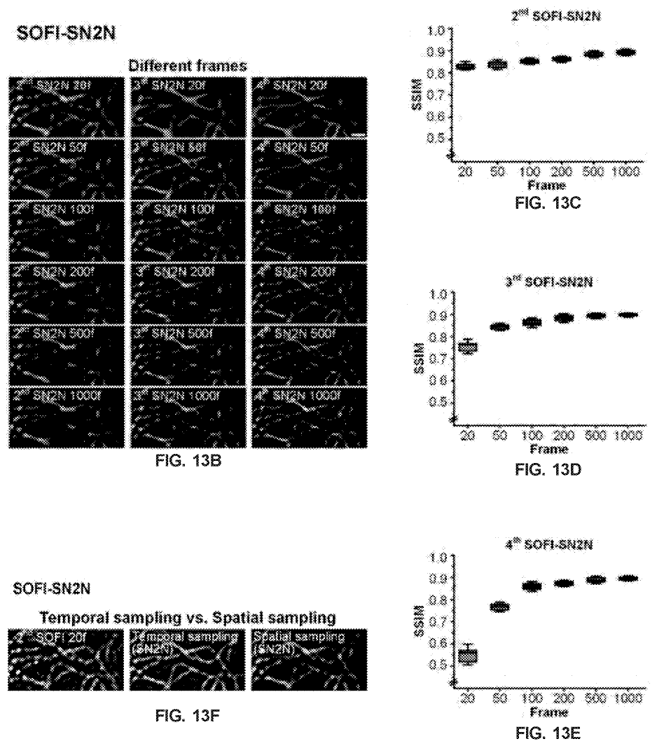

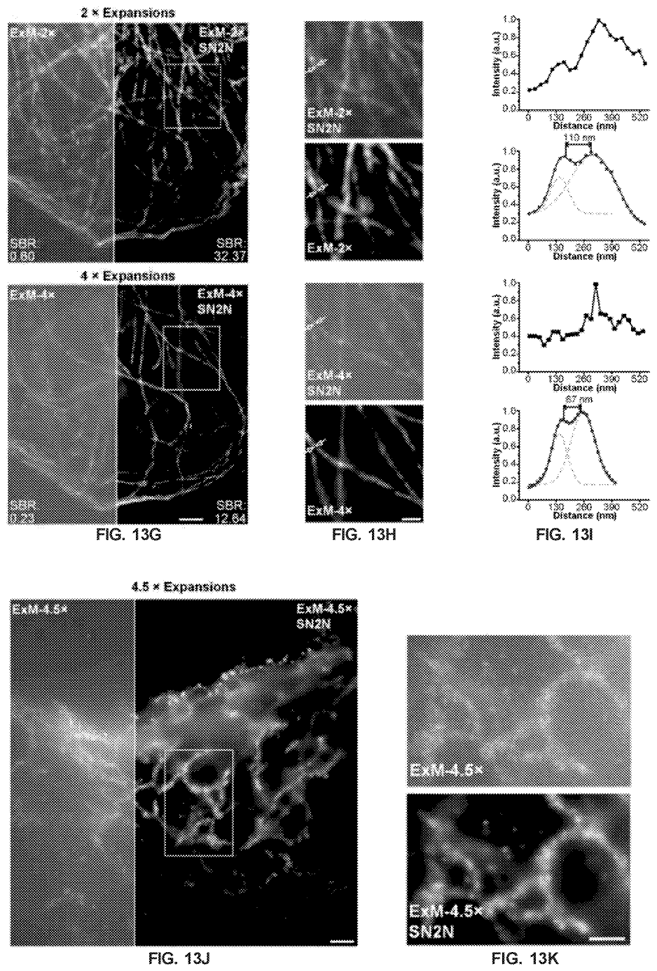

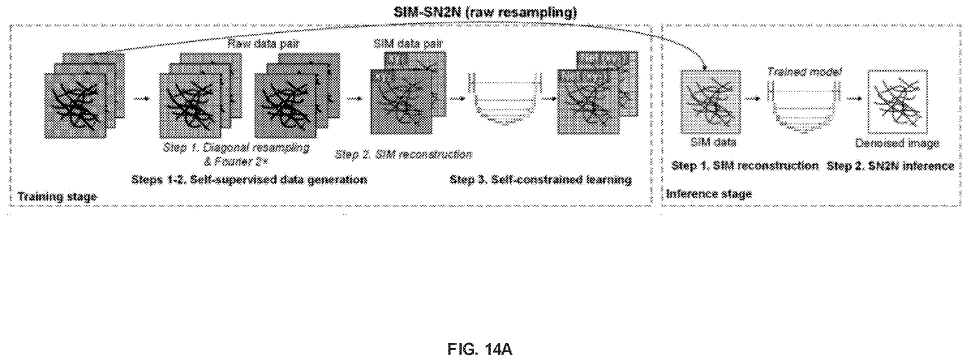

Super-resolution optical fluctuation imaging (SOFI) can routinely break the diffraction limit by exploiting the natural temporal fluctuations of fluorescence emissions under optical systems in their native states. However, the statistical uncertainty of reconstructions from short sequences may dramatically affect image continuity and homogeneity, which leads it generally requiring hundreds of raw images (~1,000 frames for 2^{nd} order) to preserve structural integrity. To increase its reconstruction efficiency, the SN2N solution is integrated into SOFI reconstruction pipeline (FIG. 6A). Specifically, the raw image sequence is calculated by n^{th} order cumulant (core SOFI), and the resulting image is followed by the RL-SN2N procedure. Using SIM as reference, the 2^{nd} order SOFI-SN2N is first validated on a basic wide-field microscope, and it is found that the strong snowflake artifacts in conventional 20-frame SOFI are effectively eliminated and the original microtubule structures are highlighted (FIG. 6B, FIG. 13A) with similar overall performance but higher axial contrast. The two-peak analyses, FRC metrics, and FWHM measurements all demonstrate the massively improved temporal resolvability and effectively increased spatial resolution of SOFI-SN2N (FIGS. 6B-6D). Next, the SOFI-SN2N is extended to different orders of cumulant executed (FIGS. 6B-6D) on a commercial SD-confocal microscope. Consistently, both visual examination and FRC analysis exhibit that the 2^{nd} order SOFI-SN2N can produce artifacts-free results from only 20 frames (FIGS. 6E-6G). On the other hand, the increase of resolution from higher order cumulant brings a cost of more frames needed, and the SOFI-SN2N enables efficient 3^{rd} order and 4^{th} order SOFI reconstructions from 50 frames and 100 frames, respectively (FIG. 6F, FIGS. 13B-13E). The FWHM and FRC measured resolution values (FIG. 6H) also evince the spatial resolution enhancement of high-order SOFI reconstruction assisted by the SN2N engine. Finally, the recording of OMM dynamics during mitochondrial fusion during ten minutes provides live-cell SN2N-SOFI SR imaging (FIGS. 6I-6J).

In fixed-cell experiments, the temporal sampling (first and second 20 frames for SOFI reconstruction) can be applied directly (FIG. 13F). Interestingly, due to the inconsonant temporal fluctuation behaviors, the temporal sampling leads to statistical differences between the adjacent frames and produces strong artifacts. In contrast, the spatial sampling is impressed with sturdily extracting the microtubule structures for requiring no temporal consistency (FIG. 13F).

Exemplary SN2N on expanded samples may be described below.

In addition to use of fluorescence fluctuations, the expansion microscopy (ExM) is another system-agnostic SR modality by artificially enlarging the size of samples to break the diffraction-limit. However, considering the determined number of fluorophores, this space extension of samples will result in the geometrically decreased SNR according to the expansion times (FIGS. 13G-13K). Under a wide-field microscope, the ExM-SN2N enabling high-quality SR imaging of ~110 nm and ~67 nm resolutions for 2× and 4× expansions (FIGS. 13G-13I) is offered, respectively. Under different noise levels, the ExM results after SN2N denoising exhibited significantly improved signal-to-background ratios (SBRs). Similarly, the SN2N outcomes of the 4.5 times-expanded cells yielded (FIGS. 13J-13K) noise-eliminated results, revealing the complex ER tubule structures.

Exemplary artifacts-removal for live-cell SIM may be described below.

Although structured illumination microscopy (SIM) is recognized to have a higher photon efficiency than other SR modalities, it still requires an adequate SNR for each raw image to prevent random reconstruction artifacts. Therefore, to minimize the artifacts, the SN2N is included into SIM reconstruction (‘raw resampling’, FIG. 14A). The generated twin 9-raw-image were individually reconstructed by the HiFi-SIM procedure (high-fidelity SIM) to create the training sets, and at inference stage, the input is SIM image by the original 9 raw images. First, the performance of the SIM-SN2N is systematically evaluated using the BioSR open-sourced dataset under high (H), medium (M), and low (L) SNR levels. Comparing to the ground-truth ultrahigh SNR reconstructions, the SIM-SN2N effectively disentangled the real features from artifacts and produced stable SSIM values for various conditions and samples (FIGS. 14B-14G). Then, the 2D-SIM imaging of mitochondrial cristae exhibited strong background artifacts, which was further amplified as the emission fluorescence progressively decreasing (FIGS. 14H-14I). The suppression of artifacts in SIM-SN2N supports its superior performance in obtaining high-fidelity SR images from raw images of low SNR (FIG. 14J).

In particular, when meeting ultrafast SIM imaging under ultralow SNR conditions, the resampled dataset might encounter reconstruction failures, in which the parameter estimation is highly unstable. On the other hand, the frequency-component reassembly step in SIM reconstruction is usually accompanied by an artificial 2× upsampling, which breaks the pixel independency, and this prevents the direct application of SN2N on SIM images. To meet this challenge, a new strategy of spatial sampling was conducted by defining 3×3 pixels as one unit and a new average calculation of 4 directions followed by the Fourier 3× operation (‘SIM resampling’, FIG. 14K). This one-pixel interval enabled the direct artifacts-removal on the SIM reconstructed images only with a slight drop of SSIM metrics (FIGS. 14I-14Q). Tested on the ultrafast (188 Hz, ~0.6 ms exposure per raw frame) TIRF-SIM experiments, the ‘raw sampling’ failed to offer eligible SIM reconstructions, and in contrast, the ‘SIM resampling’ provided high-quality images along 6,800 consecutive SR frames (FIGS. 14R-14T).

In the N2N ecosystem, theoretically, the infinite data pairs are essential to approach the supervised learning methods' performance, because of the need for averaging training sets to remove the zero-mean noise. Using twin images from the designed self-supervised data generation, the self-constrained learning process further generalizes this N2N concept to remove noise with randomness, and also relaxes the need for infinite data amount. As a result, the SN2N is competitive with supervised learning methods but overcoming the need for large dataset and clean ground-truth, in which a single noisy frame is feasible for training. The SN2N is applied to the photoelectric detector directly captured data, including two commercial SD-SIM systems with two different types of cameras, one custom-built and two commercial STED microscopes, one ExM under a wide-field microscope, and one commercial SD-confocal microscope, demonstrating its extensive application value and superior performance. Besides, the SN2N is integrated into the prevailing SR reconstructions, including RL deconvolution, SOFI, and SIM for artifacts removal, enabling efficient reconstructions from limited photons by one-to-two orders of magnitude.

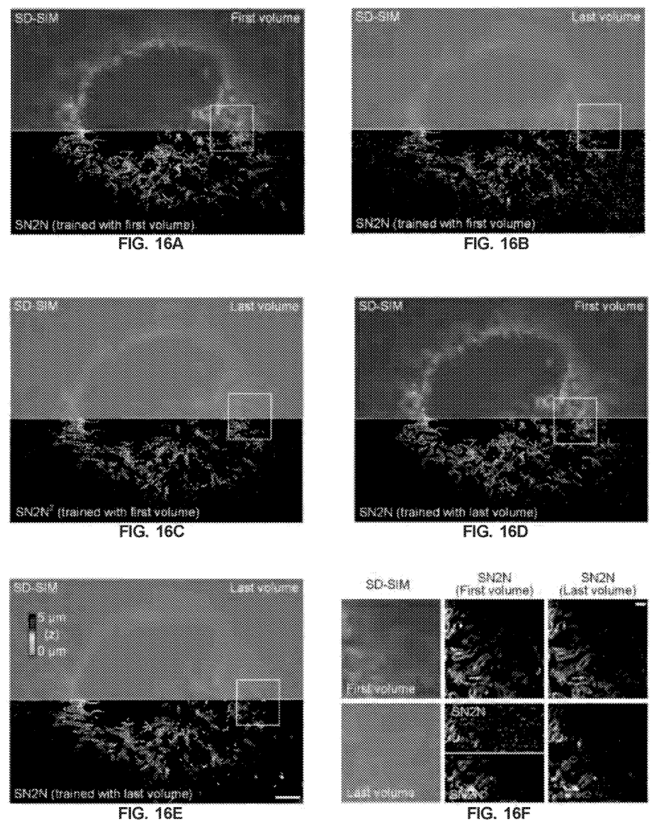

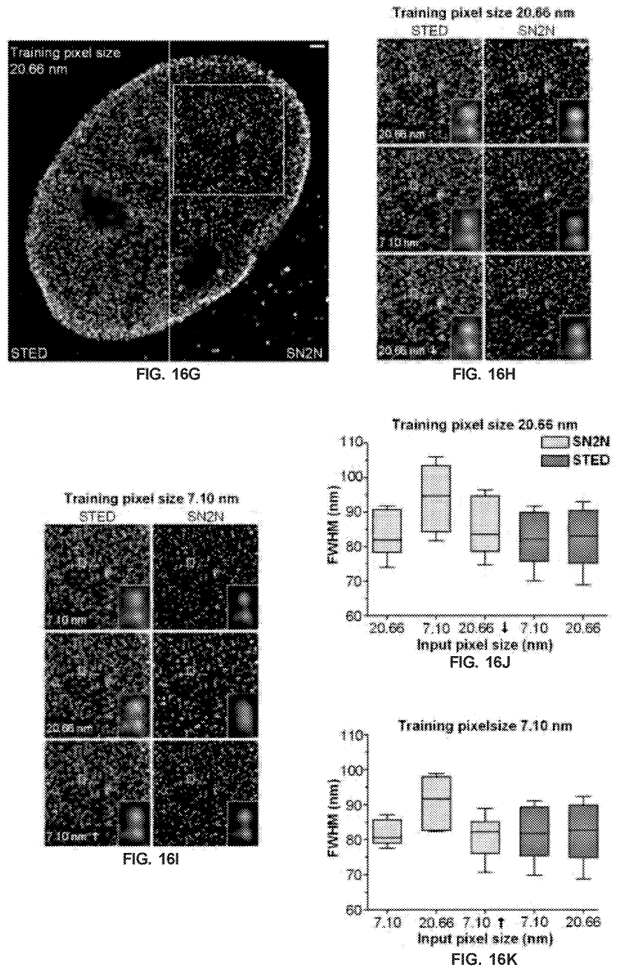

A concern of learning-based recovery is that the spatially denoised features might distort the temporal signals in a nonlinear manner. Recording cells labeled with cytosolic Ca²⁺ indicators, it is found that SN2N acted without nonlinearly perturbing the amplitudes of different Ca²⁺ transients, indicating that the SN2N denoising is quantitatively accurate (FIGS. 15A-15C). In an abstract sense, SN2N is learning to extract structures from noisy input according to the training set, while the numerical algorithms usually intend to remove the noise. Thus, the extraction of structures from models trained by higher SNR data would exhibit strong background artifacts caused by the misleading information learned between noise and structures (FIGS. 16A-16B), and the outcomes from models trained by lower SNR data are free from this failure (FIGS. 16D-16F). This issue can be moderated by the iterative execution of the SN2N model (SN2N²) to shrink the gap between training and test sets (FIG. 16F). In addition, this network extraction is also influenced by the structural scale of input images, and the up/down sampling operation should be applied to match the pixel size before SN2N inference (FIGS. 16G-16K), otherwise the network would produce erroneous results (middle panel, FIGS. 16H, 16I).

The SN2N may be a model-agnostic solution. The 2D/3D U-Nets used may be simple end-to-end baselines, and the extensions to other advanced networks are straightforward, such as the routinely used residual/dense blocks, adversarial training strategy, and transformer-based solutions. Furthermore, the incorporations of SN2N with network-based deconvolution and SIM may be expected to enable stable and efficient SR reconstructions for the real-time potential. Finally, the loss realizations of SN2N can have many variants, and the distance calculation by SSIM or in the Fourier domain could lead to additional improvements. Random noise is an ineluctable obstacle in fluorescence microscopy, especially for the live-cell SR recording. The SN2N and its extensions provide powerful solutions for routine 2D-5D imaging of suborganelle dynamics at ultra-high spatiotemporal resolution and high-fidelity for long durations. Overall, it is anticipated that the elimination of noise could benefit precise structure segmentation and facilitate automatic multi-parameter analysis, establishing a panoramic view of the organelle interaction systems.

FIGS. 1A-1F show an exemplary workflow and simulation validation of SN2N according to some embodiments of the present disclosure. FIG. 1A shows an exemplary overview of SN2N. Steps 1-2 shows an exemplary self-supervised data generation. The single-frame input image of H×W pixels is diagonally re-sampled to two images of H/2×W/2 pixels. Then, the two resulting images are re-scaled back to two images of H×W pixels with a Fourier interpolation. Step 3 shows an exemplary self-constrained learning process, i.e., the two re-scaled images serve as both inputs and labels, and the corresponding two predicted images from a classical U-Net architecture are constrained to minimize the difference between them. FIG. 1B shows an exemplary validation of SN2N using synthetic microtubule structures. The synthetic structures were convoluted with a 150 nm PSF and down-sampled 2 times (pixel size 32.5 nm) as ground truth. The noisy images were created by further injection of Poisson noise and 40% Gaussian noise. From left to right: noisy (top) and ground-truth images (bottom), PURE, AcsN, N2V, supervised, SN2N without self-constrained loss (SN2N w/o c), and SN2N denoising results. FIG. 1C shows exemplary data uncertainty results of FIG. 1B. Ten independent frames of identical contents under the same imaging conditions were fed to the trained SN2N network, and the standard deviation (STD) of the ten resulting predictions was calculated as the data uncertainty. Marked numbers are the average values of STD maps. FIG. 1D shows an exemplary FRC analysis of the denoising images. The dashed line represents the FRC threshold. FIG. 1E shows exemplary SSIM values of various denoising methods under different noise levels. Images of Levels 1-3 conditions were injected with 40%, 20%, and 10% Gaussian noise as well as the corresponding Poisson noise, respectively. FIG. 1F shows exemplary PSNR values of networks trained by different amounts of data under the Level-1 condition. Full data dimensions: 2048×2048×50. K denotes the slope of PSNR value along the data increment. Error bars denote s.e.m. Tests were repeated ten times independently with similar results; scale bar, 1 μm (FIG. 1B).

FIGS. 2A-2K show exemplary systematical evaluations in SD-SIM tests using known structures according to some embodiments of the present disclosure. FIG. 2A shows exemplary benchmarking of different denoising algorithms on the commercial Argo-SIM slide under SpinSR10 SD-SIM system. Representative images from different methods are presented below the corresponding intensity profiles indicated by the white line. Top row: Low SNR (left) and high SNR (with 100× exposure, right) SD-SIM images; middle row: PURE and N2V denoising results; bottom row: our SN2N without self-constrained loss (w/o c) and full SN2N denoising results. The intensity profiles of the corresponding double-line pairs (90 nm, 120 nm, 150 nm, 180 nm, 210 nm, and 240 nm distances) are displayed on their right.

FIG. 2B shows the line restoration quality (LRQ) values of images in FIG. 2A. FIG. 2C shows exemplary SSIM values of different denoising methods. The ground-truth image was created from the high SNR images by subtracting a constant background value and subsequently filtering a small Gaussian kernel. FIG. 2D shows exemplary FRC analysis of the denoising images. The black dashed line denotes the 1/7 FRC threshold. FIG. 2E shows exemplary standard deviation (STD) of the denoising images predicted from ten repetitively collected noisy images. FIG. 2F shows exemplary QD₆₀₅ labeled microtubules in fixed COS-7 cells imaged by SD-SIM (left) and the corresponding SN2N results (right) trained with 500 frames (‘SN2N-500f’). FIG. 2G shows exemplary enlarged regions enclosed by the white boxes in FIG. 2F. Top row: raw image under SD-SIM, and supervised learning method (‘Supervised-500f’) and SN2N results trained with 500 frames (‘SN2N-500f’); bottom row: ground truth (GT) image, supervised learning (‘Supervised-1f (w/o aug)’) and SN2N (‘SN2N-1f (w/o aug)’) trained with 1 frame and no augmentation, and SN2N trained with 1 frame and full augmentation (‘SN2N-1f (full aug)’). The ground truth image was created by the same procedure used in FIG. 2B.

FIGS. 2H-2J show exemplary average SSIM values of different training data amounts (FIG. 2H), different models trained by images under different exposure time (FIG. 2I), and different data augmentation strategies (FIG. 2J). In FIG. 2H and FIG. 2I, both the supervised learning method and SN2N were trained without data augmentation. In FIG. 2J, the basic augmentation (Basic aug) represents the random flip/rotate of training sets, and the full augmentation (Full aug) includes both our Patch2Patch augmentation (P2P aug) and basic augmentation. FIG. 2K shows exemplary data and model uncertainties quantified by the STD of ten independent frames and ten independently trained models, respectively. Centerline, medians; limits, 75%, and 25%; whiskers, maximum and minimum; error bars, s.e.m. Experiments were repeated ten times independently with similar results; scale bars, 1 μm (FIG. 2A and FIG. 2F), and 500 nm (FIG. 2G).

FIGS. 3A-3I show exemplary multi-color live-cell SR imaging enabled by RL-SN2N on SD-SIM according to some embodiments of the present disclosure. FIG. 3A shows an exemplary workflow of RL-SN2N. Training stage: Step 1, the data pairs are created with diagonal resampling followed by Fourier upsampling 2× (Fourier 2×); Step 2, the resulting data pairs are processed by RL deconvolution as RL-SN2N training set; Step 3, Self-constrained learning is executed using the generated RL data pairs. Inference stage: Step 1, the RL deconvolution is applied on the raw data; Step 2, the RL deconvolved data is fed into the trained RL-SN2N network and the outcomes are the final SR results; Step 3, the denoised SR images are input to the selected smart algorithms for segmentation; Step 4, Performing downstream analysis using the segmentation. FIG. 3B shows a representative example for dual-color SR imaging of mitochondria (Mito, green) and ER (magenta) labeled with Tom20-mCherry and Sec61β-EGFP in live COS-7 cells under SD-SIM (top left), SD-SIM after RL deconvolution (top right, RL SD-SIM), SN2N result (bottom left), and RL-SN2N result (bottom right), alongside the enlarged region of yellow dashed box. FIG. 3C shows a representative example for four-color imaging of Mito (green), ER (gray), lysosome (Lys, red), and Golgi apparatus (GA, blue) labeled with MitoTracker® Deep Red FM, Sec61β-EGFP, Lamp1-mCherry, and Golgi-BFP in live COS-7 cells under raw SD-SIM (right) and RL-SN2N (left). In FIG. 3D, the yellow dashed box in FIG. 3C is enlarged and shown at seven time points under different configurations. From top to bottom: Raw SD-SIM, RL-SN2N, RL SD-SIM segmentation, and RL-SN2N segmentation results. The lines in different colors indicate different interaction events (E1-E4). FIG. 3E shows exemplary segmentation results of the Mito (orange, by Mitonet) and ER (by Ernet) under SD-SIM (left), and RL-SN2N (right). The Ernet segmentations contain tubules (cyan), sheets (yellow), and sheet-based tubules (magenta, SBT). FIG. 3F shows exemplary trajectories of Lys exhibiting directed motion (green), free diffusion motion (blue), and confined motion (red), and ER tubules (black). FIG. 3G shows exemplary distribution of the estimated a values of Lys versus their temporal average distances to ER tubules. FIG. 3H shows exemplary average Mito diameters. FIG. 3I shows exemplary average numbers of events surpassing the MOC threshold (>0.26) of Lys-Mito. DM (green): directed motion; FDM (blue): free diffusion motion; CM (red): confined motion. Centerline, medians; limits, 75% and 25%; whiskers, maximum and minimum; error bars, s.e.m. Tests were repeated ten times independently with similar results; scale bars, 2 μm (FIGS. 3C-3E), and 5 μm (FIG. 3B).

FIGS. 4A-4I show 3D RL-SN2N on SD-SIM unlocks fast long-term imaging across 5D according to some embodiments of the present disclosure. FIG. 4A shows an exemplary extension of 2D U-Net (top) to its 3D mode (bottom). FIGS. 4B-4D show exemplary 3D OMM network imaging of Tom20-mCherry labeled live COS-7 cells. FIG. 4B shows exemplary color-coded volumes of raw SD-SIM (top) and RL-SN2N (bottom). The color-coded axial views (yz and xz planes) indicated by the yellow dashed lines are provided alongside. Magnified view of yellow boxed regions on xz section is shown at the bottom left of the images. FIG. 4D shows exemplary 3D rendering views of the white boxed region in FIG. 4B under raw SD-SIM (1^{st} column), segmentation of SD-SIM (2^{nd} column), SN2N (3^{rd} column), and segmentation of SN2N (4^{th} column). FIG. 4C shows exemplary 2D slices under raw SD-SIM (top) and RL-SN2N (bottom). FIGS. 4E-4F show exemplary 4D imaging of OMM network (Tom20-mCherry) in live COS-7 cells. FIG. 4E shows exemplary representative color-coded volumes at six time points. FIG. 4F shows exemplary magnified views of the white boxed region in FIG. 4E under RL-SN2N at four time points. The red and white arrows indicate the mitochondrial fission and before fission, respectively. FIG. 4G shows exemplary 5D imaging of mitochondria (green, mGold-Mito-N-7), ER (magenta, DsRed-ER), and nucleus (blue, SPY650-DNA) in live COS-7 cells. Representative 3D rendering views of the cell mitosis process at ten time points under RL-SN2N, except for the first (left part) and the last views being under raw SD-SIM. FIG. 4H shows magnified views from yellow boxes in FIG. 4G under raw SD-SIM (left) and RL-SN2N (right). FIG. 4I shows two representative time points of mitochondria (green) and ER (magenta) after mitosis. Experiments were repeated five times independently with similar results; scale bar, 5 μm (FIGS. 4B, 4I), 1 μm (FIGS. 4C, 4D, 4H), 10 μm (FIG. 4E), and 2 μm (FIG. 4F).

FIGS. 5A-5O show SN2N and RL-SN2N permit long-term live-cell STED imaging according to some embodiments of the present disclosure. FIG. 5A shows a representative example of live HeLa cells labeled with SiR-tubulin under STED (center pixel, STED depletion laser power as 50%, left) and its SN2N result (STED-SN2N, right). FIG. 5B shows exemplary magnified views of the white boxed regions in FIG. 5A. First column: Confocal image (5×5 sum, top) and its SN2N result (bottom); the other columns: STED images (center pixel, top) under different depletion laser powers (0%, 8%, 16%, 30%, and 50% from left to right), its SN2N results (middle), and its ISM results (5×5 adaptive pixel reassignment, APR, STED-ISM, bottom). FRC-measured resolution values are marked at the left bottom. STED with a depletion laser power as 0% is equivalent to the confocal configuration. FIG. 5C shows an exemplary sketch of different strategies for pixel assembly, including center pixel (‘Cent. Pix.’), 5×5 sum, and APR. FIG. 5D shows exemplary fluorescence intensity profiles along the white arrow in FIG. 5B of confocal/STED (center pixel, left) and their SN2N results (right) under depletion laser powers. Different colors indicate different depletion laser powers. FIG. 5E shows exemplary FRC analysis of the confocal/STED images (center pixel) before and after SN2N denoising under depletion laser powers. The black dashed line denotes the 1/7 FRC threshold. FIG. 5F shows exemplary average FWHM values of 5×5 sum confocal/STED, ISM/STED-ISM, center pixel confocal/STED, and center pixel SN2N results. FIG. 5G shows exemplary STED snapshots of live COS-7 cells labeled with SiR-Tubulin (top), Lifeact-EGFP (middle), and Sec61β-EGFP (bottom) under a commercial STED microscope (Leica). Left: the original STED images. Right: denoised images using SN2N. FIG. 5H shows exemplary raw STED frames (left) and SN2N (right) denoised counterparts of magnified views of the white-boxed regions in FIG. 5G. Three representative time points are provided from top to bottom. FIG. 5I shows three exemplary representative frames of PKMO labeled live COS-7 cells under another commercial STED microscopy (Abberior) at high depletion power (86%) and long duration time (100 μs per pixel). FIG. 5J shows exemplary STED raw images (left) and their SN2N results (right) at high depletion power (86%) and short duration time (10 μs per pixel). FIG. 5K shows exemplary photobleaching analysis of STED images used in i, j, and m, quantifying the normalized signal in each case. L, fluorescence profiles along the white arrow in FIG. 5J imaged by STED and SN2N. FIG. 5J shows exemplary STED raw images (left) and their SN2N results (right) at high depletion power (86%) and short duration time (10 μs per pixel). FIGS. 5M-5P show exemplary long-term STED imaging of PKMO labeled mitochondrial cristae in live COS-7 cells at high depletion power (41%) and short duration time (10 μs per pixel). FIG. 5M shows exemplary representative frames of STED (left) and RL-SN2N (right) results. FIG. 5N shows exemplary magnified views of the white boxed regions in FIG. 5M by raw STED, SN2N, and RL-SN2N. FIG. 5O shows exemplary representative montages of the mitochondrial fusion and fission events. The yellow and blue arrows highlight the regions of mitochondrial fusion and fission, respectively, while the white arrows indicate the moments before events. Centerline, medians; limits, 75% and 25%; whiskers, maximum and minimum; error bars, s.e.m. Experiments were repeated five times independently with similar results; scale bar, 2 μm (FIG. 5A), 1 μm (FIGS. 5B, 5G, 5H), 500 nm (FIGS. 5I, 5M-5O).

FIGS. 6A-6J show integration of SN2N and SOFI massively improves the SR reconstruction efficiency according to some embodiments of the present disclosure. FIG. 6A shows an exemplary workflow of SOFI-SN2N. Training stage (red dashed box): Step 1, the acquired image sequence is calculated by n^{th} order SOFI; Step 2, the SOFI data pair is created by diagonal resampling followed by Fourier upsampling 4× on the raw SOFI image; Step 3, the SOFI data pair is then processed by a RL deconvolution followed by a linearization operation; Step 4, the self-constrained learning is executed using the generated SOFI data pairs. Inference stage: Step 1, generating the SOFI image. The acquired image sequence is calculated by n^{th} order SOFI, and the resulting image is processed by Fourier upsampling 2× followed by an RL deconvolution and a linearization operation; Step 2, This resulting SR image is then fed into the trained SN2N model for high-quality reconstruction. FIG. 6B shows exemplary cross-validation of SOFI-SN2N. Snapshots of microtubules in a COS-7 cell labeled with QD₆₀₅ under wide-field microscopy (top left), 2D-SIM (bottom left), 2^{nd} order SOFI using 20 frames (2^{nd} SOFI 20f, top right) and its SN2N result (2^{nd} SOFI-SN2N 20f, bottom right). The Intensity profiles and multiple Gaussian fitting indicated by the white arrows of the corresponding modalities are provided at their bottom. The numbers indicate the distance between peaks. FIG. 6C shows exemplary FRC analysis of the images in FIG. 6B. The black dashed line denotes the 1/7 FRC threshold. FIG. 6D shows an exemplary average FWHM (top) and FRC (bottom) values. WF: wide-field. FIG. 6E shows examples of microtubules in a COS-7 cell labeled with QD₆₀₅ under a commercial SD-confocal microscopy reconstructed by 2^{nd} order SOFI using 20 frames and its SN2N result (right). FIG. 6F shows zoomed views from the white box in FIG. 6E. First row: confocal image (left) and 4^{th} order SOFI using 2,000 frames denoised by SN2N (4^{th} SOFI-SN2N 2,000f, right); the other rows, from top to bottom: 2^{nd} 3^{rd} and 4^{th} orders SOFI reconstructions (left) using 20, 50, 100 frames, respectively, and their SN2N results (right). FIG. 6G shows exemplary FRC analysis of raw SD-confocal image, 2^{nd} SOFI 20f reconstruction, and its SN2N result. The red dashed line denotes the 1/7 FRC threshold. FIG. 6H shows exemplary average FWHM (left) and FRC (right) values of SD-confocal images, SOFI images, and their SN2N results. FIG. 6I shows an exemplary representative live COS-7 cell labeled with Skylan-S-TOM20 imaged by 2^{nd} SOFI-20f of SD-confocal microscopy and its SN2N result (bottom). FIG. 6J shows zoomed views of OMM structures. Top three rows, from top to bottom: magnified views of the white boxed region in FIG. 6I under SD-confocal microscopy, 2^{nd} SOFI 20f reconstruction, and 2^{nd} SOFI-SN2N 20f result; bottom three rows: montages of a representative mitochondrial fission event. The yellow and white arrows highlight the mitochondrial fission and before fission, respectively. Centerline, medians; limits, 75% and 25%; whiskers, maximum and minimum; error bars, s.e.m. Experiments were repeated three times independently with similar results; scale bars, 2 μm (FIGS. 6B, 6I, 6J); 5 μm (FIG. 6E) and 1 μm (FIG. 6F).

FIGS. 7A-7B show exemplary workflow of SN2N and network architectures according to some embodiments of the present disclosure. FIG. 7A shows an exemplary detailed flow diagram of SN2N. Steps 1-3, self-supervised data generation. First, the data pre-augmentation (optional) is performed using the Patch2Patch (random patch transformations in multiple dimensions) strategy. After that, a sliding window approach is employed to generate small patches suitable for input into the network for training. Subsequently, the spatial diagonal resampling strategy followed by Fourier upsampling is used to create paired SN2N data. Additionally, basic augmentations such as rotation and flipping (optional) are applied to the generated data pairs. Step 4: self-constrained learning process. SN2N utilizes the classical U-Net network and selects either the 2D U-Net or 3D U-Net based on the input data dimensions. The generated paired images are considered as one training example, and the resulting two predictions are used to calculate the loss for back propagation. FIG. 7B shows an exemplary Patch2Patch (P2P) pipeline. It includes three available modes for augmentation along the temporal axis, in a single image, and between different experiments.

FIGS. 8A-8F show exemplary testing results of different pixel sizes, interpolation methods, and constraint weights according to some embodiments of the present disclosure. FIG. 8A shows exemplary SN2N denoising results under different pixel sizes with same resolution. From top to bottom: raw images, SN2N results, and clean ground truth images. The synthetic structures (16.25 nm pixel size) were convolved with a 150 nm size PSF and downsampled by 2, 3, 4, 5, 6, 8, and 16 times (from left to right). Then the resulting images with different pixel sizes (labeled on the top left corner) were injected with Poisson-Gaussian noise on the same level (40%, Level 1). SSIM and PSNR values of SN2N results are marked on the bottom right corner. FIG. 8B shows exemplary average SSIM (top) and PSNR (bottom) values from data under different downsampling rates. FIG. 8C shows exemplary SN2N denoising results under different interpolation methods. From left to right: raw input, SN2N results using data without interpolation, with bilinear interpolation, and our Fourier interpolation as training sets, and ground truth image. FIG. 8D shows exemplary average SSIM values of SN2N under different interpolation strategies. FIG. 8E shows exemplary SN2N results under different self-constrained regularization weights (values labeled on the top left corner). SSIM and PSNR values of SN2N results are marked in the bottom right corner. FIG. 8F shows exemplary average SSIM and PSNR values. Error bars: s.e.m. Experiments were repeated ten times independently with similar results; scale bars, 1 μm.

FIGS. 9A-9F show exemplary testing results of different noise levels and data amounts according to some embodiments of the present disclosure. FIG. 9A shows exemplary denoising results of various methods under three different noise levels (Level 3, Level 2, and Level 1, from top to bottom) using the full training set. From left to right: raw input, denoising results of PURE, AcsN, N2V, supervised learning (‘Supervised’), SN2N without constraint (‘SN2N w/o c’), and full SN2N. FIG. 9B shows exemplary quantitative comparisons of the results shown in FIG. 9A using PSNR (left), SSIM (middle), and RMSE (left) metrics. FIG. 9C shows exemplary denoising results of learning-based methods using three different amounts ( 1/50, ⅕, and full data, from top to bottom) of training data under Level 1 of noise. FIG. 9D shows exemplary quantitative comparison of the results shown in FIG. 9C using PSNR (left), SSIM (middle), and RMSE (left) metrics. K denotes the slope (red lines) of the corresponding metric values along the data increment. FIGS. 9E-9F show exemplary data uncertainty (FIG. 9E) and model uncertainty (FIG. 9F) of neural network models trained by different data amounts. Average standard derivation (STD) values calculated from ten predictions of ten repetitively acquired data or ten repetitively trained models. Experiments were repeated three times independently with similar results; scale bars, 1 μm.

FIGS. 10A-10G show exemplary comparisons of SN2N versus RL-SN2N using SD-SIM and applying SN2N on SD-confocal microscopy according to some embodiments of the present disclosure. FIG. 10A shows exemplary zoomed-in views (top) and FWHM distribution plots (bottom, calculated by LuckyProfiler) of denoising results by different methods (c.f., FIG. 2A). FIG. 10B shows an exemplary comparison of SN2N and RL-SN2N. Top: SD-SIM (left) and its RL result (right); Bottom: SN2N result (left) and RL-SN2N result (right). FIG. 10C shows exemplary LRQ values of results in FIG. 10B. FIG. 10D shows exemplary SN2N denoising results (right) of SD confocal image (left) recording the Argo-SIM slide. FIG. 10E shows exemplary LRQ values of results in FIG. 10D. FIG. 10F shows exemplary comparisons of SN2N with 2D U-Net (left), SN2N with 3D U-Net (middle), and RL-SN2N with 3D U-Net (right) of volumetric data (c.f., FIG. 3B). FIG. 10G shows exemplary magnified views and their xz and yz cross-sections from white boxed regions in FIG. 10F. Scale bars, 500 nm (FIGS. 10A, 10B, 10D); 1 μm (FIGS. 10F, 10G).

FIGS. 11A-11K show exemplary SN2N-empowered automated subcellular segmentation and tracking according to some embodiments of the present disclosure. FIG. 11A shows an exemplary workflow. Step 1, RL deconvolution; Step 2, RL-SN2N inference; Step 3, segmentation; Step 4, tracking; Step 5, extraction of motion features; Step 6, classification; Step 7, topology graph construction; Step 8, specific downstream analysis. FIG. 11B shows a representative example for dual-color SR imaging of mitochondria (Mito, green) and ER (magenta) labeled with Tom20-mCherry and Sec61β-EGFP in live COS-7 cells under raw SD-SIM (left) and RL-SN2N (right). In FIG. 11C, the white box in FIG. 11B is enlarged and shown at seven time points under different configurations. From top to bottom: raw SD-SIM, dual-color RL-SN2N, single-channel (Mito) RL-SN2N, RL SD-SIM segmentation, and RL-SN2N segmentation results. The yellow and white arrows indicate the mitochondrial fission and before fission, respectively. FIGS. 11D, 11E show exemplary results of Mito (FIG. 11D) and ER (FIG. 11E) segmentations (first row) using the Otsu hard threshold (first column) and Mitonet/Ernet (second column) and their skeletonizations (second row) under SD-SIM (left) and RL-SN2N (right). FIG. 11F shows exemplary Otsu segmentation results for Lys (red) and GA (blue) under SDSIM (left) and RL-SN2N (right). FIG. 11G shows an exemplary representative 4-color segmentation result under RL-SN2N. FIG. 11H shows exemplary spatial distribution of Lys assigned with different motion behaviors. FIG. 11I shows exemplary distribution of estimated a values of Lys versus their temporal average of minimum distances to Mito. FIG. 11J shows an exemplary distribution of the Lys-Mito MOCs' standard deviation (S.D.) versus their mean values. FIG. 11K shows exemplary illustrations of the MSD curves for different motion behaviors of Lys. Curves are color-coded by the corresponding ER-Lys distances. Scale bars, 2 μm (FIGS. 11B, 11C, 11E).

FIGS. 12A-12F show that RL-SN2N can suppress noise in undersampled data from EMCCD SD-SIM according to some embodiments of the present disclosure. FIG. 12A shows exemplary 3D renderings of live COS-7 cells labeled with Hoechst (green) and MitoTracker Deep Red (magenta) under raw SD-SIM equipped with an EMCCD camera (94 nm pixel size versus <150 nm resolution). FIG. 12B shows exemplary representative lateral slices from volume in FIG. 12A. FIG. 12C shows exemplary RL-SN2N results of FIG. 12A with additional 2× upsampling before RL deconvolution (47 nm pixel size). FIG. 12D shows exemplary representative lateral slices from volume in FIG. 12C. FIG. 12E shows another RL-SN2N time point. FIG. 12F shows exemplary representative lateral slices from volume in FIG. 12E. Scale bars, 5 μm.

FIGS. 13A-13K show exemplary full data of SOFI-SN2N results and SN2N-assisted expansion microscopy (ExM-SN2N) according to some embodiments of the present disclosure. FIG. 13A shows the entire view of the wide-field, 2D-SIM, 2^{nd} order SOFI with 20 frames (2^{nd} SOFI 20f), 2^{nd} order SOFI-SN2N with 20 frames images (clockwise arranged) (c.f., FIG. 6B). FIG. 13B shows exemplary SN2N results of 2^{nd}, 3^{rd} and 4^{th} orders SOFI (from left to right) using 20, 50, 100, 200, 500, 1000 frames (from top to bottom) (c.f., FIG. 6E). FIGS. 13C-13E show exemplary average SSIM values of 2^{nd} (FIG. 13C), 3^{rd} (FIG. 13D), and 4^{th} (FIG. 13E) SOFI-SN2N results. FIG. 13F shows exemplary comparison of temporal and spatial sampling methods. From left to right: SOFI reconstruction, SN2N result using temporal sampling (the first 20 frames vs. the second 20 frames), and SN2N result using spatial sampling. FIG. 13G shows an exemplary 2 times-expanded (2×, top) and 4-times expanded (4×, bottom)COS-7 cell was immunostained with a primary antibody against α-tubulin and a second antibody conjugated with Alexa Fluor 488 under wide-field microscopy (left) and its SN2N denoised result (right). Signal-to-background ratios (SBR) are labeled. FIG. 13H shows exemplary magnified views of the white boxed regions in FIG. 13A under ExM (top) and SN2N denoised results (bottom). FIG. 13I shows exemplary intensity profiles and multiple Gaussian fitting of the filaments indicated by the white arrows in FIG. 13H. Numbers represent the distances between peaks; a.u., arbitrary units. FIG. 13J shows an exemplary 4.5-times expanded (4.5×)COS-7 cell labeled with Sec61β-GFP under wide-field microscopy (left) and its SN2N denoised result (right). FIG. 13K shows exemplary enlarged regions enclosed by the white box in FIG. 13J seen under ExM-4.5× (left) and its SN2N result (right). Centerline, medians; limits, 75% and 25%; whiskers, maximum and minimum; error bars, s.e.m., scale bars, 2 μm (FIG. 13A), 1 μm (FIGS. 13B, 13H, 13J, 13K), and 5 μm (FIG. 13G).

FIGS. 14A-14T show that SN2N removes random, non-continuous artifacts in low-SNR SIM with two strategies according to some embodiments of the present disclosure. FIG. 14A shows an exemplary pipeline of SIM-SN2N using raw image resampling strategy. The self-supervised data generation is applied on the 9 raw images followed by the SIM reconstruction. The resulting paired SR SIM images are the training set. At the inference stage, the SR SIM image is directly fed into the trained SIM-SN2N model. FIGS. 14B, 14D, 14F show exemplary clathrin-coated pits (CCPs, FIG. 14B), microtubules (FIG. 14D), and ER (FIG. 14F), recorded by SIM under low-SNR condition (SIM-L, left) and their SN2N results (right). FIGS. 14C, 14E, 14G show exemplary SIM reconstructions (left) of CCPs (FIG. 14C), microtubules (FIG. 14E), and ER (FIG. 14G) under low (L, top), medium (M, middle), and high (H, bottom) SNR conditions and their SN2N results (right). The ground truth (GT) images are displayed on the right part of the corresponding low-SNR SIM images. SSIM values are labeled on the bottom right corners. FIG. 14H shows exemplary mitochondrial cristae structures in live COS-7 cells labeled with MitoTracker Green under 2D-SIM (bottom left boxed region) and SN2N-SIM imaging at the first time point. FIGS. 14I, 14J show exemplary representative montages of 11 time points from yellow boxed region in FIG. 14H under 2D-SIM (FIG. 14I) and SIM-SN2N (FIG. 14J). FIG. 14K shows an exemplary workflow of SIM-SN2N using SIM image resampling strategy. After SIM reconstruction, a self-supervised data generation is applied for SIM, in which the resampling operation acts in 3×3 pixels (1+3+7+9 versus 2+4+6+8) followed by a 3× Fourier interpolation. FIGS. 14L, 14N, 14P show exemplary CCPs (FIG. 14L), microtubules (FIG. 14N), and ER (FIG. 14P), recorded by SIM under low-SNR condition (left) and their SN2N results (right). FIGS. 14M, 14O, 14Q show exemplary SIM reconstructions (left) of CCPs (FIG. 14M), microtubules (FIG. 14O), and ER (FIG. 14Q) under low (top), medium (middle), and high (bottom) SNR conditions and their SN2N results (right). The ground truth images are displayed on the right part of the corresponding low-SNR SIM images. SSIM values are labeled on the bottom right corners. FIG. 14R shows an exemplary representative living COS-7 cell labeled with LifeAct-EGFP under ultrafast TIRF (left), TIRF-SIM (middle), and SIM-SN2N (right). FIGS. 14S, 14T show exemplary enlarged regions enclosed by the white box in FIG. 14R, under TIRF-SIM (FIG. 14S) and SIM-SN2N (FIG. 14T). Experiments were repeated three times independently with similar results. Scale bars, 2 μm (FIGS. 14B, 14D, 14F, 14H) and 1 μm (FIGS. 14C, 14E, 14G, 14J, 14R, 14T).

FIGS. 15A-15C show that SN2N maintains the linear response of Ca²⁺ transients obtained by the SD-SIM according to some embodiments of the present disclosure. FIG. 15A shows an exemplary representative live COS-7 cell transfected with gCaMP6s, stimulated with ATP (10 μM). One snapshot under the SD-SIM (left) and after the SN2N (right) were shown. FIG. 15B shows exemplary magnified views of regions enclosed by white boxes 1-4 in FIG. 15A. FIG. 15C shows exemplary ATP stimulated calcium traces from corresponding macrodomains in FIG. 15B. Experiments were repeated three times independently with similar results. Scale bar, 5 μm (FIG. 15A), 2 μm (FIG. 15B).

FIGS. 16A-16K show exemplary generalization of unsupervised learning methods across different SNR conditions and pixel sizes (structural scales) according to some embodiments of the present disclosure. FIGS. 16A-16F show exemplary testing generalization of SN2N across different SNR conditions. FIGS. 16A-16C show exemplary color-coded 3D distributions of all mitochondria (labeled with Tom20-mCherry) of a live COS-7 cell (c.f., FIG. 3B) at the first volume (0 min) (FIG. 16A) and the last volume (2.5 min) (FIG. 16B) under SD-SIM (top) and SN2N trained with the first volume (bottom), and the SN2N prediction of SN2N perdition (SN2N², bottom) from the last SD-SIM volume (top). FIGS. 16D, 16E show exemplary SN2N predictions (bottom, trained with the last SD-SIM volume) from the first (0 min) (FIG. 16D) and the last (2.5 min) (FIG. 16E) SD-SIM volumes (top). FIG. 16F shows exemplary zoom-in views from white-boxed regions in FIGS. 16A-16E. First column: 0 min (top) and 2.5 min (bottom) SD-SIM; second column: SN2N and SN2N² (bottom half of bottom) results (trained with 0 min SD-SIM volume) of 0 min (top) and 2.5 min (bottom) SD-SIM; SN2N results (trained with 2.5 min SD-SIM volume) of 0 min (top) and 2.5 min (bottom) SD-SIM. FIGS. 16G-16K show exemplary testing generalization of SN2N across different pixel sizes. FIG. 16G shows exemplary nuclear pores in HeLa cells labeled with an anti-Mab414 primary antibody and the Alexa594 secondary antibody and observed under STED and STED-SN2N configurations. FIG. 16H shows STED images (left) of 20.66 nm pixel size (top), 7.10 nm pixel size (middle), and 20.66 nm pixel size subsampled from 7.10 nm (bottom), and their SN2N results (right) from model trained by data of 20.66 nm pixel size.

FIG. 16I shows exemplary STED images (left) of 7.10 nm pixel size (top), 20.66 nm pixel size (middle), and 7.10 nm pixel size Fourier upsampled from 20.66 nm (bottom), and their SN2N results (right) from the model trained by data of 7.10 nm pixel size. FIGS. 16J, 16K show exemplary average FWHM values of STED (gray) and SN2N results (yellow) from the model trained by data of 20.66 nm pixel size (FIG. 16J) and 7.10 nm pixel size (FIG. 16K). Centerline, medians; limits, 75% and 25%; whiskers, maximum and minimum; error bars, s.e.m. Experiments were repeated three times independently with similar results. Scale bar, 5 μm (FIG. 16E), 1 μm (FIGS. 16F-16H).

FIG. 17 shows exemplary simulation workflow of microtubule filaments, ground-truth (GT) image, and SR images under different noise levels according to some embodiments of the present disclosure. Scale bar, 5 μm.

FIG. 18 shows exemplary full data uncertainty results of simulation data under different noise levels (c.f., FIG. 9C) according to some embodiments of the present disclosure. Scale bar, 1 μm.

FIGS. 19A-19B show exemplary Full data uncertainty and model uncertainty results of simulation data with different training data amounts (c.f., FIG. 9C) according to some embodiments of the present disclosure. Scale bar, 1 μm.

FIGS. 20A-20H show exemplary benchmarking of SN2N against N2V and DeepCAD using live-cell imaging data and their segmentation results (c.f., FIG. 3E) according to some embodiments of the present disclosure. SEG.: segmentation. The DeepCAD model was trained by temporally interleaved data (odd and even frames) as input and target. Scale bar, 1 μm.

FIGS. 21A-21B show that RL-SN2N reveals the 3D distribution of mitochondria after long-term recording (c.f., FIG. 4e) according to some embodiments of the present disclosure. FIG. 21A shows exemplary three time points of mitochondrial network in a live COS-7 cell labeled with Tom20-mCherry under SD-SIM (left) and RL-SN2N (right). FIG. 21B shows exemplary magnified views and their xz and yz cross-sections from white boxed regions in FIG. 21A under SD-SIM (left) and RL-SN2N (right). Scale bars, 5 μm (FIG. 21A); 2 μm (FIG. 21B).

FIGS. 22A-22B show exemplary representative lateral slices at the first time point of 5D data (c.f., FIG. 4G) according to some embodiments of the present disclosure. FIGS. 22A, 22B show exemplary SD-SIM (FIG. 22A) lateral slices at different axial positions (labeled on the top left corner) and their SN2N denoised results (FIG. 22B). Scale bar, 5 μm.

FIG. 23 shows exemplary STED (top), STED-SN2N (middle), and STED-ISM (bottom) results of microtubules in a fixed cell under different depletion laser powers according to some embodiments of the present disclosure. Scale bar, 1 μm.

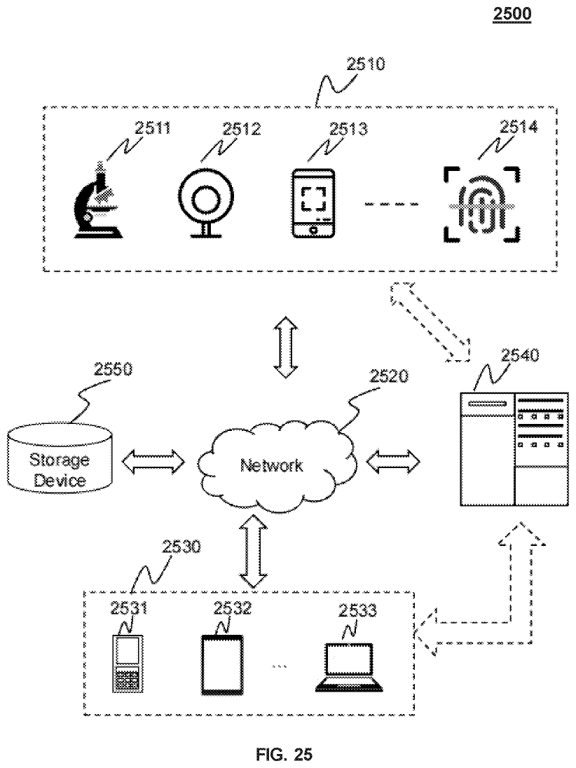

FIG. 25 is a schematic diagram illustrating an exemplary application scenario of an image processing system according to some embodiments of the present disclosure. As shown in FIG. 25, the image processing system 2500 may include an image acquisition device 2510, a network 2520, one or more terminals 2530, a processing device 2540, and a storage device 2550.

The components in the image processing system 2500 may be connected in one or more of various ways. Merely by way of example, the image acquisition device 2510 may be connected to the processing device 2540 through the network 2520. As another example, the image acquisition device 2510 may be connected to the processing device 2540 directly as indicated by the bi-directional arrow in dotted lines linking the image acquisition device 2510 and the processing device 2540. As still another example, the storage device 2550 may be connected to the processing device 2540 directly or through the network 2520. As a further example, the terminal 2530 may be connected to the processing device 2540 directly (as indicated by the bi-directional arrow in dotted lines linking the terminal 2530 and the processing device 2540) or through the network 2520.

The image processing system 2500 may be configured to train an image processing model. Merely by way of example, the image processing system 2500 may obtain a plurality of sample images; generate a plurality of image pairs based on the plurality of sample images; and/or obtain a trained image processing model by training the image processing model using the plurality of image pairs. Alternatively or additionally, the image processing system 2500 may be configured to process one or more images. Merely by way of example, the image processing system 2500 may obtain one or more initial images; and/or generate one or more target images by processing the one or more initial images using a trained image processing model.

The image acquisition device 2510 may be configured to obtain one or more images (e.g., one or more initial images, one or more sample images, etc.) associated with an object within its detection region. The object may include one or more biological or non-biological objects. In some embodiments, the image acquisition device 2510 may be an optical imaging device, a radioactive-ray-based imaging device (e.g., a computed tomography device), a nuclide-based imaging device (e.g., a positron emission tomography device, a magnetic resonance imaging device), etc. Exemplary optical imaging devices may include a microscope 2511 (e.g., a fluorescence microscope), a surveillance device 2512 (e.g., a security camera), a mobile terminal device 2513 (e.g., a camera phone), a scanning device 2514 (e.g., a flatbed scanner, a drum scanner, etc.), a telescope, a webcam, or the like, or any combination thereof. In some embodiments, the optical imaging device may include a capture device (e.g., a detector or a camera) for collecting the image data. For illustration purposes, the present disclosure may take the microscope 2511 as an example for describing exemplary functions of the image acquisition device 2510. Exemplary microscopes may include a structured illumination microscope (SIM) (e.g., a two-dimensional SIM (2D-SIM), a three-dimensional SIM (3D-SIM), a total internal reflection SIM (TIRF-SIM), a spinning-disc confocal-based SIM (SD-SIM), etc.), a photoactivated localization microscopy (PALM), a stimulated emission depletion microscopy (STED), a stochastic optical reconstruction microscopy (STORM), an SR optical fluctuation imaging (SOFI) microscopy, etc. The SIM may include a detector such as an EMCCD camera, an sCMOS camera, etc. The objects detected by the SIM may include one or more objects of biological structures, biological issues, proteins, cells, microorganisms, or the like, or any combination. Exemplary cells may include INS-1 cells, COS-7 cells, HeLa cells, MCF7 cells, liver sinusoidal endothelial cells (LSECs), human umbilical vein endothelial cells (HUVECs), HEK293 cells, or the like, or any combination thereof. In some embodiments, the one or more objects may be fluorescent or fluorescent-labeled. The fluorescent or fluorescent-labeled objects may be excited to emit fluorescence for imaging.

The network 2520 may include any suitable network that can facilitate the image processing system 2500 to exchange information and/or data. In some embodiments, one or more of components (e.g., the image acquisition device 2510, the terminal(s) 2530, the processing device 2540, the storage device 2550, etc.) of the image processing system 2500 may communicate information and/or data with one another via the network 2520. For example, the processing device 2540 may acquire image(s) (e.g., one or more initial images, one or more sample images) from the image acquisition device 2510 via the network 2520. As another example, the processing device 2540 may obtain user instructions from the terminal(s) 2530 via the network 2520. The network 2520 may be and/or include a public network (e.g., the Internet), a private network (e.g., a local area network (LAN), a wide area network (WAN), etc.), a wired network (e.g., an Ethernet), a wireless network (e.g., an 802.11 network, a Wi-Fi network, etc.), a cellular network (e.g., a Long Term Evolution (LTE) network), an image relay network, a virtual private network (“VPN”), a satellite network, a telephone network, a router, a hub, a switch, a server computer, and/or a combination of one or more thereof. For example, the network 2520 may include a cable network, a wired network, a fiber network, a telecommunication network, a local area network, a wireless local area network (WLAN), a metropolitan area network (MAN), a public switched telephone network (PSTN), a Bluetooth™ network, a ZigBee™ network, a near field communication network (NFC), or the like, or a combination thereof. In some embodiments, the network 2520 may include one or more network access points. For example, the network 2520 may include wired and/or wireless network access points, such as base stations and/or network switching points, through which one or more components of the image processing system 2500 may access the network 2520 for data and/or information exchange.

In some embodiments, a user may operate the image processing system 2500 through the terminal(s) 2530. The terminal(s) 2530 may include a mobile device 2531, a tablet computer 2532, a laptop computer 2533, or the like, or a combination thereof. In some embodiments, the mobile device 2531 may include a smart home device, a wearable device, a mobile device, a virtual reality device, an augmented reality device, or the like. In some embodiments, the smart home device may include a smart lighting device, a control device of an intelligent electrical apparatus, a smart monitoring device, a smart television, a smart video camera, an interphone, or the like, or a combination thereof. In some embodiments, the wearable device may include a bracelet, footgear, glasses, a helmet, a watch, clothing, a backpack, a smart accessory, or the like, or a combination thereof. In some embodiments, the mobile device may include a mobile phone, a personal digital assistant (PDA), a gaming device, a navigation device, a point of sale (POS) device, a laptop, a tablet computer, a desktop, or the like, or a combination thereof. In some embodiments, the virtual reality device and/or augmented reality device may include a virtual reality helmet, virtual reality glasses, a virtual reality eyewear, an augmented reality helmet, augmented reality glasses, an augmented reality eyewear, or the like, or a combination thereof. For example, the virtual reality device and/or augmented reality device may include a Google Glass™, an Oculus Rift™, a Hololens™, a Gear VR™, or the like. In some embodiments, the terminal(s) 2530 may be part of the processing device 2540.

The processing device 2540 may process data and/or information obtained from the image acquisition device 2510, the terminal(s) 2530, and/or the storage device 2550. For example, the processing device 2540 may process one or more images (e.g., one or more initial images, one or more sample images, etc.) generated by the image acquisition device 2510, using one or more methods described in the present disclosure, to generate denoised image(s). As another example, the processing device 2540 may train an image processing model using a plurality of sample images according to one or more training methods described in the present disclosure. In some embodiments, the processing device 2540 may be a server or a server group. The server group may be centralized or distributed. In some embodiments, the processing device 2540 may be local or remote. For example, the processing device 2540 may access information and/or data stored in the image acquisition device 2510, the terminal(s) 2530, and/or the storage device 2550 via the network 2520. As another example, the processing device 2540 may be directly connected to the image acquisition device 2510, the terminal(s) 2530, and/or the storage device 2550 to access stored information and/or data. In some embodiments, the processing device 2540 may be implemented on a cloud platform. For example, the cloud platform may include a private cloud, a public cloud, a hybrid cloud, a community cloud, a distributed cloud, an interconnected cloud, a multiple cloud, or the like, or a combination thereof. In some embodiments, the processing device 2540 may be implemented by a computing device 2600 having one or more components as described in FIG. 26.

The storage device 2550 may store data, instructions, and/or any other information. In some embodiments, the storage device 2550 may store data obtained from the terminal(s) 2530, the image acquisition device 2510, and/or the processing device 2540. In some embodiments, the storage device 2550 may store data and/or instructions that the processing device 2540 may execute or use to perform exemplary methods described in the present disclosure. In some embodiments, the storage device 2550 may include a mass storage device, a removable storage device, a volatile read-and-write memory, a read-only memory (ROM), or the like. Exemplary mass storage devices may include a magnetic disk, an optical disk, a solid-state drive, etc. Exemplary removable storage devices may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 2550 may be executed on a cloud platform. For example, the cloud platform may include a private cloud, a public cloud, a hybrid cloud, a community cloud, a distributed cloud, an interconnected cloud, a multiple cloud, or the like, or a combination thereof.

In some embodiments, the storage device 2550 may be connected to the network 2520 to communicate with one or more other components (e.g., the processing device 2540, the terminal(s) 2530, etc.) of the image processing system 2500. One or more components of the image processing system 2500 may access data or instructions stored in the storage device 2550 via the network 2520. In some embodiments, the storage device 2550 may be directly connected to or communicate with one or more other components (e.g., the processing device 2540, the terminal(s) 2530, etc.) of the image processing system 2500. In some embodiments, the storage device 2550 may be part of the processing device 2540.

FIG. 26 is a schematic diagram illustrating an exemplary computing device according to some embodiments of the present disclosure. The computing device 2600 may be used to implement any component of the image processing system 2500 as described herein. For example, the processing device 2540 and/or the terminal(s) 2530 may be implemented on the computing device 2600, respectively, via its hardware, software program, firmware, or a combination thereof. Although only one such computing device is shown, for convenience, the computer functions relating to the image processing system 2500 as described herein may be implemented in a distributed manner on a number of similar platforms, to distribute the processing load.

As shown in FIG. 26, the computing device 2600 may include a processor 2610, a storage 2620, an input/output (I/O) 2630, and a communication port 2640.

The processor 2610 may execute computer instructions (e.g., program code) and perform functions of the image processing system 2500 (e.g., the processing device 2540) in accordance with the techniques described herein. The computer instructions may include, for example, routines, programs, objects, components, data structures, procedures, modules, and functions, which perform particular functions described herein. For example, the processor 2610 may process image(s) obtained from any component of the image processing system 2500 according to one or more image processing methods described in the present disclosure. In some embodiments, the processor 2610 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or a combination thereof.

Merely for illustration, only one processor is described in the computing device 2600. However, it should be noted that the computing device 2600 in the present disclosure may also include multiple processors, thus operations and/or method operations that are performed by one processor as described in the present disclosure may also be jointly or separately performed by the multiple processors. For example, if in the present disclosure the processor of the computing device 2600 executes both operation A and operation B, it should be understood that operation A and operation B may also be performed by two or more different processors jointly or separately in the computing device 2600 (e.g., a first processor executes operation A and a second processor executes operation B, or the first and second processors jointly execute operations A and B).

The storage 2620 may store data/information obtained from any component of the image processing system 2500. In some embodiments, the storage 2620 may include a mass storage device, a removable storage device, a volatile read-and-write memory, a read-only memory (ROM), or the like, or any combination thereof. Exemplary mass storage devices may include a magnetic disk, an optical disk, a solid-state drive, etc. The removable storage device may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc.

In some embodiments, the storage 2620 may store one or more programs and/or instructions to perform exemplary methods described in the present disclosure. For example, the storage 2620 may store a program for the processing device 2540 to process images generated by the image acquisition device 2510.

The I/O 2630 may input and/or output signals, data, information, etc. In some embodiments, the I/O 2630 may enable user interaction with the image processing system 2500 (e.g., the processing device 2540). In some embodiments, the I/O 2630 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 2640 may be connected to a network to facilitate data communications. The communication port 2640 may establish connections between the processing device 2540 and the image acquisition device 2510, the terminal(s) 2530, and/or the storage device 2550. The connection may be a wired connection, a wireless connection, any other communication connection that can enable data transmission and/or reception, and/or any combination of these connections. The wired connection may include, for example, an electrical cable, an optical cable, a telephone wire, or the like, or a combination thereof. The wireless connection may include a Bluetooth™ link, a Wi-Fi™ link, a WiMax™ link, a WLAN link, a ZigBee™ link, a mobile network link (e.g., 3G, 4G, 5G), or the like, or a combination thereof. In some embodiments, the communication port 240 may be and/or include a standardized communication port, such as RS232, RS485, etc. In some embodiments, the communication port 2640 may be a specially designed communication port.

For example, the communication port 2640 may be designed in accordance with the digital imaging and communications in medicine (DICOM) protocol.

FIG. 27 is a block diagram illustrating an exemplary mobile device on which the terminal(s) 2530 may be implemented according to some embodiments of the present disclosure.

As shown in FIG. 27, the mobile device 2700 may include a communication unit 2710, a display unit 2720, a graphics processing unit (GPU) 2730, a central processing unit (CPU) 2740, an I/O 2750, a memory 2760, a storage unit 2770, etc. In some embodiments, any other suitable component, including but not limited to a system bus or a controller (not shown), may also be included in the mobile device 2700. In some embodiments, an operating system 2761 (e.g., iOS™, Android™, Windows Phone™, etc.) and one or more applications (apps) 2762 may be loaded into the memory 2760 from the storage unit 2770 in order to be executed by the CPU 2740. The application(s) 2762 may include a browser or any other suitable mobile apps for receiving and rendering information relating to imaging, image processing, or other information from the image processing system 2500 (e.g., the processing device 2540). User interactions with the information stream may be achieved via the I/O 2750 and provided to the processing device 2540 and/or other components of the image processing system 2500 via the network 2520. In some embodiments, a user may input parameters to the image processing system 2500, via the mobile device 2700.

In order to implement various modules, units and their functions described above, a computer hardware platform may be used as hardware platforms of one or more elements (e.g., the processing device 2540 and/or other components of the image processing system 2500 described in FIG. 25). Since these hardware elements, operating systems and program languages are common; it may be assumed that persons skilled in the art may be familiar with these techniques and they may be able to provide information needed in the imaging and assessing according to the techniques described in the present disclosure. A computer with the user interface may be used as a personal computer (PC), or other types of workstations or terminal devices. After being properly programmed, a computer with the user interface may be used as a server. It may be considered that those skilled in the art may also be familiar with such structures, programs, or general operations of this type of computing device.

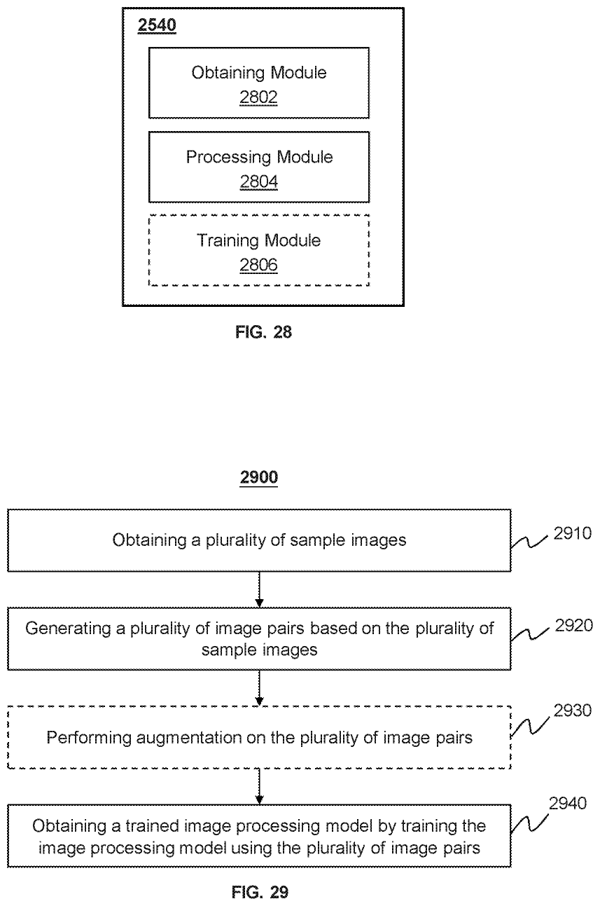

FIG. 28 is a block diagram illustrating an exemplary processing device according to some embodiments of the present disclosure. In some embodiments, the processing device 2540 may be configured to process one or more images, and/or train an image processing model. The processing device 2540 may be implemented as software and/or hardware. In some embodiments, the processing device 2540 may be part of an imaging device (e.g., the image acquisition device 2510). In some embodiments, the processing device 2540 may include an obtaining module 2802, and a processing module 2804.

The obtaining module 2802 may be configured to obtain an initial image.

The processing module 2804 may be configured to generate a target image by processing the initial image using a trained image processing model. In some embodiments, the trained image processing model may be generated by training an image processing model using one or more training samples. In some embodiments, each training sample of the one or more training samples may include an image pair generated based on a sample image.

In some embodiments, the processing device 2540 may further include a training module 2806. The training module 2806 may be configured to obtain a plurality of sample images; generate a plurality of image pairs based on the plurality of sample images; and obtain a trained image processing model by training the image processing model using the plurality of image pairs. In some embodiments, noises of each image pair of the plurality of image pairs are uncorrelated.

It should be noted that the above descriptions about the processing device 2540 are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, some other components/modules (e.g., a storage module) may be added into the processing device 2540. In some embodiments, the training module 2806 may be omitted. In some embodiments, the training process may be implemented on another processing device (not shown) independent or separated from the processing device 2540. In some embodiments, the processing device 2540 (also referred to as a first processing device) and the processing device implementing the training process (also referred to as a second processing device) may share one or more of the modules illustrated above. For instance, the first and second processing devices may be part of a same system (e.g., the image processing system 2500) and/or share a same obtaining module (e.g., the obtaining module 2802). In some embodiments, the first and second processing devices may be different devices belonging to different parties, in which the second processing device may be configured to train the image processing model offline, while the first processing device may be configured to use the trained image processing model to process image(s) online.

FIG. 29 is a flowchart illustrating an exemplary process for training an image processing model according to some embodiments of the present disclosure. In some embodiments, process 2900 may be executed by the image processing system 2500. For example, the process 2900 may be implemented as a set of instructions (e.g., an application) stored in one or more storage devices (e.g., the storage device 2550, the storage 2620, and/or the storage unit 2770) and invoked and/or executed by the processing device 2540 (implemented on, for example, the processor 2610 of the computing device 2600, and the CPU 2740 of the mobile device 2700). The operations of the process 2900 presented below are intended to be illustrative. In some embodiments, the process 2900 may be accomplished with one or more additional operations not described, and/or without one or more of the operations discussed. Additionally, the order in which the operations of the process 2900 as illustrated in FIG. 29 and described below is not intended to be limiting.

In 2910, a plurality of sample images may be obtained. Operation 2910 may be performed by the obtaining module 2802.

A sample image may refer to an image of a sample object. The sample object may be a biological or non-biological object described elsewhere in the present disclosure. Merely by way of example, the sample object may be a cell. The sample object may be the same as or similar to a target object (an image of which is to be processed). In some embodiments, the sample object may be identical with the target object. For example, the sample object and the target object may be a same cell. In some embodiments, the sample object may be different from the target object. For example, the sample object and the target object may be different cells from the same or different batch of culture. As another example, the sample object and the target object may be different objects that have similar structure(s). For instance, the target object may be a cell, while the sample object may be a non-biological phantom that has similar structure(s) with the cell. The plurality of sample images may be SR images.

In some embodiments, the plurality of sample images may be obtained by imaging the sample object or the target object using an imaging device (e.g., the image acquisition device 2510 in FIG. 25). The imaging device may include a fluorescence microscopic imaging device (e.g., a fluorescence microscopic imaging device described elsewhere in the present disclosure, such as SIM, TIRF-SIM, SD-SIM, PALM, STED, STORM, SOFI, etc.). In some embodiments, the plurality of sample images may be directly obtained from the imaging device. Alternatively, the plurality of sample images may be obtained from the storage device 2550.

In 2920, a plurality of image pairs may be generated based on the plurality of sample images. operation 2920 may be performed by the obtaining module 2802.

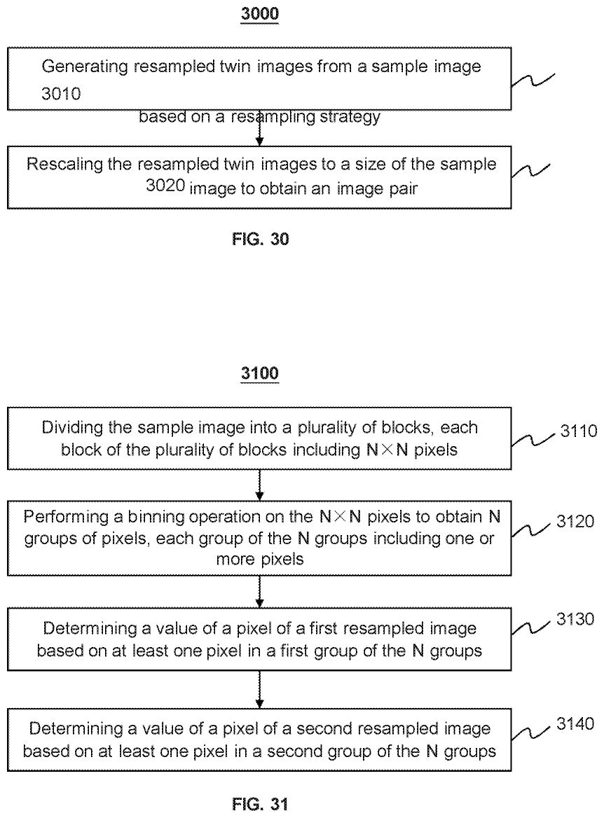

In some embodiments, each image pair of the plurality of image pairs may be generated from a sample image of the plurality of sample images. In some embodiments, an image pair may be generated from a sample image (e.g., an SR image) using the inherent spatial redundancy of the SR image. In some embodiments, the image pair may share identical detail(s). For example, the image pair from the same sample image may have similar or same structural feature(s). In some embodiments, the image pairs may have different noise realizations. For example, the image pair from the same sample image may have uncorrelated noises. More descriptions of the generation of the image pairs may be found elsewhere in the present disclosure (e.g., FIG. 30 and descriptions thereof).

In 2930, data augmentation may be performed on the plurality of image pairs. Operation 2930 may be performed by the obtaining module 2802.

In some embodiments, data augmentation may be performed to augment the image pairs used for training an image processing model. Data augmentation may be optional. In some embodiments, if a count of the sample images is relatively small, data augmentation may be performed on the plurality of image pairs. In some embodiments, the obtaining module 2802 may automatically perform data augmentation on the plurality of image pairs. In some embodiments, the obtaining module 2802 may receive a user instruction (e.g., from the terminal 2530) (that indicates to perform data augmentation) and perform data augmentation on the plurality of image pairs.

A plurality of modes for data augmentation may be developed. Merely by way of example, data augmentation may be performed along the temporal dimension. In some embodiments, a first patch of a first selected image in the plurality of image pairs corresponding to a first time point may be exchanged with a second patch of a second selected image in the plurality of image pairs corresponding to a second time point, in which a position of the first patch in the first selected image is identical with a position of the second patch in the second selected image. As another example, data augmentation may be performed between different measurements. In some embodiments, a first patch of a first selected image in the plurality of image pairs corresponding to a first object may be exchanged with a second patch of a second selected image in the plurality of image pairs corresponding to a second object, in which a position of the first patch in the first selected image is identical with a position of the second patch in the second selected image, and the first object and the second object are detected in different measurements.

In some embodiments, in data augmentation, two image pairs (also referred to as two original image pairs) may be selected from the plurality of image pairs, and the two original image pairs may be recombined, or partially replaced to generate two new image pairs. Merely by way of example, the two original image pairs may include a first original image pair (including a first original image and a second original image) and a second original image pair (including a third original image and a fourth original image), the two new image pairs may include a first new image pair and a second new image pair. A portion (e.g., a patch) of the first original image may be exchanged with a portion (e.g., a patch) of the third original image to obtain a first new image and a third new image, in which the two portions have the same position in their corresponding original images. Similarly, a portion (e.g., a patch) of the second original image may be exchanged with a portion (e.g., a patch) of the fourth original image to obtain a second new image and a fourth new image, in which the two portions have the same position in their corresponding original images. Thus, the first new image pair (including the first new image and the second new image) and the second new image pair (including the third new image and the fourth new image) may be obtained. The two selected image pairs for augmentation may be from different time points and/or different measurements. In some embodiments, the new image pairs may be used as original image pairs for further data augmentation.

In some embodiments, in a single image pair (including, e.g., a first selected image and a second selected image) of the plurality of image pairs, two distinct patches at different positions may be swapped. Merely by way of example, a first patch of the first selected image in the plurality of image pairs may be exchanged with a second patch of the first selected image to obtain a first new image. Correspondingly, a first patch of the second selected image in the plurality of image pairs may be exchanged with a second patch of the second selected image to obtain a second new image. Thus, a new image pair including the first new image and the second new image may be obtained. In some embodiments, a position of the first patch of the first selected image in the first selected image may be identical with a position of the first patch of the second selected image in the second selected image, and a position of the second patch of the first selected image in the first selected image may be identical with a position of the second patch of the second selected image in the second selected image.

It should be noted that, one patch is described for illustration purposes, in some embodiments, two or more patches may be exchanged between two different images, and/or two or more patches may be swapped in a single image for data augmentation. More descriptions of the data augmentation may be found elsewhere in the present disclosure (e.g., Patch2Patch data augmentation and descriptions thereof).

In 2940, a trained image processing model may be obtained by training the image processing model using the plurality of image pairs. Operation 2940 may be performed by the training module 2806.

In some embodiments, an initial image processing model may be obtained. In some embodiments, the initial image processing model may include a convolutional neural network (CNN) model (e.g., a U-Net neural network model, or a V-Net neural network model), a deep CNN (DCNN) model, a fully convolutional network (FCN) model, a recurrent neural network (RNN) model, or the like, or any combination thereof. In some embodiments, the initial image processing model may be stored in one or more storage devices (e.g., the storage device 2550, the storage 2620, and/or the storage unit 2770) associated with the image processing system 2500 and/or an external data source. Accordingly, the initial image processing model may be retrieved from the storage devices and/or the external data source.

In some embodiments, the training module 2806 may perform a plurality of iterations to iteratively update one or more parameter values of the initial image processing model. In some embodiments, before the plurality of iterations, the training module 2806 may initialize the parameter values of the initial image processing model. Exemplary parameters of the initial image processing model may include the size of a kernel of a layer, the total count (or number) of layers, the count (or number) of nodes in each layer, a learning rate, a batch size, a connected weight between two connected nodes, bias vector(s) relating to the node(s), etc. In some embodiments, the one or more parameters may be set randomly. In some embodiments, the one or more parameters may be set to one or more predetermined values, e.g., 0, 1, or the like.

In the training process of the image processing model, the two images in each image pair of the plurality of image pairs may be used as an input and a label interchangeably. For example, for an image pair including a first image and a second image, the first image may be used as an input while the second image may be used as a label of the first image; additionally, the second image may be used as an input while the first image may be used as a label of the second image.

In some embodiments, the plurality of image pairs may be input into the image processing model. Differences between the output of the image processing model and corresponding labels of the plurality of image pairs may be used to determine a value of a loss function. The parameters of the image processing model may be updated based on the value of the loss function. In some embodiments, a plurality of iterations may be performed to update the parameters of the image processing model until a termination condition is satisfied. The termination condition may provide an indication of whether the image processing model is sufficiently trained. The termination condition may relate to the cost function or an iteration count of the training process. For example, the termination condition may be satisfied if the value of the cost function (also referred to as an accuracy) of the image processing model is minimal or smaller than a threshold. As another example, the termination condition may be satisfied if the value of the cost function converges. The convergence may be deemed to have occurred if the variation of the values of the cost function in two or more consecutive iterations is smaller than a threshold. As a further example, the termination condition may be satisfied when a specified number (or count) of iterations are performed in the training process. As illustrated above, if the termination condition is not satisfied (e.g., if the accuracy does not satisfy a predetermined accuracy threshold), in next iteration(s), other training sample(s) may be input into the image processing model to train the image processing model as described above, until the termination condition is satisfied. The trained image processing model may be determined based on the one or more updated parameters. In some embodiments, the trained image processing model may be transmitted to the storage device 2550, or any other storage device for storage.

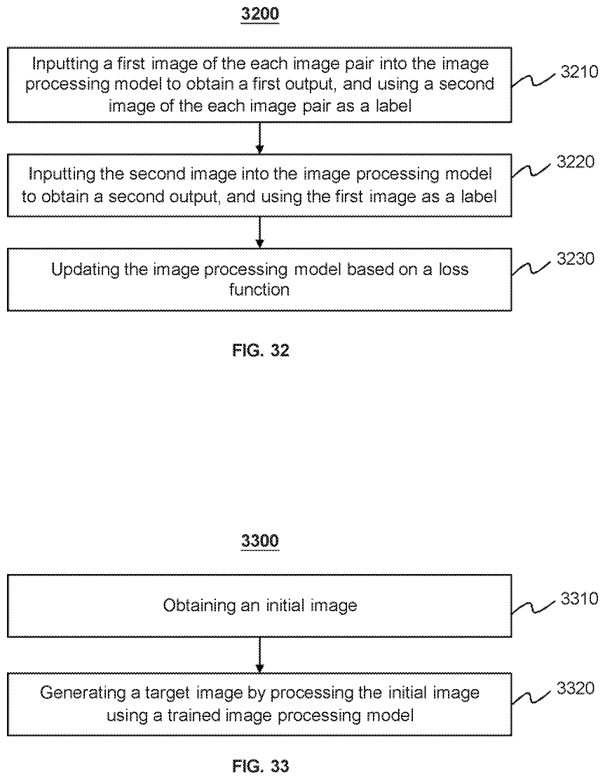

An exemplary training process (see process 3200 in FIG. 32) is described for the purpose of illustration and is not intended to limit the scope of the present disclosure. Specifically, for each image pair of the plurality of image pairs (e.g., image pair x₁ and x₂), in 3210, a first image (e.g., image x₁) of the each image pair may be input into the image processing model to obtain a first output (e.g., an output image \tilde{x}₁), and a second image (e.g., image x₂) of the each image pair may be used as a label. Alternatively or additionally, in 3220, the second image (e.g., image x₂) of the each image pair may be input into the image processing model to obtain a second output (e.g., an output image \tilde{x}₂), and the first image (e.g., image x₁) of the each image pair may be used as a label. In 3230, the image processing model (e.g., the parameters of the processing model) may be updated based on a loss function. In some embodiments, the loss function may be associated with a difference between the first output and the second image. In some embodiments, the loss function may be associated with a difference between the second output and the first image. In some embodiments, the loss function may be associated with a difference between the first output and the second output.

In some embodiments, the loss function may include a first term and/or a second term. The first term or the second term may be a distance between an output of the image processing model corresponding to an input and a label of the input. The input and the label may belong to an image pair and may be used interchangeably for the first term and the second term. For example, for the image pair x₁ and x₂, when the image x₁ is used as an input, the image x₂ may be used as a label, the output \tilde{x}₁ corresponding to the input x₁ may be obtained, and the first term may be determined based on a distance between the output \tilde{x}₁ and the label x₂. Similarly, when the image x₂ is used as an input, the image x₁ may be used as a label, the output \tilde{x}₂ corresponding to the input x₂ may be obtained, and the second term may be determined based on a distance between the output \tilde{x}₂ and the label x₁.

In some embodiments, the loss function may include a third term. The third term may be a self-constrained term. The self-constrained term may be configured to constrain the training process and denoising variance. The self-constrained term may be determined based on a distance between the output \tilde{x}₁ (when the image x₁ is used as the input) and the output \tilde{x}₂ (when the image x₂ is used as the input). In some embodiments, the third term may include a weight (e.g., a constraint weight). It should be noted that the first term, second term, and the third term of the loss function may be used separately or integrally, which is not limited in the present disclosure. For example, the loss function may include the first term, the second term, or the third term. As another example, the loss function may include the first term and the second term. As a further example, the loss function may include the first term (or the second term) and the third term. More descriptions of the loss function may be found elsewhere in the present disclosure (e.g., Equations (1)-(2) and descriptions thereof). More descriptions of the training process may be found elsewhere in the present disclosure (e.g., FIG. 32 and descriptions thereof).

It should be noted that the above description of process 2900 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, operation 2930 may be omitted.

FIG. 30 is a flowchart illustrating an exemplary process for generating a plurality of image pairs based on a plurality of sample images according to some embodiments of the present disclosure. In some embodiments, process 3000 may be executed by the image processing system 2500. For example, the process 3000 may be implemented as a set of instructions (e.g., an application) stored in one or more storage devices (e.g., the storage device 2550, the storage 2620, and/or the storage unit 2770) and invoked and/or executed by the processing device 2540 (implemented on, for example, the processor 2610 of the computing device 2600, and the CPU 2740 of the mobile device 2700). The operations of the process 3000 presented below are intended to be illustrative. In some embodiments, the process 3000 may be accomplished with one or more additional operations not described, and/or without one or more of the operations discussed. Additionally, the order in which the operations of the process 3000 as illustrated in FIG. 30 and described below is not intended to be limiting. In some embodiments, the operation 2920 in FIG. 29 may be performed according to the process 3000.

In 3010, resampled twin images may be generated from each sample image of the plurality of sample images based on a resampling strategy. Operation 3010 may be performed by the obtaining module 2802.

In some embodiments, the resampling strategy may include a subsampling strategy. The subsampling strategy may have a 1:N subsampling rate, in which N is greater than 1. Using the subsampling strategy, resampled twin images (including, e.g., a first resampled image and a second resampled image, a each of which having a 1/N subsampled size with respect to the sample image) may be generated. A plurality of subsampling strategies may be developed. An exemplary subsampling process (see process 3100 in FIG. 31) is described for the purpose of illustration and is not intended to limit the scope of the present disclosure. Specifically, in some embodiments, to subsample the sample image, in 3110, the sample image may be divided into a plurality of blocks. Each of the plurality of blocks may include N×N pixels. In 3120, for each block of the plurality of blocks, a binning operation may be performed on the N×N pixels to obtain N groups of pixels. Each group of the N groups may include one or more pixels. In 3130, a value of a pixel of the first resampled image may be determined based on at least one pixel (e.g., all pixels) in a first group of the N groups; in 3140, a value of a pixel of the second resampled image may be determined based on at least one pixel (e.g., all pixels) in a second group of the N groups, in which a position of the pixel of the second resampled image in the second resampled image may be identical with a position of the pixel of the first resampled image in the first resampled image. In some embodiments, the value of the pixel of the first resampled image may be determined based on an average value (or a maximum value, a minimum value, or the like) of the at least one pixel in the first group. Similarly, the value of the pixel of the second resampled image may be determined based on an average value (or a maximum value, a minimum value, or the like) of the at least one pixel in the second group.

In some embodiments, the first group and the second group may be randomly selected from the N groups. Alternatively, the first group and the second group may be determined from the N groups according to a preset rule. Merely by way of example, N may be equal to 2. An exemplary block may be shown in FIG. 24A. The first group may include two pixels at a first diagonal of the each block (e.g., pixels “1” and “4” in FIG. 24A). The second group may include two pixels at a second diagonal of the each block (e.g., pixels “2” and “3” in FIG. 24A). As another example, N may be equal to 3. An exemplary block may be shown in FIG. 24B. The first group may include four corner pixels at four corners of the each block (e.g., pixels “1”, “3”, “7” and “9” in FIG. 24B). The second group may include four intermediate pixels (e.g., four remaining pixels excluding the four corner pixels and a central pixel) in the each block (e.g., pixels “2”, “4”, “6” and “8” in FIG. 24B). More descriptions of the subsampling strategy may be found elsewhere in the present disclosure.

In 3020, the resampled twin images may be rescaled to a size of the sample image to obtain an image pair. Operation 3020 may be performed by the obtaining module 2802.

In some embodiments, the rescaling of the resampled twin images may be realized through interpolation. Exemplary interpolation algorithms may include Fourier interpolation, nearest neighbor interpolation, bilinear interpolation, bicubic interpolation, etc., which is not limited in the present disclosure. Taking Fourier interpolation as an example, each image of the resampled twin images may be transformed into Fourier domain; the each image in Fourier domain may be extended by padding with zeros; and the each image may be transformed from Fourier domain into image domain to obtain a rescaled image. In some embodiments, each of the resampled twin images may be rescaled independently. Through rescaling, sizes of the resampled twin images may become identical with the size of the sample image, and an image pair may be obtained. Accordingly, a plurality of image pairs may be obtained similarly. The image pairs may be further used for data augmentation or training the image processing model.

It should be noted that the above description of process 3000 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the sample image may be rescaled (e.g., upsampled) to a target size larger than a size of the sample image (e.g., with an N:1 upsampling rate); then an image pair may be generated from the rescaled sample image based on a subsampling strategy (e.g., with a 1:N subsampling rate) described in the present disclosure. As another example, before operation 3010, a first user instruction may be received (e.g., by the obtaining module 2802 from the terminal 2530). The first user instruction may instruct which resampling strategy will be used. Then the resampling strategy may be determined based on the first user instruction. As a further example, before operation 3010, a second user instruction may be received (e.g., by the obtaining module 2802 from the terminal 2530). The second user instruction may indicate the subsampling rate. Then the 1:N subsampling rate may be determined based on the second user instruction.

FIG. 33 is a flowchart illustrating an exemplary process for processing an image according to some embodiments of the present disclosure. In some embodiments, process 3300 may be executed by the image processing system 2500. For example, the process 3300 may be implemented as a set of instructions (e.g., an application) stored in one or more storage devices (e.g., the storage device 2550, the storage 2620, and/or the storage unit 2770) and invoked and/or executed by the processing device 2540 (implemented on, for example, the processor 2610 of the computing device 2600, and the CPU 2740 of the mobile device 2700). The operations of the process 3300 presented below are intended to be illustrative. In some embodiments, the process 3300 may be accomplished with one or more additional operations not described, and/or without one or more of the operations discussed. Additionally, the order in which the operations of the process 3300 as illustrated in FIG. 33 and described below is not intended to be limiting.

In 3310, an initial image may be obtained. Operation 3310 may be performed by the obtaining module 2802.

In some embodiments, the initial image may be obtained by imaging the target object using an imaging device (e.g., the image acquisition device 2510 in FIG. 25). The imaging device may include a fluorescence microscopic imaging device (e.g., a fluorescence microscopic imaging device described elsewhere in the present disclosure, such as SIM, TIRF-SIM, SD-SIM, PALM, STED, STORM, SOFI, etc.). In some embodiments, the initial image may be directly obtained from the imaging device. Alternatively, the initial image may be obtained from the storage device 2550.

In 3320, a target image may be generated by processing the initial image using a trained image processing model. Operation 3320 may be performed by the processing module 2804.

The trained image processing model may be configured to reduce or remove one or more noises in the initial image. In some embodiments, the trained image processing model may be generated by training an image processing model using one or more training samples. Each training sample of the one or more training samples may include an image pair generated based on a sample image. In some embodiments, noises of the image pair may be uncorrelated. In some embodiments, the initial image and the sample image(s) may be generated by a same imaging device. In some embodiments, the initial image and the sample image(s) may be generated by imaging a same target object using the imaging device. In some embodiments, the training process of the image processing model may include: obtaining one or more sample images; generating one or more image pairs based on the one or more sample images; and obtaining the trained image processing model by training the image processing model using the one or more image pairs. More descriptions of the target object, the sample image(s), and the training process of the image processing model may be found elsewhere in the present disclosure (e.g., FIGS. 29-32 and descriptions thereof).

In some embodiments, the initial image may be input into the trained image processing model, and an output of the trained image processing model may be designated as the target image. The target image may have a lower level of noise than the initial image.

It should be noted that the above description of process 3300 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, a plurality of initial images may be obtained. And a plurality of target images may be generated by processing the initial images using the trained image processing model. Each target image may be generated based on a corresponding one initial image using the trained image processing model. The plurality of initial images may be processed one by one or in a batch using the trained image processing model.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for training an image processing model implemented on a computing device having one or more processors and one or more storage devices, comprising:
obtaining a plurality of sample images;
generating a plurality of image pairs based on the plurality of sample images; and
obtaining a trained image processing model by training the image processing model using the plurality of image pairs;
wherein noises of each image pair of the plurality of image pairs are uncorrelated.

2. The method of claim 1, wherein the generating a plurality of image pairs based on the plurality of sample images includes:
for each sample image of the plurality of sample images,
generating resampled twin images from the sample image based on a resampling strategy;
rescaling the resampled twin images to a size of the sample image to obtain an image pair.

3. The method of claim 2, wherein the resampling strategy includes a subsampling strategy with a 1:N subsampling rate, N being greater than 1.

4. The method of claim 3, wherein the resampled twin images include a first resampled image and a second resampled image, and the generating resampled twin images from the sample image based on a resampling strategy includes:
dividing the sample image into a plurality of blocks, each block of the plurality of blocks including N×N pixels;
for the each block,
performing a binning operation on the N×N pixels to obtain N groups of pixels, each group of the N groups including one or more pixels;
determining a value of a pixel of the first resampled image based on at least one pixel in a first group of the N groups;
determining a value of a pixel of the second resampled image based on at least one pixel in a second group of the N groups;
wherein a position of the pixel of the second resampled image in the second resampled image is identical with a position of the pixel of the first resampled image in the first resampled image.

5. The method of claim 4, wherein the determining a value of a pixel of the first resampled image based on at least one pixel in a first group of the N groups includes:
determining the value of the pixel of the first resampled image based on an average value of the at least one pixel in the first group.

6. The method of claim 4, wherein the determining a value of a pixel of the second resampled image based on at least one pixel in a second group of the N groups includes:
determining the value of the pixel of the second resampled image based on an average value of the at least one pixel in the second group.

7. The method of claim 4, wherein
N is equal to 2;
the first group includes two pixels at a first diagonal of the each block; and
the second group includes two pixels at a second diagonal of the each block.

8. The method of claim 4, wherein
N is equal to 3;
the first group includes four corner pixels at four corners of the each block; and
the second group includes four remaining pixels excluding the four corner pixels and a central pixel in the each block.

9. The method of claim 2, wherein the rescaling the resampled twin images to a size of the sample image to obtain an image pair includes:
rescaling the resampled twin images to the size of the sample image using interpolation.

10. The method of claim 9, wherein the rescaling the resampled twin images to the size of the sample image using interpolation includes:
transforming each image of the resampled twin images into Fourier domain;
extending the each image in the Fourier domain by padding with zeros;
transforming the each image from the Fourier domain into image domain.

11. The method of claim 1, wherein the generating a plurality of image pairs based on the plurality of sample images includes:
for each sample image of the plurality of sample images,
rescaling the sample image to a target size larger than a size of the sample image;
generating an image pair from the rescaled sample image based on a resampling strategy.

12. The method of claim 1, further comprising:
performing augmentation on the plurality of image pairs.

13. The method of claim 12, wherein the performing augmentation on the plurality of image pairs includes:
exchanging a first patch of a first selected image in the plurality of image pairs corresponding to a first time point with a second patch of a second selected image in the plurality of image pairs corresponding to a second time point;
wherein a position of the first patch in the first selected image is identical with a position of the second patch in the second selected image.

14. The method of claim 12, wherein the performing augmentation on the plurality of image pairs includes:
exchanging a first patch of a first selected image in the plurality of image pairs with a second patch of the first selected image.

15. The method of claim 12, wherein the performing augmentation on the plurality of image pairs includes:
exchanging a first patch of a first selected image in the plurality of image pairs corresponding to a first object with a second patch of a second selected image in the plurality of image pairs corresponding to a second object;
wherein a position of the first patch in the first selected image is identical with a position of the second patch in the second selected image.

16. The method of claim 1, wherein the training the image processing model using the plurality of image pairs includes:
for each image pair of the plurality of image pairs,
inputting a first image of the each image pair into the image processing model to obtain a first output, and using a second image of the each image pair as a label;
updating the image processing model based on a loss function, the loss function being associated with a difference between the first output and the second image.

17. The method of claim 16, wherein the training the image processing model using the plurality of image pairs further includes:
for the each image pair, inputting the second image into the image processing model to obtain a second output, and using the first image as a label; and
wherein the loss function is further associated with a difference between the second output and the first image.

18. The method of claim 17, wherein the loss function is further associated with a difference between the first output and the second output.

19. A method for image processing implemented on a computing device having one or more processors and one or more storage devices, comprising:
obtaining an initial image; and
generating a target image by processing the initial image using a trained image processing model;
wherein:
the trained image processing model is generated by training an image processing model using one or more training samples; and
each training sample of the one or more training samples includes an image pair generated based on a sample image.

20. A system for training an image processing model, comprising:
at least one storage device storing a set of instructions; and
at least one processor in communication with the storage device, wherein when executing the set of instructions, the at least one processor is configured to cause the system to perform operations including:
obtaining a plurality of sample images;
generating a plurality of image pairs based on the plurality of sample images; and
obtaining a trained image processing model by training the image processing model using the plurality of image pairs;
wherein noises of each image pair of the plurality of image pairs are uncorrelated.
